(19) United States
(12) Patent Application Publication
(10) Pub. No.: US 2025/0296898 A1
(43) Pub. Date: Sep. 25, 2025

(54) APPLICATIONS OF OXIDIZED LIGNIN IN AGRICULTURAL FORMULATIONS

(71) Applicant: INGEVITY SOUTH CAROLINA, LLC, North Charleston, SC (US)

(72) Inventors: Mitra Shiran Ganewatta, North Charleston, SC (US); Qi Wang, North Charleston, SC (US); Thomas M. Sisson, North Charleston, SC (US); Mariola Beresniewicz-Kopcinski, North Charleston, SC (US); Petr Koutnik, North Charleston, SC (US)

(21) Appl. No.: 18/643,504

(22) Filed: Apr. 23, 2024

Related U.S. Application Data
(60) Provisional application No. 63/567,690, filed on Mar. 20, 2024.

(51) Int. Cl. C05G 3/80; A01N 25/10; A01N 25/12; A01N 35/06; A01N 63/23; A01N 63/30; A01P 7/04; A01P 13/02; B01J 20/24; B01J 20/28; B01J 20/30; C02F 1/28; C02F 1/62; C02F 101/20; C05G 1/00; C05G 3/50; C05G 3/60; C05G 5/27; C09K 17/32

(52) U.S. Cl. CPC C05G 3/80; A01N 25/10; A01N 25/12; A01N 35/06; A01N 63/23; A01N 63/30; A01P 7/04; A01P 13/02; B01J 20/24; B01J 20/28004; B01J 20/28016; B01J 20/3085; C02F 1/286; C02F 1/62; C05G 1/00; C05G 3/50; C05G 3/60; C05G 5/27; C09K 17/32; C02F 2101/20

(57) ABSTRACT

Presently described are agricultural compositions/formulations, such as suspension concentrate compositions/formulations comprising an active component and nutrient compositions/formulations, comprising oxidized lignin, as well as methods of making and using the same. The present disclosure also provides oxidized lignin formulations for the removal of heavy metal ions, as well as methods of making and using the same.

### CROSS-REFERENCE TO RELATED APPLICATIONS

The present application claims priority to, and the benefit of, U.S. Provisional Application Ser. No. 63/567,690, filed 20 Mar. 2024, which is incorporate by reference herein in its entirety for all purposes.

### STATEMENT REGARDING FEDERALLY FUNDED RESEARCH

This invention was made with government support under grant number DE-EE0008912 by the Department of Energy. The government has certain rights in the invention.

### INCORPORATION BY REFERENCE

U.S. Pat. No. 11,014,951 B2, titled “COMPOSITIONS AND METHODS FOR DEPOLYMERIZING LIGNIN USING A CHELATOR-MEDIATED FENTON REACTION”, and International Patent Application Publication No. WO 2022/221209 A1, titled “CHELATOR-MEDIATED FENTON (CMF) PROCESSES TO MODIFY LIGNIN”, describe methods of making oxidized lignin, which is incorporated by reference herein by reference in its entirety for all purposes.

### BACKGROUND

1. Field of Discovery. Described herein are agricultural formulations comprising lignin polyacid materials used as agricultural dispersants, micronutrient complexation agents, soil purification, and water purification materials. The lignin polyacid materials were formulated as a component in agricultural dispersants, micronutrient complexation, and heavy metal ion removal compositions. Also described herein are methods of making and using the compositions of the present disclosure.

2. Background Information. Lignin is a valuable biomass feedstock that has the potential to produce advanced chemicals and materials. Lignin comprises 15-30% of lignocellulosic biomass and is mostly burned for its heating value within the paper pulping industry. Generating greater value out of this renewable and abundant material is critical for the establishment of a sustainable bioeconomy.

A near-room temperature aqueous oxidative process was developed to open the aromatic rings within the lignin structure and resulting in carboxylic acid-functionalized lignins. Kraft lignin, lignin from lignocellulosic biorefineries, and lignosulfonates can be oxidized by chelator-mediated Fenton reaction to make the carboxylic acid-functionalized lignins.

Active agents used in agricultural industry, such as pesticides and herbicides, have low water solubility, thereby requiring dispersing agents to produce versions/compositions that can be practically used in the fields. Furthermore, there is a need in the remediation industry for renewable compositions that are capable of adsorbing heavy metals.

Therefore, a need exists in the agricultural industry and in the remediation industry for compositions that enhance solubility and adsorb heavy metals, respectively.

### SUMMARY

Presently described are agricultural, remediation, and purification formulations and methods of their use. It was surprisingly and unexpectedly discovered that agricultural formulations could be prepared using oxidized lignin that result in stable dispersions of the solutes while maintaining performance characteristics. It was also surprisingly and unexpectedly discovered that oxidized lignin could be used to adsorb heavy metals.

Thus, in an aspect, the disclosure provides a composition or formulation (e.g., a suspension concentrate, an agricultural composition or formulation, a pesticidal composition or formulation, or a combination thereof) comprising, consisting essentially of, or consisting of: at least one (e.g., 1, 2, 3, 4, 5, 6, 7, 8, 9, 10, or more) active component comprising at least one (e.g., 1, 2, 3, 4, 5, 6, 7, 8, 9, 10, or more) pesticide (e.g., at least one fungicide, at least one herbicide, at least one insecticide, at least one biopesticide or its capsules, at least one algicide, at least one bactericide, at least one miticide, at least one molluscicide, at least one nematicide, at least one rodenticide, at least one virucide, or a combination thereof), at least one (e.g., 1, 2, 3, 4, 5, 6, 7, 8, 9, 10, or more) biostimulant, or a combination thereof; at least one (e.g., 1, 2, 3, 4, 5, 6, 7, 8, 9, 10, or more) oxidized lignin; at least one (e.g., 1, 2, 3, 4, 5, 6, 7, 8, 9, 10, or more) surfactant (e.g., an anionic surfactant, such as alkylnapthalene sulfonate); and at least one (e.g., 1, 2, 3, 4, 5, 6, 7, 8, 9, 10, or more) solvent (e.g., water), at least one (e.g., 1, 2, 3, 4, 5, 6, 7, 8, 9, 10, or more) filler (e.g., clay), or a combination thereof. In a further aspect, the disclosure provides a method of making the composition or formulation of the present disclosure comprising an active component, the method comprising combining, and optionally mixing (e.g., mixing with milling beads, mixing until the composition has a desired particle size, such as described herein, or a combination thereof), the components of the composition.

In any aspect or embodiment describe herein, (i) the at least one surfactant includes, consists essentially of, or is a non-ionic surfactant, an ionic surfactant (e.g., a cationic surfactant, an anionic surfactant, an amphoteric surfactant, or a combination thereof), or a combination thereof; (ii) the at least one solvent includes, consists essentially of, or is a polar protic solvent or a polar aprotic solvent (e.g., water, propylene glycol, ethylene glycol, glycerin, diethylene glycol monobutyl ether, 1-methoxy-2-propanol, ethanol, isopropanol, propanol, acetone, dimethylformamide, dimethyl sulfoxide, tetrahydrofuran, acetonitrile, dimethylacetamide, or a combination thereof); (iii) the composition further comprises at least one (e.g., 1, 2, 3, 4, 5, 6, 7, 8, 9, 10, or more) nutrient (e.g., at least one micronutrient, at least one macronutrient, or a combination thereof); or (iv) a combination thereof.

In any aspect or embodiment describe herein, the composition comprises at least one solvent (e.g., the composition does not include a filler), and the composition further comprises (i) a D90 particle size of less than about 30 micron (e.g., less than about 29, less than about 28, less than about 27, less than about 26, less than about 25, less than about 24, less than about 23, less than about 22, less than about 21, or less than about 20 micron); (ii) a D50 particle size of less than about 15 micron (e.g., less than about 14, less than about 13, less than about 12, less than about 11, less than about 10, less than about 9, less than about 8, less than about 7, less than about 6, or less than about 5 micron); (iii) at least one (e.g., 1, 2, 3, 4, 5, 6, 7, 8, 9, 10, or more) anti-freezing agent or freezing point depressant (e.g., propylene glycol, urea, or a combination thereof); (iv) at least one (e.g., 1, 2, 3, 4, 5, 6, 7, 8, 9, 10, or more) defoamer (e.g., a silicone defoamer (e.g., polydimethylsiloxane (PDMS), silicone oil, silicone emulsion, or a combination thereof), a mineral oil based defoamer (e.g., paraffinic oil, naphthenic oil, vegetable oil, or a combination thereof), a fatty acid-based defoamer (e.g., a stearate, calcium stearate, oleate, tall oil fatty acids, or a combination thereof), a polymeric defoamer (e.g., polyacrylate, polyurethanes, or a combination thereof), a hydrophobic silica-based defoamer (e.g., hydrophobic fumed silica), or a combination thereof); or (v) a combination thereof.

In any aspect or embodiment describe herein, (i) the at least one active component is present in an amount of about 0.5 wt % to about 15.0 wt %; (ii) the at least one oxidized lignin is present in the composition in an amount of about 0.5 to about 15.0 wt % (e.g., about 0.5 to about 5.0 wt % or about 1.0 to about 10 wt %); (iii) the at least one surfactant is present in an amount of about 0.01 wt % to about 5.0 wt % (e.g., about 0.1 wt % to about 2.0 wt %, about 0.5 wt % to about 1.5 wt %, or about 1 wt %); (iv) the at least one solvent is present in an amount of about 20.0 wt % to about 45.0 wt % (e.g., about 25.0 wt % to about 42.0 wt %, about 30.0 wt % to about 40.0 wt %, or about 35.0 wt % to about 39.0 wt %); (v) the at least one anti-freezing agent or freezing point depressant is present in an amount of about 1.0 wt % to about 10.0 wt % (e.g., about 2.5 wt % to about 7.5 wt %, about 4.0 wt % to about 6.0 wt %, about 5 wt %); (vi) the at least one defoamer is present in an amount of about 0.05 wt % to about 2.0 wt % (e.g., about 0.1 wt % to about 0.5 wt % or about 0.2 wt %); (vii) the at least one nutrient (e.g., at least one (e.g., 1, 2, 3, 4, 5, 6, 7, 8, 9, 10, or more) micronutrient, at least one (e.g., 1, 2, 3, 4, 5, 6, 7, 8, 9, 10, or more) macronutrient, or a combination thereof) is present in an amount of less than or equal to about 20.0 wt % (e.g., at least one micronutrient in an amount of less than or equal to about 3.0 wt %, at least one macronutrient in an amount of less than or equal to about 20.0 wt %, or a combination thereof); or (viii) a combination thereof.

In any aspect or embodiment described herein, the at least one active component includes, consists essentially of, or is at least one (e.g., 1, 2, 3, 4, 5, 6, 7, 8, 9, 10, or more) biopesticide, at least one (e.g., 1, 2, 3, 4, 5, 6, 7, 8, 9, 10, or more) biostimulant, or a combination thereof, and (i) the composition (e.g., a dry composition, such as a wettable powder or granules) comprises at least one filler (e.g., the composition does not comprise a solvent, the at least one filler includes clay, or a combination thereof) and optionally further comprises at least one (e.g., 1, 2, 3, 4, 5, 6, 7, 8, 9, 10, or more) binder, or (ii) the composition (e.g. an aqueous composition or suspension concentrate) comprises the at least one solvent (e.g., the composition does not comprise a filler, the at least one solvent comprises polyoxyethylene (20) sorbitan monolaurate, or a combination thereof) and optionally further comprises (a) at least one (e.g., 1, 2, 3, 4, 5, 6, 7, 8, 9, 10, or more) anti-freezing agent or freezing point depressant (e.g., propylene glycol, urea, or a combination thereof), (b) at least one (e.g., 1, 2, 3, 4, 5, 6, 7, 8, 9, 10, or more) preservative (e.g., methyl p-hydroxybenzoate), (c) at least one (e.g., 1, 2, 3, 4, 5, 6, 7, 8, 9, 10, or more) protectant (e.g., polyethylene glycol), or (d) a combination thereof.

In any aspect or embodiment described herein, wherein (i) the composition has a D90 particle size of less than about 100 micron (e.g., less than about 99, less than about 98, less than about 97, less than about 96, less than about 95, less than about 94, less than about 93, less than about 92, less than about 91, less than about 90, less than about 89, less than about 88, less than about 87, less than about 86, less than about 85, less than about 84, less than about 83, less than about 82, less than about 81, less than about 80, less than about 75, less than about 70, less than about 65, or less than about 60 micron); (ii) the composition has a D50 particle size of less than about 10 micron (e.g., less than about 9, less than about 8, less than about 7, less than about 6, or less than about 5 micron); (iii) the at least one active component is present in an amount of about 5.0 wt % to about 90.0 wt % (e.g., about 5.0 wt % to about 25.0 wt %); (iv) the at least one oxidized lignin is present in the composition in an amount of about 0.5 to about 15.0 wt % (e.g., about 0.5 to about 5.0 wt % or about 1.0 to about 10 wt %); (v) the at least one surfactant is present in an amount of about 0.01 wt % to about 7.5 wt % (e.g., about 0.1 wt % to about 7.0 wt %, about 0.5 wt % to about 6.5 wt %, about 4.0 wt % to about 6.0 wt %, or about 5.0 wt %); (vi) the at least one filler is present in an amount of about 5.0 wt % to about 90.0 wt % (e.g., about 55.0 wt % to about 90.0 wt % (e.g., about 60.0 wt % to about 80.0 wt %, about 65.0 wt % to about 75.0 wt %, or about 71.0 wt %); (vii) the at least one binder is present in an amount of less than or equal to about 10.0 wt % (e.g., about 1.0 wt % to about 5.0 wt %); (viii) the at least one nutrient (e.g., at least one (e.g., 1, 2, 3, 4, 5, 6, 7, 8, 9, 10, or more) micronutrient, at least one (e.g., 1, 2, 3, 4, 5, 6, 7, 8, 9, 10, or more) macronutrient, or a combination thereof) is present in an amount of less than or equal to about 20.0 wt % (e.g., at least one micronutrient in an amount of less than or equal to about 3.0 wt %, at least one macronutrient in an amount of less than or equal to about 20.0 wt %, or a combination thereof); or (ix) a combination thereof.

In any aspect or embodiment described herein, (i) the composition has a D50 particle size of less than about 15 micron (e.g., less than about 14, less than about 13, less than about 12, less than about 11, less than about 10, less than about 9, less than about 8, less than about 7, less than about 6, or less than about 5 micron); (ii) the at least one active component is present in an amount of about 5.0 wt % to about 90.0 wt % (e.g., about 5.0 wt % to about 25.0 wt %); (iii) the at least one oxidized lignin is present in the composition in an amount of about 0.5 to about 15.0 wt % (e.g., about 0.5 to about 5.0 wt % or about 1.0 to about 10.0 wt %); (iv) the at least one surfactant is present in an amount of about 0.01 wt % to about 7.5 wt % (e.g., about 0.1 wt % to about 7.0 wt %, about 0.5 wt % to about 6.5 wt %, about 4.0 wt % to about 6.0 wt %, or about 5.0 wt %); (v) the at least one solvent is present in the composition in an amount of about 60.0 wt % to about 90.0 wt % (e.g., about 65.0 wt % to about 90.0 wt %, about 70.0 wt % to about 90.0 wt %, or about 80.0 wt % to about 82.0 wt %); (vi) the at least one anti-freezing agent or freezing point depressant (e.g. urea) is present in an amount of about 0.01 wt % to about 1.5 wt % (e.g., about 0.05 wt % to about 1.0 wt % or about 0.3 wt %); (vii) the at least one nutrient (e.g., at least one (e.g., 1, 2, 3, 4, 5, 6, 7, 8, 9, 10, or more) micronutrient, at least one (e.g., 1, 2, 3, 4, 5, 6, 7, 8, 9, 10, or more) macronutrient, or a combination thereof) is present in an amount of less than or equal to about 20.0 wt % (e.g., at least one micronutrient in an amount of less than or equal to about 3.0 wt %, at least one macronutrient in an amount of less than or equal to about 20.0 wt %, or a combination thereof); (viii) the at least one preservative is present in the composition in an amount of less than or equal to about 0.5 wt % (e.g., less than or equal to about 0.4 wt %, less than or equal to about 0.3 wt %, less than or equal to about 0.2 wt %, less than or equal to 0.1 wt %, or about 0.01 wt % to about 0.5 wt %); (ix) the at least one protectant is present in the composition in an amount of less than or equal to about 2.0 wt % (e.g., less than or equal to about 1.9 wt %, less than or equal to about 1.8 wt %, less than or equal to about 1.7 wt %, less than or equal to about 1.6 wt %, less than or equal to about 1.5 wt %, less than or equal to about 1.4 wt %, less than or equal to about 1.3 wt %, less than or equal to about 1.2 wt %, less than or equal to about 1.1 wt %, less than or equal to about 1.0 wt %, or about 0.1 wt % to about 2.0 wt %); or (x) a combination thereof.

In another embodiment, oxidized lignin is disclosed as a component in micronutrient formulations where in metal oxides, carbonates, and other salts that are insoluble and/or soluble, water, and other ingredients are components. Thus, in an aspect, the disclosure provides a composition or formulation (e.g., an agricultural composition or formulation, or a nutrient composition or formulation) comprising, consisting essentially of, or consisting of: at least one (e.g., 1, 2, 3, 4, 5, 6, 7, 8, 9, 10, or more) nutrient (e.g., at least one micronutrient, at least one macronutrient, or a combination thereof, such as Cu₂O, MnCO₃, ZnO, ZnSO₄, or a combination thereof); at least one (e.g., 1, 2, 3, 4, 5, 6, 7, 8, 9, 10, or more) oxidized lignin; at least one (e.g., 1, 2, 3, 4, 5, 6, 7, 8, 9, 10, or more) solvent (e.g., water); and optionally, at least one (e.g., 1, 2, 3, 4, 5, 6, 7, 8, 9, 10, or more) surfactant (e.g., an anionic surfactant). In a further aspect, the present disclosure provides a method of making the composition or formulation of the present disclosure comprising nutrients, the method comprising combining, and optionally mixing (e.g., mixing with milling beads, mixing until the composition has a particle size of less than about 30 micron (e.g., less than about 25, less than about 20, less than about 15, less than about 10, or less than about 5 micron)), the components of the composition.

In any aspect or embodiment describe herein, the at least one nutrient includes at least one (e.g., 1, 2, 3, 4, 5, 6, 7, 8, 9, 10, or more) micronutrient, at least one (e.g., 1, 2, 3, 4, 5, 6, 7, 8, 9, 10, or more) macronutrient, or a combination thereof.

In any aspect or embodiment describe herein, (i) the at least one macronutrient includes, consists essentially of, or is nitrogen (N), phosphorus (P), potassium (K), or a combination thereof; (ii) the at least one micronutrient includes, consists essentially of, or is sulphur(S), magnesium (Mg), calcium (Ca), zinc (Zn), iron (Fe), boron (B), manganese (Mn), copper (Cu), molybdenum (Mo), chlorine (Cl), nickel (Ni), iodine (I), sodium (Na), cobalt (Co), selenium (Se), fluorine (F), or a combination thereof; or (iii) a combination thereof.

In any aspect or embodiment describe herein, (i) the nutrient includes, consists essentially of, or is calcium sulfate, monoammonium phosphate, diammonium phosphate, superphosphate, rock phosphate, ammonium nitrate, potassium nitrate, sodium nitrate, calcium nitrate, magnesium sulfate, potassium-magnesium sulfate, gypsum, ammonium sulfate, elemental sulfur, sodium nitrate, sodium molybdate, potassium iodate, potassium nitrate, potassium sulfate, muriate of potash (MOP), potassium chloride, iron oxide, ferrous sulfate sulfa, zinc oxysulfate, zinc oxide, zinc chloride, zinc nitrate, boric acid, ammonium molybdate, copper sulfate, copper chloride, chromium oxides, sodium selenate, manganese sulfate, manganese oxide, copper sulfates, cobalt sulfate, sodium fluoride, calcium fluoride, or a combination thereof; (ii) the composition has a D90 particle size of less than about 30 micron (e.g., less than about 29, less than about 28, less than about 27, less than about 26, less than about 25, less than about 24, less than about 23, less than about 22, less than about 21, or less than about 20 micron); (iii) the composition has a D50 particle size of less than about 10 micron (e.g., less than about 9, less than about 8, less than about 7, less than about 6, or less than about 5 micron); (iv) the solvent includes, consists essentially of, or is a polar protic solvent or a polar aprotic solvent (e.g., water, propylene glycol, ethylene glycol, glycerin, diethylene glycol monobutyl ether, 1-methoxy-2-propanol, ethanol, isopropanol, propanol, acetone, dimethylformamide, dimethyl sulfoxide, tetrahydrofuran, acetonitrile, dimethylacetamide, or a combination thereof); or (v) a combination thereof.

In any aspect or embodiment describe herein, the composition comprises at least one surfactant (e.g., polyoxethylene (20) sorbitan monolaurate), the at least one nutrient comprises, consists essentially of, or consists of, at least one (e.g., 1, 2, 3, 4, 5, 6, 7, 8, 9, 10, or more) water-insoluble nutrient (e.g., Cu₂O, MnCO₃, ZnO, or a combination thereof), and the composition further comprises: (i) at least one (e.g., 1, 2, 3, 4, 5, 6, 7, 8, 9, 10, or more) defoamer (e.g., a silicone defoamer (e.g., polydimethylsiloxane (PDMS), silicone oil, silicone emulsion, or a combination thereof), a mineral oil based defoamer (e.g., paraffinic oil, naphthenic oil, vegetable oil, or a combination thereof), a fatty acid-based defoamer (e.g., a stearate, calcium stearate, oleate, tall oil fatty acids, or a combination thereof), a polymeric defoamer (e.g., polyacrylate, polyurethanes, or a combination thereof), a hydrophobic silica-based defoamer (e.g., hydrophobic fumed silica), or a combination thereof); (ii) at least one (e.g., 1, 2, 3, 4, 5, 6, 7, 8, 9, 10, or more) stabilizer or thickener (e.g., a cellulose-based thickener (e.g., carboxymethyl cellulose (CMC), hydroxyethyl cellulose (HEC), methyl cellulose (MC), microcrystalline cellulose (MCC)), a starch-based thickener (e.g., cornstarch, potato starch, tapioca starch, rice starch, or a combination thereof), a guar gum derivative (e.g., guar gum, hydroxypropyl guar (HPG), carboxymethyl guar (CMG), xanthan gum, agar-agar, locust bean gum (carob gum), pectin, alginate, gellan gum, acacia gum (gum arabic), carrageenan, or a combination thereof), a polyacrylic acid derivative (e.g., carbomer, acrylates/C10-30 alkyl acrylate crosspolymer, polyethylene glycol (PEG), polyvinyl alcohol (PVA), or a combination thereof), a silica-based thickener (e.g., colloidal silica, fumed silica, bentonite, montmorillonite, hectorite, sodium polyacrylate, hydroxypropyl methylcellulose (HPMC), or a combination thereof). or a combination thereof); (iii) at least one (e.g., 1, 2, 3, 4, 5, 6, 7, 8, 9, 10, or more) anti-freezing agent or freezing point depressant (e.g., propylene glycol, urea, or a combination thereof), or (iv) a combination thereof.

In any aspect or embodiment describe herein, (i) the oxidized lignin is present in an amount of about 0.5 to about 10.0 wt % (e.g., about 1.0 to about 10.0 wt %, about 0.5 to about 5.0 wt %, or about 1.0 wt % to about 5.0 wt %); (ii) the at least one nutrient (e.g., the at least one water-insoluble nutrient) is present in an amount of about 25.0 wt % to about 50.0 wt % (e.g., about 30.0 wt % to about 42.0 wt % or about 35.0 wt % to about 38.0 wt %); (iii) the at least one solvent is present in an amount of about 40.0 wt % to about 70.0 wt % (e.g., about 45.0 wt % to about 65.0 wt % or about 49.0 wt % to about 60.0 wt %); (iv) the at least one surfactant is present in an amount of about 0.01 wt % to about 5.0 wt % (e.g., about 0.1 wt % to about 2.5 wt %); (v) the at least one anti-freezing agent or freezing point depressant is present in an amount of about 1.0 wt % to about 15.0 wt % (e.g., about 1.0 wt % to about 10.0 wt % or about 3.0 wt % to about 8.0 wt %); (vi) the at least one defoamer is present in an amount of about 0.01 wt % to about 2.0 wt % (e.g., about 0.05 wt % to about 0.5 wt % or about 0.05 wt % to about 0.25 wt %); (vii) the at least one stabilizer or thickener is present in an amount of about 0.01 wt % to about 2.0 wt % (e.g., about 0.05% to about 0.5 wt % or about 0.05 wt % to about 0.25 wt %); or (viii) a combination thereof.

In any aspect or embodiment describe herein, (i) the at least one nutrient comprises, consists essentially of, or consists of, at least one (e.g., 1, 2, 3, 4, 5, 6, 7, 8, 9, 10, or more) water-soluble nutrient (e.g., ZnSO₄); (ii) the composition does not include a surfactant (e.g., a surfactant as described herein and/or the composition does not include a defoamer); or (iii) a combination thereof.

In any aspect or embodiment describe herein, (i) the at least one nutrient (e.g., at least one water-soluble nutrient) is present in an amount of about 5.0 wt % to about 20.0 wt % (e.g., about 5.0 wt % to about 15.0 wt %); (ii) the at least one oxidized lignin is present in an amount of about 5.0 wt % to about 20.0 wt % (e.g., about 5.0 wt % to about 15.0 wt %); (iii) the at least one solvent (e.g., water) is present in an amount of about 60.0 wt % to about 90.0 wt %; or (iv) a combination thereof.

A further aspect of the present disclosure relates to a method of applying or treating a plant(s), soil, and/or seed(s) with the composition or formulation of the present disclosure, the method comprising contacting a plant (e.g., a plurality of plants), a seed (e.g., a plurality of seeds), soil near a plant (e.g., a plurality of plants) or a seed (e.g., a plurality of seeds), or a combination thereof, with the composition or formulation (e.g., applying the composition to a plant (e.g., a plurality of plants), soil near a plant and/or seed (e.g., a plurality of plants and/or seeds), a seed (e.g., a plurality of seeds), or a combination thereof).

In another aspect, oxidized lignin materials complex with metal ions via carboxylate and other hydrophilic groups. Formulations and methods to remove heavy metal ions from water or soil for purification applications is disclosed. Thus, in another aspect, the disclosure provides a method of performing remediation (e.g., soil or water remediation) or purification (e.g., water), the method comprising, consisting essentially of, or consisting of, contacting or treating a material to be remediated or purified or contaminated material (e.g., soil, water, or a combination thereof) with an adsorbent material comprising, consisting essentially of, or consisting of, at least one (e.g., 1, 2, 3, 4, 5, 6, 7, 8, 9, 10, or more) oxidized lignin.

In any aspect or embodiment describe herein, the remediation or purification method further comprises, consists essentially of, or consists of, removing the contaminated material prior to contacting or treating the contaminated material with the adsorbent material.

In any aspect or embodiment describe herein, the material to be remediated or purified or contaminated materials includes at least one (e.g., 1, 2, 3, 4, 5, 6, 7, 8, 9, 10, or more) heavy metal (e.g., at least one heavy metal that includes, consists essentially of, or is mercury (Hg), cadmium (Cd), arsenic (As), chromium (Cr), thallium (TI), lead (Pb), or a combination thereof).

Another aspect of the present disclosure relates to an adsorbent material (e.g., a soil remediation adsorbent material or a water remediation adsorbent material) comprising, consisting essentially of, or consisting of, an oxidized lignin (e.g., an adsorbent material for the use of remediation, such as soil remediation, water remediation, or a combination thereof).

In any aspect or embodiment describe herein, the material adsorbs at least one (e.g., 1, 2, 3, 4, 5, 6, 7, 8, 9, 10, or more) heavy metal (e.g., at least one heavy metal that includes, consists essentially of, or is mercury (Hg), cadmium (Cd), arsenic (As), chromium (Cr), thallium (Tl), lead (Pb), or a combination thereof).

Another aspect of the present disclosure relates to the use of the absorbent material of the present disclosure for remediation (e.g., soil remediation, water remediation, or a combination thereof) or purification (e.g., water purification).

A further aspect of the present disclosure relates to a composition comprising the adsorbent of the present disclosure and at least one (e.g., 1, 2, 3, 4, 5, 6, 7, 8, 9, 10, or more) heavy metal (e.g., at least one heavy metal that includes, consists essentially of, or is mercury (Hg), cadmium (Cd), arsenic (As), chromium (Cr), thallium (TI), lead (Pb), or a combination thereof).

In any aspect or embodiment describe herein, (i) the at least one oxidized lignin comprises at least one (e.g., 1, 2, 3, 4, 5, 6, 7, 8, 9, 10, or more) aromatic ring of one or more (e.g., 1, 2, 3, 4, 5, 6, 7, 8, 9, 10, or more, such as each) lignin polymer that is opened; (ii) the at least one oxidized lignin is prepared by performing a modified Fenton reaction (e.g., a Fenton reaction with a chelator) with at least one (e.g., 1, 2, 3, 4, 5, 6, 7, 8, 9, 10, or more) lignin; (iii) the at least one oxidized lignin is prepared by a method comprising (a) mixing at least one lignin (e.g., water-insoluble lignin) and a chelator/Fe complex (e.g., at least one (e.g., 1, 2, 3, 4, 5, 6, 7, 8, 9, 10, or more) chelator (e.g., dihydroxybenzene), and at least one (e.g., 1, 2, 3, 4, 5, 6, 7, 8, 9, 10, or more) Fe salt (e.g., FeCl₃)) to produce a first reaction mixture, and optionally incubating the first reaction mixture, (b) mixing at least one (e.g., 1, 2, 3, 4, 5, 6, 7, 8, 9, 10, or more) oxidizing agent (e.g., H₂O₂, molecular oxygen (O₂), or a combination thereof) to the first reaction mixture to produce a second reaction mixture, and optionally incubating the second reaction mixture, thereby forming the at least one oxidized lignin (e.g., at least one oxidized lignin includes at least one (e.g., 1, 2, 3, 4, 5, 6, 7, 8, 9, 10, or more) comprising at least one aromatic ring of one or more lignin polymer that is opened); (iv) the at least one surfactant is derived from Kraft lignin; or (v) a combination thereof.

In any aspect or embodiment describe herein, the method of making the oxidized lignin further comprises (c) after mixing the at least one oxidizing agent to the first reaction mixture to produce the second reaction mixture or optionally incubating the second reaction mixture, adding additional at least one (e.g., 1, 2, 3, 4, 5, 6, 7, 8, 9, 10, or more) lignin (e.g., water-insoluble lignin), additional at least one (e.g., 1, 2, 3, 4, 5, 6, 7, 8, 9, 10, or more) oxidizing agent (e.g., H₂O₂, molecular oxygen (O₂), or a combination thereof), and optionally additional chelator/Fe complex, to the second reaction mixture, to produce a third reaction mixture, and optionally incubating the third reaction mixture, and (d) optionally repeating step (c), thereby forming the at least one oxidized lignin (e.g., at least one oxidized lignin includes at least one (e.g., 1, 2, 3, 4, 5, 6, 7, 8, 9, 10, or more) comprising at least one aromatic ring of one or more lignin polymer that is opened).

In any aspect or embodiment describe herein, (i) the chelator/Fe complex comprises at least one (e.g., 1, 2, 3, 4, 5, 6, 7, 8, 9, 10, or more) chelator (e.g., dihydroxybenzene) and at least one (e.g., 1, 2, 3, 4, 5, 6, 7, 8, 9, 10, or more) Fe salt (e.g., FeCl₃); (ii) at least about 90% of the at least one lignin in the reaction mixture is converted into the at least one oxidized lignin (e.g., at least one oxidized lignin includes at least one (e.g., 1, 2, 3, 4, 5, 6, 7, 8, 9, 10, or more) comprising at least one aromatic ring of one or more lignin polymer that is opened), such as a water-soluble polyacid by the opening of at least one aromatic ring in each water-insoluble lignin; or (iii) a combination thereof.

The preceding general areas of utility are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the invention may be utilized in numerous combinations, all of which are expressly contemplated by the present description. These additional advantages objects and embodiments expressly included within the scope of the present invention. The publications and other materials used herein to illuminate the background of the invention, and in particular cases, to provide additional details respecting the practice, are incorporated by reference.

### BRIEF DESCRIPTION OF THE DRAWINGS

The accompanying drawings, which are incorporated into and form a part of the specification, illustrate several embodiments of the present disclosure and, together with the description, serve to explain the principles of the disclosure. The drawings are only for the purpose of illustrating embodiments of the disclosure and are not to be construed as limiting the disclosure. Further objects, features and advantages of the disclosure will become apparent from the following detailed description taken in conjunction with the accompanying FIGS. showing illustrative embodiments of the disclosure.

FIG. 1. Exemplary pictures of the micronutrient formulation before (Day 1) and after being stored for 3 days.

### DETAILED DESCRIPTION

The present disclosure now will be described more fully hereinafter, but not all embodiments of the disclosure are shown. While the disclosure has been described with reference to exemplary embodiments, it will be understood by those skilled in the art that various changes may be made, and equivalents may be substituted for elements thereof without departing from the scope of the disclosure. In addition, many modifications may be made to adapt a particular structure or material to the teachings of the disclosure without departing from the essential scope thereof.

Where a range of values is provided, it is understood that each intervening value between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding both of those included limits are also included in the invention.

The following terms are used to describe the inventions of the present disclosure. In instances where a term is not specifically defined herein, that term is given an art-recognized meaning by those of ordinary skill applying that term in context to its use in describing the present invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or”, as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, that is, “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (that is, “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended (that is, to mean including but not limited to). It is expressly contemplated that all embodiments, and claims reciting one of the open-ended transitional phrases can be written with any other transitional phrase, which may be more limiting, unless clearly precluded by the context or art. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

### Exemplary Aspects and Embodiments

Surprisingly and unexpectedly, the inventors discovered that agricultural compositions/formulations developed using oxidized lignin were stable and surpassed performance metrics typically used for such compositions/formulations. Advantageously, such compositions/formulations where oxidized lignin is used can broaden the use of various lignin feedstocks, such as kraft lignin, lignin from lignocellulosic biorefineries and lignin derivatives, including lignosulfonates.

### Exemplary Active Component Compositions/Formulations

An aspect of the present disclosure relates to a composition or formulation (e.g., a suspension concentrate, an agricultural composition or formulation, a pesticidal composition or formulation, or a combination thereof) comprising, consisting essentially of, or consisting of: at least one (e.g., 1, 2, 3, 4, 5, 6, 7, 8, 9, 10, or more) active component comprising at least one (e.g., 1, 2, 3, 4, 5, 6, 7, 8, 9, 10, or more) pesticide, at least one (e.g., 1, 2, 3, 4, 5, 6, 7, 8, 9, 10, or more) biostimulant, or a combination thereof; at least one (e.g., 1, 2, 3, 4, 5, 6, 7, 8, 9, 10, or more) oxidized lignin; at least one (e.g., 1, 2, 3, 4, 5, 6, 7, 8, 9, 10, or more) surfactant; and at least one (e.g., 1, 2, 3, 4, 5, 6, 7, 8, 9, 10, or more) solvent, at least one (e.g., 1, 2, 3, 4, 5, 6, 7, 8, 9, 10, or more) filler (e.g., clay), or a combination thereof. For example, in any aspect or embodiment described herein, the at least one pesticide includes, consists essentially of, or is at least one (e.g., 1, 2, 3, 4, 5, 6, 7, 8, 9, 10, or more) fungicide, at least one (e.g., 1, 2, 3, 4, 5, 6, 7, 8, 9, 10, or more) herbicide, at least one (e.g., 1, 2, 3, 4, 5, 6, 7, 8, 9, 10, or more) insecticide, at least one (e.g., 1, 2, 3, 4, 5, 6, 7, 8, 9, 10, or more) biopesticide or its capsules, at least one (e.g., 1, 2, 3, 4, 5, 6, 7, 8, 9, 10, or more) algicide, at least one (e.g., 1, 2, 3, 4, 5, 6, 7, 8, 9, 10, or more) bactericide, at least one (e.g., 1, 2, 3, 4, 5, 6, 7, 8, 9, 10, or more) miticide, at least one (e.g., 1, 2, 3, 4, 5, 6, 7, 8, 9, 10, or more) molluscicide, at least one (e.g., 1, 2, 3, 4, 5, 6, 7, 8, 9, 10, or more) nematicide, at least one (e.g., 1, 2, 3, 4, 5, 6, 7, 8, 9, 10, or more) rodenticide, at least one (e.g., 1, 2, 3, 4, 5, 6, 7, 8, 9, 10, or more) virucide, or a combination thereof. Furthermore, in any aspect or embodiment described herein, (i) the surfactant includes, consists essentially of, or is an anionic surfactant (e.g., alkylnapthalene sulfonate), (ii) the solvent includes, consists essentially of, or is propylene glycol, or (iii) a combination thereof.

A further aspect of the present disclosure relates to a method of making the composition or formulation comprising of the present disclosure comprising an active component, the method comprising combining, and optionally mixing, the components of the composition. For example, in any aspect or embodiment described herein, mixing includes mixing with milling beads, mixing until the composition has a desired particle size, such as described herein, or a combination thereof.

In any aspect or embodiment describe herein, the at least one surfactant includes, consists essentially of, or is a non-ionic surfactant, an ionic surfactant, or a combination thereof. For example, in any aspect or embodiment described herein, the ionic surfactant includes, consists essentially of, or is a cationic surfactant, an anionic surfactant, an amphoteric surfactant, or a combination thereof.

In any aspect or embodiment describe herein, the composition comprises at least one solvent (e.g., water, the composition does not include a filler, or a combination thereof), and the composition further comprises (i) a D90 particle size of less than about 30 micron (e.g., less than about 29, less than about 28, less than about 27, less than about 26, less than about 25, less than about 24, less than about 23, less than about 22, less than about 21, or less than about 20 micron); (ii) a D50 particle size of less than about 15 micron (e.g., less than about 14, less than about 13, less than about 12, less than about 11, less than about 10, less than about 9, less than about 8, less than about 7, less than about 6, or less than about 5 micron); (iii) at least one (e.g., 1, 2, 3, 4, 5, 6, 7, 8, 9, 10, or more) anti-freezing agent or freezing point depressant (e.g., propylene glycol, urea, or a combination thereof); (iv) at least one (e.g., 1, 2, 3, 4, 5, 6, 7, 8, 9, 10, or more) defoamer (e.g., a silicone defoamer (e.g., polydimethylsiloxane (PDMS), silicone oil, silicone emulsion, or a combination thereof), a mineral oil based defoamer (e.g., paraffinic oil, naphthenic oil, vegetable oil, or a combination thereof), a fatty acid-based defoamer (e.g., a stearate, calcium stearate, oleate, tall oil fatty acids, or a combination thereof), a polymeric defoamer (e.g., polyacrylate, polyurethanes, or a combination thereof), a hydrophobic silica-based defoamer (e.g., hydrophobic fumed silica), or a combination thereof); or (v) a combination thereof.

In any aspect or embodiment described herein, the composition comprises at least one solvent (e.g., the composition does not include a filler), and the composition has a D90 particle size of about 1 to about 30 micron, about 1 to about 25 micron, about 1 to about 20 micron, about 1 to about 15 micron, about 1 to about 10 micron, about 1 to about 5 micron, about 5 to about 30 micron, about 5 to about 25 micron, about 5 to about 20 micron, about 5 to about 15 micron, about 5 to about 10 micron, about 10 to about 30 micron, about 10 to about 25 micron, about 10 to about 20 micron, about 10 to about 15 micron, about 15 to about 30 micron, about 15 to about 25 micron, about 15 to about 20 micron, about 20 to about 30 micron, about 20 to about 25 micron, or about 25 to about 30 micron.

In any aspect or embodiment described herein, the composition comprises at least one solvent (e.g., the composition does not include a filler), and the composition has a D50 particle size of about 1 micron to about 15 micron, about 2 micron to about 15 micron, about 3 micron to about 15 micron, about 4 micron to about 15 micron, about 5 micron to about 15 micron, about 6 micron to about 15 micron, about 7 micron to about 15 micron, about 8 micron to about 15 micron, about 9 micron to about 15 micron, about 10 micron to about 15 micron, about 11 micron to about 15 micron, about 12 micron to about 15 micron, about 13 micron to about 15 micron, about 14 micron to about 15 micron, about 1 micron to about 14 micron, about 2 micron to about 14 micron, about 3 micron to about 14 micron, about 4 micron to about 14 micron, about 5 micron to about 14 micron, about 6 micron to about 14 micron, about 7 micron to about 14 micron, about 8 micron to about 14 micron, about 9 micron to about 14 micron, about 10 micron to about 14 micron, about 11 micron to about 14 micron, about 12 micron to about 14 micron, about 13 micron to about 14 micron, about 1 micron to about 13 micron, about 2 micron to about 13 micron, about 3 micron to about 13 micron, about 4 micron to about 13 micron, about 5 micron to about 13 micron, about 6 micron to about 13 micron, about 7 micron to about 13 micron, about 8 micron to about 13 micron, about 9 micron to about 13 micron, about 10 micron to about 13 micron, about 11 micron to about 13 micron, about 12 micron to about 13 micron, about 1 micron to about 12 micron, about 2 micron to about 12 micron, about 3 micron to about 12 micron, about 4 micron to about 12 micron, about 5 micron to about 12 micron, about 6 micron to about 12 micron, about 7 micron to about 12 micron, about 8 micron to about 12 micron, about 9 micron to about 12 micron, about 10 micron to about 12 micron, about 11 micron to about 12 micron, about 1 micron to about 11 micron, about 2 micron to about 11 micron, about 3 micron to about 11 micron, about 4 micron to about 11 micron, about 5 micron to about 11 micron, about 6 micron to about 11 micron, about 7 micron to about 11 micron, about 8 micron to about 11 micron, about 9 micron to about 11 micron, about 10 micron to about 11 micron, about 1 micron to about 10 micron, about 2 micron to about 10 micron, about 3 micron to about 10 micron, about 4 micron to about 10 micron, about 5 micron to about 10 micron, about 6 micron to about 10 micron, about 7 micron to about 10 micron, about 8 micron to about 10 micron, about 9 micron to about 10 micron, about 1 micron to about 9 micron, about 2 micron to about 9 micron, about 3 micron to about 9 micron, about 4 micron to about 9 micron, about 5 micron to about 9 micron, about 6 micron to about 9 micron, about 7 micron to about 9 micron, about 8 micron to about 9 micron, about 1 micron to about 8 micron, about 2 micron to about 8 micron, about 3 micron to about 8 micron, about 4 micron to about 8 micron, about 5 micron to about 8 micron, about 6 micron to about 8 micron, about 7 micron to about 8 micron, about 1 micron to about 7 micron, about 2 micron to about 7 micron, about 3 micron to about 7 micron, about 4 micron to about 7 micron, about 5 micron to about 7 micron, about 6 micron to about 7 micron, about 1 micron to about 6 micron, about 2 micron to about 6 micron, about 3 micron to about 6 micron, about 4 micron to about 6 micron, about 5 micron to about 6 micron, about 1 micron to about 5 micron, about 2 micron to about 5 micron, about 3 micron to about 5 micron, about 4 micron to about 5 micron, about 1 micron to about 4 micron, about 2 micron to about 4 micron, about 3 micron to about 4 micron, about 1 micron to about 3 micron, about 2 micron to about 3 micron, or about 1 micron to about 2 micron.

In any aspect or embodiment described herein, the composition comprises at least one solvent (e.g., the composition does not include a filler), and (i) the at least one active component is present in an amount of about 0.5 wt % to about 15.0 wt %; (ii) the at least one oxidized lignin is present in the composition in an amount of about 0.5 to about 15.0 wt % (e.g., about 0.5 to about 5.0 wt % or about 1.0 to about 10.0 wt %); (iii) the at least one surfactant is present in an amount of about 0.01 wt % to about 5.0 wt % (e.g., about 0.1 wt % to about 2.0 wt %, about 0.5 wt % to about 1.5 wt %, or about 1.0 wt %); (iv) the at least one solvent is present in an amount of about 20.0 wt % to about 45.0 wt % (e.g., about 25.0 wt % to about 42.0 wt %, about 30.0 wt % to about 40.0 wt %, or about 35.0 wt % to about 39.0 wt %); (v) the at least one anti-freezing agent or freezing point depressant is present in an amount of about 1.0 wt % to about 10.0 wt % (e.g., about 2.5 wt % to about 7.5 wt %, about 4.0 wt % to about 6.0 wt %, about 5.0 wt %); (vi) the at least one defoamer is present in an amount of about 0.05 wt % to about 2.0 wt % (e.g., about 0.1 wt % to about 0.5 wt % or about 0.2 wt %); (vii) the at least one nutrient (e.g., at least one (e.g., 1, 2, 3, 4, 5, 6, 7, 8, 9, 10, or more) micronutrient, at least one (e.g., 1, 2, 3, 4, 5, 6, 7, 8, 9, 10, or more) macronutrient, or a combination thereof) is present in an amount of less than or equal to about 20.0 wt % (e.g., at least one micronutrient in an amount of less than or equal to about 3.0 wt %, at least one macronutrient in an amount of less than or equal to about 20.0 wt %, or a combination thereof); or (viii) a combination thereof.

In any aspect or embodiment describe herein, the at least one active component is present in an amount of about 0.5 wt % to about 15.0 wt %. For example, in any aspect or embodiment described herein the at least one active component is present in an amount of about 0.5 wt % to about 15.0 wt %, about 0.5 wt % to about 14.0 wt %, about 0.5 wt % to about 13.0 wt %, about 0.5 wt % to about 12.0 wt %, about 0.5 wt % to about 11.0 wt %, about 0.5 wt % to about 10.0 wt %, about 0.5 wt % to about 9.0 wt %, about 0.5 wt % to about 8.0 wt %, about 0.5 wt % to about 7.0 wt %, about 0.5 wt % to about 6.0 wt %, about 0.5 wt % to about 5.0 wt %, about 0.5 wt % to about 4.0 wt %, about 0.5 wt % to about 3.0 wt %, about 0.5 wt % to about 2.0 wt %, about 1.0 wt % to about 15.0 wt %, about 1.0 wt % to about 14.0 wt %, about 1.0 wt % to about 13.0 wt %, about 1.0 wt % to about 12.0 wt %, about 1.0 wt % to about 11.0 wt %, about 1.0 wt % to about 10.0 wt %, about 1.0 wt % to about 9.0 wt %, about 1.0 wt % to about 8.0 wt %, about 1.0 wt % to about 7.0 wt %, about 1.0 wt % to about 6.0 wt %, about 1.0 wt % to about 5.0 wt %, about 1.0 wt % to about 4.0 wt %, about 1.0 wt % to about 3.0 wt %, about 2.0 wt % to about 15.0 wt %, about 2.0 wt % to about 14.0 wt %, about 2.0 wt % to about 13.0 wt %, about 2.0 wt % to about 12.0 wt %, about 2.0 wt % to about 11.0 wt %, about 2.0 wt % to about 10.0 wt %, about 2.0 wt % to about 9.0 wt %, about 2.0 wt % to about 8.0 wt %, about 2.0 wt % to about 7.0 wt %, about 2.0 wt % to about 6.0 wt %, about 2.0 wt % to about 5.0 wt %, about 2.0 wt % to about 4.0 wt %, about 3.0 wt % to about 15.0 wt %, about 3.0 wt % to about 14.0 wt %, about 3.0 wt % to about 13.0 wt %, about 3.0 wt % to about 12.0 wt %, about 3.0 wt % to about 11.0 wt %, about 3.0 wt % to about 10.0 wt %, about 3.0 wt % to about 9.0 wt %, about 3.0 wt % to about 8.0 wt %, about 3.0 wt % to about 7.0 wt %, about 3.0 wt % to about 6.0 wt %, about 3.0 wt % to about 5.0 wt %, about 4.0 wt % to about 15.0 wt %, about 4.0 wt % to about 14.0 wt %, about 4.0 wt % to about 13.0 wt %, about 4.0 wt % to about 12.0 wt %, about 4.0 wt % to about 11.0 wt %, about 4.0 wt % to about 10.0 wt %, about 4.0 wt % to about 9.0 wt %, about 4.0 wt % to about 8.0 wt %, about 4.0 wt % to about 7.0 wt %, about 4.0 wt % to about 6.0 wt %, about 5.0 wt % to about 15.0 wt %, about 5.0 wt % to about 14.0 wt %, about 5.0 wt % to about 13.0 wt %, about 5.0 wt % to about 12.0 wt %, about 5.0 wt % to about 11.0 wt %, about 5.0 wt % to about 10.0 wt %, about 5.0 wt % to about 9.0 wt %, about 5.0 wt % to about 8.0 wt %, about 5.0 wt % to about 7.0 wt %, about 6.0 wt % to about 15.0 wt %, about 6.0 wt % to about 14.0 wt %, about 6.0 wt % to about 13.0 wt %, about 6.0 wt % to about 12.0 wt %, about 6.0 wt % to about 11.0 wt %, about 6.0 wt % to about 10.0 wt %, about 6.0 wt % to about 9.0 wt %, about 6.0 wt % to about 8.0 wt %, about 7.0 wt % to about 15.0 wt %, about 7.0 wt % to about 14.0 wt %, about 7.0 wt % to about 13.0 wt %, about 7.0 wt % to about 12.0 wt %, about 7.0 wt % to about 11.0 wt %, about 7.0 wt % to about 10.0 wt %, about 7.0 wt % to about 9.0 wt %, about 8.0 wt % to about 15.0 wt %, about 8.0 wt % to about 14.0 wt %, about 8.0 wt % to about 13.0 wt %, about 8.0 wt % to about 12.0 wt %, about 8.0 wt % to about 11.0 wt %, about 8.0 wt % to about 10.0 wt %, about 9.0 wt % to about 15.0 wt %, about 9.0 wt % to about 14.0 wt %, about 9.0 wt % to about 13.0 wt %, about 9.0 wt % to about 12.0 wt %, about 9.0 wt % to about 11.0 wt %, about 10.0 wt % to about 15.0 wt %, about 10.0 wt % to about 14.0 wt %, about 10.0 wt % to about 13.0 wt %, about 10.0 wt % to about 12.0 wt %, about 11.0 wt % to about 15.0 wt %, about 11.0 wt % to about 14.0 wt %, about 11.0 wt % to about 13.0 wt %, about 12.0 wt % to about 15.0 wt %, about 12.0 wt % to about 14.0 wt %, or about 13.0 wt % to about 15.0 wt %.

In any aspect or embodiment describe herein, the at least one oxidized lignin is present in the composition in an amount of about 0.5 to about 15.0 wt % (e.g., about 0.5 to about 5.0 wt % or about 1.0 to about 10.0 wt %). For example, in any aspect or embodiment described herein the at least one oxidized lignin is present in an amount of about 0.5 wt % to about 15.0 wt %, about 0.5 wt % to about 14.0 wt %, about 0.5 wt % to about 13.0 wt %, about 0.5 wt % to about 12.0 wt %, about 0.5 wt % to about 11.0 wt %, about 0.5 wt % to about 10.0 wt %, about 0.5 wt % to about 9.0 wt %, about 0.5 wt % to about 8.0 wt %, about 0.5 wt % to about 7.0 wt %, about 0.5 wt % to about 6.0 wt %, about 0.5 wt % to about 5.0 wt %, about 0.5 wt % to about 4.0 wt %, about 0.5 wt % to about 3.0 wt %, about 0.5 wt % to about 2.0 wt %, about 1.0 wt % to about 15.0 wt %, about 1.0 wt % to about 14.0 wt %, about 1.0 wt % to about 13.0 wt %, about 1.0 wt % to about 12.0 wt %, about 1.0 wt % to about 11.0 wt %, about 1.0 wt % to about 10.0 wt %, about 1.0 wt % to about 9.0 wt %, about 1.0 wt % to about 8.0 wt %, about 1.0 wt % to about 7.0 wt %, about 1.0 wt % to about 6.0 wt %, about 1.0 wt % to about 5.0 wt %, about 1.0 wt % to about 4.0 wt %, about 1.0 wt % to about 3.0 wt %, about 2.0 wt % to about 15.0 wt %, about 2.0 wt % to about 14.0 wt %, about 2.0 wt % to about 13.0 wt %, about 2.0 wt % to about 12.0 wt %, about 2.0 wt % to about 11.0 wt %, about 2.0 wt % to about 10.0 wt %, about 2.0 wt % to about 9.0 wt %, about 2.0 wt % to about 8.0 wt %, about 2.0 wt % to about 7.0 wt %, about 2.0 wt % to about 6.0 wt %, about 2.0 wt % to about 5.0 wt %, about 2.0 wt % to about 4.0 wt %, about 3.0 wt % to about 15.0 wt %, about 3.0 wt % to about 14.0 wt %, about 3.0 wt % to about 13.0 wt %, about 3.0 wt % to about 12.0 wt %, about 3.0 wt % to about 11.0 wt %, about 3.0 wt % to about 10.0 wt %, about 3.0 wt % to about 9.0 wt %, about 3.0 wt % to about 8.0 wt %, about 3.0 wt % to about 7.0 wt %, about 3.0 wt % to about 6.0 wt %, about 3.0 wt % to about 5.0 wt %, about 4.0 wt % to about 15.0 wt %, about 4.0 wt % to about 14.0 wt %, about 4.0 wt % to about 13.0 wt %, about 4.0 wt % to about 12.0 wt %, about 4.0 wt % to about 11.0 wt %, about 4.0 wt % to about 10.0 wt %, about 4.0 wt % to about 9.0 wt %, about 4.0 wt % to about 8.0 wt %, about 4.0 wt % to about 7.0 wt %, about 4.0 wt % to about 6.0 wt %, about 5.0 wt % to about 15.0 wt %, about 5.0 wt % to about 14.0 wt %, about 5.0 wt % to about 13.0 wt %, about 5.0 wt % to about 12.0 wt %, about 5.0 wt % to about 11.0 wt %, about 5.0 wt % to about 10.0 wt %, about 5.0 wt % to about 9.0 wt %, about 5.0 wt % to about 8.0 wt %, about 5.0 wt % to about 7.0 wt %, about 6.0 wt % to about 15.0 wt %, about 6.0 wt % to about 14.0 wt %, about 6.0 wt % to about 13.0 wt %, about 6.0 wt % to about 12.0 wt %, about 6.0 wt % to about 11.0 wt %, about 6.0 wt % to about 10.0 wt %, about 6.0 wt % to about 9.0 wt %, about 6.0 wt % to about 8.0 wt %, about 7.0 wt % to about 15.0 wt %, about 7.0 wt % to about 14.0 wt %, about 7.0 wt % to about 13.0 wt %, about 7.0 wt % to about 12.0 wt %, about 7.0 wt % to about 11.0 wt %, about 7.0 wt % to about 10.0 wt %, about 7.0 wt % to about 9.0 wt %, about 8.0 wt % to about 15.0 wt %, about 8.0 wt % to about 14.0 wt %, about 8.0 wt % to about 13.0 wt %, about 8.0 wt % to about 12.0 wt %, about 8.0 wt % to about 11.0 wt %, about 8.0 wt % to about 10.0 wt %, about 9.0 wt % to about 15.0 wt %, about 9.0 wt % to about 14.0 wt %, about 9.0 wt % to about 13.0 wt %, about 9.0 wt % to about 12.0 wt %, about 9.0 wt % to about 11.0 wt %, about 10.0 wt % to about 15.0 wt %, about 10.0 wt % to about 14.0 wt %, about 10.0 wt % to about 13.0 wt %, about 10.0 wt % to about 12.0 wt %, about 11.0 wt % to about 15.0 wt %, about 11.0 wt % to about 14.0 wt %, about 11.0 wt % to about 13.0 wt %, about 12.0 wt % to about 15.0 wt %, about 12.0 wt % to about 14.0 wt %, or about 13.0 wt % to about 15.0 wt %.

In any aspect or embodiment describe herein, the at least one surfactant is present in an amount of about 0.01 wt % to about 5.0 wt % (e.g., about 0.1 wt % to about 2.0 wt %, about 0.5 wt % to about 1.5 wt %, or about 1.0 wt %). For example, in any aspect or embodiment describe herein, the at least one surfactant is present in an amount of about 0.01 wt % to about 5.0 wt %, about 0.01 wt % to about 4.5 wt %, about 0.01 wt % to about 4.0 wt %, about 0.01 wt % to about 3.5 wt %, about 0.01 wt % to about 3.0 wt %, about 0.01 wt % to about 2.5 wt %, about 0.01 wt % to about 2.0 wt %, about 0.01 wt % to about 1.5 wt %, about 0.01 wt % to about 1.0 wt %, about 0.01 wt % to about 0.5 wt %, about 0.25 wt % to about 5.0 wt %, about 0.25 wt % to about 4.5 wt %, about 0.25 wt % to about 4.0 wt %, about 0.25 wt % to about 3.5 wt %, about 0.25 wt % to about 3.0 wt %, about 0.25 wt % to about 2.5 wt %, about 0.25 wt % to about 2.0 wt %, about 0.25 wt % to about 1.5 wt %, about 0.25 wt % to about 1.0 wt %, about 0.25 wt % to about 0.5 wt %, about 0.5 wt % to about 5.0 wt %, about 0.5 wt % to about 4.5 wt %, about 0.5 wt % to about 4.0 wt %, about 0.5 wt % to about 3.5 wt %, about 0.5 wt % to about 3.0 wt %, about 0.5 wt % to about 2.5 wt %, about 0.5 wt % to about 2.0 wt %, about 0.5 wt % to about 1.5 wt %, about 0.5 wt % to about 1.0 wt %, about 0.5 wt % to about 5.0 wt %, about 0.5 wt % to about 4.5 wt %, about 0.5 wt % to about 4.0 wt %, about 0.5 wt % to about 3.5 wt %, about 0.5 wt % to about 3.0 wt %, about 0.5 wt % to about 2.5 wt %, about 0.5 wt % to about 2.0 wt %, about 0.5 wt % to about 1.5 wt %, about 0.5 wt % to about 1.0 wt %, about 1.0 wt % to about 5.0 wt %, about 1.0 wt % to about 4.5 wt %, about 1.0 wt % to about 4.0 wt %, about 1.0 wt % to about 3.5 wt %, about 1.0 wt % to about 3.0 wt %, about 1.0 wt % to about 2.5 wt %, about 1.0 wt % to about 2.0 wt %, about 1.0 wt % to about 1.5 wt %, about 1.5 wt % to about 5.0 wt %, about 1.5 wt % to about 4.5 wt %, about 1.5 wt % to about 4.0 wt %, about 1.5 wt % to about 3.5 wt %, about 1.5 wt % to about 3.0 wt %, about 1.5 wt % to about 2.5 wt %, about 1.5 wt % to about 2.0 wt %, about 2.0 wt % to about 5.0 wt %, about 2.0 wt % to about 4.5 wt %, about 2.0 wt % to about 4.0 wt %, about 2.0 wt % to about 3.5 wt %, about 2.0 wt % to about 3.0 wt %, about 2.0 wt % to about 2.5 wt %, about 2.5 wt % to about 5.0 wt %, about 2.5 wt % to about 4.5 wt %, about 2.5 wt % to about 4.0 wt %, about 2.5 wt % to about 3.5 wt %, about 2.5 wt % to about 3.0 wt %, about 3.0 wt % to about 5.0 wt %, about 3.0 wt % to about 4.5 wt %, about 3.0 wt % to about 4.0 wt %, about 3.0 wt % to about 3.5 wt %, about 3.5 wt % to about 5.0 wt %, about 3.5 wt % to about 4.5 wt %, about 3.5 wt % to about 4.0 wt %, about 4.0 wt % to about 5.0 wt %, about 4.0 wt % to about 4.5 wt %, or about 4.5 wt % to about 5.0 wt %.

In any aspect or embodiment describe herein, the at least one anti-freezing agent or freezing point depressant is present in an amount of about 1.0 wt % to about 10.0 wt % (e.g., about 2.5 wt % to about 7.5 wt %, about 4.0 wt % to about 6.0 wt %, about 5.0 wt %). For example, in any aspect or embodiment described herein the at least one anti-freezing agent or freezing point depressant is present in an amount of about 1.0 wt % to about 10.0 wt %, about 1.0 wt % to about 9.0 wt %, about 1.0 wt % to about 8.0 wt %, about 1.0 wt % to about 7.0 wt %, about 1.0 wt % to about 6.0 wt %, about 1.0 wt % to about 5.0 wt %, about 1.0 wt % to about 4.0 wt %, about 1.0 wt % to about 3.0 wt %, about 2.0 wt % to about 10.0 wt %, about 2.0 wt % to about 9.0 wt %, about 2.0 wt % to about 8.0 wt %, about 2.0 wt % to about 7.0 wt %, about 2.0 wt % to about 6.0 wt %, about 2.0 wt % to about 5.0 wt %, about 2.0 wt % to about 4.0 wt %, about 3.0 wt % to about 10.0 wt %, about 3.0 wt % to about 9.0 wt %, about 3.0 wt % to about 8.0 wt %, about 3.0 wt % to about 7.0 wt %, about 3.0 wt % to about 6.0 wt %, about 3.0 wt % to about 5.0 wt %, about 4.0 wt % to about 10.0 wt %, about 4.0 wt % to about 9.0 wt %, about 4.0 wt % to about 8.0 wt %, about 4.0 wt % to about 7.0 wt %, about 4.0 wt % to about 6.0 wt %, about 5.0 wt % to about 10.0 wt %, about 5.0 wt % to about 9.0 wt %, about 5.0 wt % to about 8.0 wt %, about 5.0 wt % to about 7.0 wt %, about 6.0 wt % to about 10.0 wt %, about 6.0 wt % to about 9.0 wt %, about 6.0 wt % to about 8.0 wt %, about 7.0 wt % to about 10.0 wt %, about 7.0 wt % to about 9.0 wt %, about 8.0 wt % to about 10.0 wt %, or about 9.0 wt % to about 10.0 wt %.

In any aspect or embodiment describe herein, the at least one defoamer is present in an amount of about 0.05 wt % to about 2.0 wt % (e.g., about 0.1 wt % to about 0.5 wt % or about 0.2 wt %). For example, in any aspect or embodiment describe herein, the at least one defoamer is present in an amount of about 0.05 wt % to about 2.0 wt %, about 0.05 wt % to about 1.8 wt %, about 0.05 wt % to about 1.6 wt %, about 0.05 wt % to about 1.4 wt %, about 0.05 wt % to about 1.2 wt %, about 0.05 wt % to about 1.0 wt %, about 0.05 wt % to about 0.8 wt %, about 0.05 wt % to about 0.6 wt %, about 0.05 wt % to about 0.4 wt %, about 0.2 wt % to about 2.0 wt %, about 0.2 wt % to about 1.8 wt %, about 0.2 wt % to about 1.6 wt %, about 0.2 wt % to about 1.4 wt %, about 0.2 wt % to about 1.2 wt %, about 0.2 wt % to about 1.0 wt %, about 0.2 wt % to about 0.8 wt %, about 0.2 wt % to about 0.6 wt %, about 0.2 wt % to about 0.4 wt %, about 0.4 wt % to about 2.0 wt %, about 0.4 wt % to about 1.8 wt %, about 0.4 wt % to about 1.6 wt %, about 0.4 wt % to about 1.4 wt %, about 0.4 wt % to about 1.2 wt %, about 0.4 wt % to about 1.0 wt %, about 0.4 wt % to about 0.8 wt %, about 0.4 wt % to about 0.6 wt %, about 0.6 wt % to about 2.0 wt %, about 0.6 wt % to about 1.8 wt %, about 0.6 wt % to about 1.6 wt %, about 0.6 wt % to about 1.4 wt %, about 0.6 wt % to about 1.2 wt %, about 0.6 wt % to about 1.0 wt %, about 0.6 wt % to about 0.8 wt %, about 0.8 wt % to about 2.0 wt %, about 0.8 wt % to about 1.8 wt %, about 0.8 wt % to about 1.6 wt %, about 0.8 wt % to about 1.4 wt %, about 0.8 wt % to about 1.2 wt %, about 0.8 wt % to about 1.0 wt %, about 1.0 wt % to about 2.0 wt %, about 1.0 wt % to about 1.8 wt %, about 1.0 wt % to about 1.6 wt %, about 1.0 wt % to about 1.4 wt %, about 1.0 wt % to about 1.2 wt %, about 1.2 wt % to about 2.0 wt %, about 1.2 wt % to about 1.8 wt %, about 1.2 wt % to about 1.6 wt %, about 1.2 wt % to about 1.4 wt %, about 1.4 wt % to about 2.0 wt %, about 1.4 wt % to about 1.8 wt %, about 1.4 wt % to about 1.6 wt %, about 1.6 wt % to about 2.0 wt %, about 1.6 wt % to about 1.8 wt %, or about 1.8 wt % to about 2.0 wt %.

In any aspect or embodiment describe herein, the at least one solvent (e.g., water) is present in an amount of about 20.0 wt % to about 45.0 wt % (e.g., about 25.0 wt % to about 42.0 wt %, about 30.0 wt % to about 40.0 wt %, or about 35.0 wt % to about 39.0 wt %). For example, in any aspect or embodiment describe herein, the at least one solvent (e.g., water) is present in an amount of about 20.0 wt % to about 45.0 wt %, about 20.0 wt % to about 42.5 wt %, about 20.0 wt % to about 40.0 wt %, about 20.0 wt % to about 37.5 wt %, about 20.0 wt % to about 35.0 wt %, about 20.0 wt % to about 32.5 wt %, about 20.0 wt % to about 30.0 wt %, about 20.0 wt % to about 27.5 wt %, about 20.0 wt % to about 25.0 wt %, about 22.5 wt % to about 45.0 wt %, about 22.5 wt % to about 42.5 wt %, about 22.5 wt % to about 40.0 wt %, about 22.5 wt % to about 37.5 wt %, about 22.5 wt % to about 35.0 wt %, about 22.5 wt % to about 32.5 wt %, about 22.5 wt % to about 30.0 wt %, about 22.5 wt % to about 27.5 wt %, about 25.0 wt % to about 45.0 wt %, about 25.0 wt % to about 42.5 wt %, about 25.0 wt % to about 40.0 wt %, about 25.0 wt % to about 37.5 wt %, about 25.0 wt % to about 35.0 wt %, about 25.0 wt % to about 32.5 wt %, about 25.0 wt % to about 30.0 wt %, about 27.5 wt % to about 45.0 wt %, about 27.5 wt % to about 42.5 wt %, about 27.5 wt % to about 40.0 wt %, about 27.5 wt % to about 37.5 wt %, about 27.5 wt % to about 35.0 wt %, about 27.5 wt % to about 32.5 wt %, about 30.0 wt % to about 45.0 wt %, about 30.0 wt % to about 42.5 wt %, about 30.0 wt % to about 40.0 wt %, about 30.0 wt % to about 37.5 wt %, about 30.0 wt % to about 35.0 wt %, about 32.5 wt % to about 45.0 wt %, about 32.5 wt % to about 42.5 wt %, about 32.5 wt % to about 40.0 wt %, about 32.5 wt % to about 37.5 wt %, about 35.0 wt % to about 45.0 wt %, about 35.0 wt % to about 42.5 wt %, about 35.0 wt % to about 40.0 wt %, about 37.5 wt % to about 45.0 wt %, about 37.5 wt % to about 42.5 wt %, or about 40.0 wt % to about 45.0 wt %.

In any aspect or embodiment described herein, the at least one nutrient (e.g., at least one (e.g., 1, 2, 3, 4, 5, 6, 7, 8, 9, 10, or more) micronutrient, at least one (e.g., 1, 2, 3, 4, 5, 6, 7, 8, 9, 10, or more) macronutrient, or a combination thereof) is present in an amount of less than or equal to about 20 wt % (e.g., at least one micronutrient in an amount of less than or equal to about 3.0 wt %, at least one macronutrient in an amount of less than or equal to about 20.0 wt %, or a combination thereof) or less than or equal to about 10.0 wt %. For example, in any aspect or embodiment described herein, the at least one nutrient is present in an amount of about 0.1 wt % to about 20.0 wt %, about 0.1 wt % to about 19.0 wt %, about 0.1 wt % to about 18.0 wt %, about 0.1 wt % to about 17.0 wt %, about 0.1 wt % to about 16.0 wt %, about 0.1 wt % to about 15.0 wt %, about 0.1 wt % to about 14.0 wt %, about 0.1 wt % to about 13.0 wt %, about 0.1 wt % to about 12.0 wt %, about 0.1 wt % to about 11.0 wt %, about 0.1 wt % to about 10.0 wt %, about 0.1 wt % to about 9.0 wt %, about 0.1 wt % to about 8.0 wt %, about 0.1 wt % to about 7.0 wt %, about 0.1 wt % to about 6.0 wt %, about 0.1 wt % to about 5.0 wt %, about 0.1 wt % to about 4.0 wt %, about 0.1 wt % to about 3.0 wt %, about 0.1 wt % to about 2.0 wt %, about 0.1 wt % to about 1.0 wt %, about 0.5 wt % to about 20.0 wt %, about 0.5 wt % to about 19.0 wt %, about 0.5 wt % to about 18.0 wt %, about 0.5 wt % to about 17.0 wt %, about 0.5 wt % to about 16.0 wt %, about 0.5 wt % to about 15.0 wt %, about 0.5 wt % to about 14.0 wt %, about 0.5 wt % to about 13.0 wt %, about 0.5 wt % to about 12.0 wt %, about 0.5 wt % to about 11.0 wt %, about 0.5 wt % to about 10.0 wt %, about 0.5 wt % to about 9.0 wt %, about 0.5 wt % to about 8.0 wt %, about 0.5 wt % to about 7.0 wt %, about 0.5 wt % to about 6.0 wt %, about 0.5 wt % to about 5.0 wt %, about 0.5 wt % to about 4.0 wt %, about 0.5 wt % to about 3.0 wt %, about 0.5 wt % to about 2.0 wt %, about 1.0 wt % to about 20.0 wt %, about 1.0 wt % to about 19.0 wt %, about 1.0 wt % to about 18.0 wt %, about 1.0 wt % to about 17.0 wt %, about 1.0 wt % to about 16.0 wt %, about 1.0 wt % to about 15.0 wt %, about 1.0 wt % to about 14.0 wt %, about 1.0 wt % to about 13.0 wt %, about 1.0 wt % to about 12.0 wt %, about 1.0 wt % to about 11.0 wt %, about 1.0 wt % to about 10.0 wt %, about 1.0 wt % to about 9.0 wt %, about 1.0 wt % to about 8.0 wt %, about 1.0 wt % to about 7.0 wt %, about 1.0 wt % to about 6.0 wt %, about 1.0 wt % to about 5.0 wt %, about 1.0 wt % to about 4.0 wt %, about 1.0 wt % to about 3.0 wt %, about 1.0 wt % to about 2.0 wt %, about 2.0 wt % to about 20.0 wt %, about 2.0 wt % to about 19.0 wt %, about 2.0 wt % to about 18.0 wt %, about 2.0 wt % to about 17.0 wt %, about 2.0 wt % to about 16.0 wt %, about 2.0 wt % to about 15.0 wt %, about 2.0 wt % to about 14.0 wt %, about 2.0 wt % to about 13.0 wt %, about 2.0 wt % to about 12.0 wt %, about 2.0 wt % to about 11.0 wt %, about 2.0 wt % to about 10.0 wt %, about 2.0 wt % to about 9.0 wt %, about 2.0 wt % to about 8.0 wt %, about 2.0 wt % to about 7.0 wt %, about 2.0 wt % to about 6.0 wt %, about 2.0 wt % to about 5.0 wt %, about 2.0 wt % to about 4.0 wt %, about 2.0 wt % to about 3.0 wt %, about 3.0 wt % to about 20.0 wt %, about 3.0 wt % to about 19.0 wt %, about 3.0 wt % to about 18.0 wt %, about 3.0 wt % to about 17.0 wt %, about 3.0 wt % to about 16.0 wt %, about 3.0 wt % to about 15.0 wt %, about 3.0 wt % to about 14.0 wt %, about 3.0 wt % to about 13.0 wt %, about 3.0 wt % to about 12.0 wt %, about 3.0 wt % to about 11.0 wt %, about 3.0 wt % to about 10.0 wt %, about 3.0 wt % to about 9.0 wt %, about 3.0 wt % to about 8.0 wt %, about 3.0 wt % to about 7.0 wt %, about 3.0 wt % to about 6.0 wt %, about 3.0 wt % to about 5.0 wt %, about 3.0 wt % to about 4.0 wt %, about 4.0 wt % to about 20.0 wt %, about 3.0 wt % to about 19.0 wt %, about 3.0 wt % to about 18.0 wt %, about 3.0 wt % to about 17.0 wt %, about 4.0 wt % to about 16.0 wt %, about 4.0 wt % to about 15.0 wt %, about 4.0 wt % to about 14.0 wt %, about 4.0 wt % to about 13.0 wt %, about 4.0 wt % to about 12.0 wt %, about 4.0 wt % to about 11.0 wt %, about 4.0 wt % to about 10.0 wt %, about 4.0 wt % to about 9.0 wt %, about 4.0 wt % to about 8.0 wt %, about 4.0 wt % to about 7.0 wt %, about 4.0 wt % to about 6.0 wt %, about 4.0 wt % to about 5.0 wt %, about 5.0 wt % to about 20.0 wt %, about 5.0 wt % to about 19.0 wt %, about 5.0 wt % to about 18.0 wt %, about 5.0 wt % to about 17.0 wt %, about 5.0 wt % to about 16.0 wt %, about 5.0 wt % to about 15.0 wt %, about 5.0 wt % to about 14.0 wt %, about 5.0 wt % to about 13.0 wt %, about 5.0 wt % to about 12.0 wt %, about 5.0 wt % to about 11.0 wt %, about 5.0 wt % to about 10.0 wt %, about 5.0 wt % to about 9.0 wt %, about 5.0 wt % to about 8.0 wt %, about 5.0 wt % to about 7.0 wt %, about 5.0 wt % to about 6.0 wt %, about 6.0 wt % to about 20.0 wt %, about 6.0 wt % to about 19.0 wt %, about 6.0 wt % to about 18.0 wt %, about 6.0 wt % to about 17.0 wt %, about 6.0 wt % to about 16.0 wt %, about 6.0 wt % to about 15.0 wt %, about 6.0 wt % to about 14.0 wt %, about 6.0 wt % to about 13.0 wt %, about 6.0 wt % to about 12.0 wt %, about 6.0 wt % to about 11.0 wt %, about 6.0 wt % to about 10.0 wt %, about 6.0 wt % to about 9.0 wt %, about 6.0 wt % to about 8.0 wt %, about 6.0 wt % to about 7.0 wt %, about 7.0 wt % to about 20.0 wt %, about 7.0 wt % to about 19.0 wt %, about 7.0 wt % to about 18.0 wt %, about 7.0 wt % to about 17.0 wt %, about 7.0 wt % to about 16.0 wt %, about 7.0 wt % to about 15.0 wt %, about 7.0 wt % to about 14.0 wt %, about 7.0 wt % to about 13.0 wt %, about 7.0 wt % to about 12.0 wt %, about 7.0 wt % to about 11.0 wt %, about 7.0 wt % to about 10.0 wt %, about 7.0 wt % to about 9.0 wt %, about 7.0 wt % to about 8.0 wt %, about 8.0 wt % to about 20.0 wt %, about 8.0 wt % to about 19.0 wt %, about 8.0 wt % to about 18.0 wt %, about 8.0 wt % to about 17.0 wt %, about 8.0 wt % to about 16.0 wt %, about 8.0 wt % to about 15.0 wt %, about 8.0 wt % to about 14.0 wt %, about 8.0 wt % to about 13.0 wt %, about 8.0 wt % to about 12.0 wt %, about 8.0 wt % to about 11.0 wt %, about 8.0 wt % to about 10.0 wt %, about 8.0 wt % to about 9.0 wt %, about 9.0 wt % to about 20.0 wt %, about 9.0 wt % to about 19.0 wt %, about 9.0 wt % to about 18.0 wt %, about 9.0 wt % to about 17.0 wt %, about 9.0 wt % to about 16.0 wt %, about 9.0 wt % to about 15.0 wt %, about 9.0 wt % to about 14.0 wt %, about 9.0 wt % to about 13.0 wt %, about 9.0 wt % to about 12.0 wt %, about 9.0 wt % to about 11.0 wt %, about 9.0 wt % to about 10.0 wt %, about 10.0 wt % to about 20.0 wt %, about 10.0 wt % to about 19.0 wt %, about 10.0 wt % to about 18.0 wt %, about 10.0 wt % to about 17.0 wt %, about 10.0 wt % to about 16.0 wt %, about 10.0 wt % to about 15.0 wt %, about 10.0 wt % to about 14.0 wt %, about 10.0 wt % to about 13.0 wt %, about 10.0 wt % to about 12.0 wt %, about 10.0 wt % to about 11.0 wt %, about 11.0 wt % to about 20.0 wt %, about 11.0 wt % to about 19.0 wt %, about 11.0 wt % to about 18.0 wt %, about 11.0 wt % to about 17.0 wt %, about 11.0 wt % to about 16.0 wt %, about 11.0 wt % to about 15.0 wt %, about 11.0 wt % to about 14.0 wt %, about 11.0 wt % to about 13.0 wt %, about 11.0 wt % to about 12.0 wt %, about 12.0 wt % to about 20.0 wt %, about 12.0 wt % to about 19.0 wt %, about 12.0 wt % to about 18.0 wt %, about 12.0 wt % to about 17.0 wt %, about 12.0 wt % to about 16.0 wt %, about 12.0 wt % to about 15.0 wt %, about 12.0 wt % to about 14.0 wt %, about 12.0 wt % to about 13.0 wt %, about 13.0 wt % to about 20.0 wt %, about 13.0 wt % to about 19.0 wt %, about 13.0 wt % to about 18.0 wt %, about 13.0 wt % to about 17.0 wt %, about 13.0 wt % to about 16.0 wt %, about 13.0 wt % to about 15.0 wt %, about 13.0 wt % to about 14.0 wt %, about 14.0 wt % to about 20.0 wt %, about 14.0 wt % to about 19.0 wt %, about 14.0 wt % to about 18.0 wt %, about 14.0 wt % to about 17.0 wt %, about 14.0 wt % to about 16.0 wt %, about 14.0 wt % to about 15.0 wt %, about 15.0 wt % to about 20.0 wt %, about 15.0 wt % to about 19.0 wt %, about 15.0 wt % to about 18.0 wt %, about 15.0 wt % to about 17.0 wt %, about 15.0 wt % to about 16.0 wt %, about 16.0 wt % to about 20.0 wt %, about 16.0 wt % to about 19.0 wt %, about 16.0 wt % to about 18.0 wt %, about 16.0 wt % to about 17.0 wt %, about 17.0 wt % to about 20.0 wt %, about 17.0 wt % to about 19.0 wt %, about 17.0 wt % to about 18.0 wt %, about 18.0 wt % to about 20.0 wt %, about 18.0 wt % to about 19.0 wt %, or about 19.0 wt % to about 20.0 wt %.

In any aspect or embodiment described herein, the at least one micronutrient is present in an amount of about 0.1 wt % to about 3.0 wt %, about 0.1 wt % to about 2.5 wt %, about 0.1 wt % to about 2.0 wt %, about 0.1 wt % to about 1.5 wt %, about 0.1 wt % to about 1.0 wt %, about 0.1 wt % to about 0.5 wt %, about 0.5 wt % to about 3.0 wt %, about 0.5 wt % to about 2.5 wt %, about 0.5 wt % to about 2.0 wt %, about 0.5 wt % to about 1.5 wt %, about 0.5 wt % to about 1.0 wt %, about 1.0 wt % to about 3.0 wt %, about 1.0 wt % to about 2.5 wt %, about 1.0 wt % to about 2.0 wt %, about 1.0 wt % to about 1.5 wt %, about 1.5 wt % to about 3.0 wt %, about 1.5 wt % to about 2.5 wt %, about 1.5 wt % to about 2.0 wt %, about 2.0 wt % to about 3.0 wt %, about 2.0 wt % to about 2.5 wt %, or about 2.5 wt % to about 3.0 wt %. In any aspect or embodiment described herein, the at least one macronutrient is present in an amount of about 0.1 wt % to about 20.0 wt %, about 0.1 wt % to about 19.0 wt %, about 0.1 wt % to about 18.0 wt %, about 0.1 wt % to about 17.0 wt %, about 0.1 wt % to about 16.0 wt %, about 0.1 wt % to about 15.0 wt %, about 0.1 wt % to about 14.0 wt %, about 0.1 wt % to about 13.0 wt %, about 0.1 wt % to about 12.0 wt %, about 0.1 wt % to about 11.0 wt %, about 0.1 wt % to about 10.0 wt %, about 0.1 wt % to about 9.0 wt %, about 0.1 wt % to about 8.0 wt %, about 0.1 wt % to about 7.0 wt %, about 0.1 wt % to about 6.0 wt %, about 0.1 wt % to about 5.0 wt %, about 0.1 wt % to about 4.0 wt %, about 0.1 wt % to about 3.0 wt %, about 0.1 wt % to about 2.0 wt %, about 0.1 wt % to about 1.0 wt %, about 0.5 wt % to about 20.0 wt %, about 0.5 wt % to about 19.0 wt %, about 0.5 wt % to about 18.0 wt %, about 0.5 wt % to about 17.0 wt %, about 0.5 wt % to about 16.0 wt %, about 0.5 wt % to about 15.0 wt %, about 0.5 wt % to about 14.0 wt %, about 0.5 wt % to about 13.0 wt %, about 0.5 wt % to about 12.0 wt %, about 0.5 wt % to about 11.0 wt %, about 0.5 wt % to about 10.0 wt %, about 0.5 wt % to about 9.0 wt %, about 0.5 wt % to about 8.0 wt %, about 0.5 wt % to about 7.0 wt %, about 0.5 wt % to about 6.0 wt %, about 0.5 wt % to about 5.0 wt %, about 0.5 wt % to about 4.0 wt %, about 0.5 wt % to about 3.0 wt %, about 0.5 wt % to about 2.0 wt %, about 1.0 wt % to about 20.0 wt %, about 1.0 wt % to about 19.0 wt %, about 1.0 wt % to about 18.0 wt %, about 1.0 wt % to about 17.0 wt %, about 1.0 wt % to about 16.0 wt %, about 1.0 wt % to about 15.0 wt %, about 1.0 wt % to about 14.0 wt %, about 1.0 wt % to about 13.0 wt %, about 1.0 wt % to about 12.0 wt %, about 1.0 wt % to about 11.0 wt %, about 1.0 wt % to about 10.0 wt %, about 1.0 wt % to about 9.0 wt %, about 1.0 wt % to about 8.0 wt %, about 1.0 wt % to about 7.0 wt %, about 1.0 wt % to about 6.0 wt %, about 1.0 wt % to about 5.0 wt %, about 1.0 wt % to about 4.0 wt %, about 1.0 wt % to about 3.0 wt %, about 1.0 wt % to about 2.0 wt %, about 2.0 wt % to about 20.0 wt %, about 2.0 wt % to about 19.0 wt %, about 2.0 wt % to about 18.0 wt %, about 2.0 wt % to about 17.0 wt %, about 2.0 wt % to about 16.0 wt %, about 2.0 wt % to about 15.0 wt %, about 2.0 wt % to about 14.0 wt %, about 2.0 wt % to about 13.0 wt %, about 2.0 wt % to about 12.0 wt %, about 2.0 wt % to about 11.0 wt %, about 2.0 wt % to about 10.0 wt %, about 2.0 wt % to about 9.0 wt %, about 2.0 wt % to about 8.0 wt %, about 2.0 wt % to about 7.0 wt %, about 2.0 wt % to about 6.0 wt %, about 2.0 wt % to about 5.0 wt %, about 2.0 wt % to about 4.0 wt %, about 2.0 wt % to about 3.0 wt %, about 3.0 wt % to about 20.0 wt %, about 3.0 wt % to about 19.0 wt %, about 3.0 wt % to about 18.0 wt %, about 3.0 wt % to about 17.0 wt %, about 3.0 wt % to about 16.0 wt %, about 3.0 wt % to about 15.0 wt %, about 3.0 wt % to about 14.0 wt %, about 3.0 wt % to about 13.0 wt %, about 3.0 wt % to about 12.0 wt %, about 3.0 wt % to about 11.0 wt %, about 3.0 wt % to about 10.0 wt %, about 3.0 wt % to about 9.0 wt %, about 3.0 wt % to about 8.0 wt %, about 3.0 wt % to about 7.0 wt %, about 3.0 wt % to about 6.0 wt %, about 3.0 wt % to about 5.0 wt %, about 3.0 wt % to about 4.0 wt %, about 4.0 wt % to about 20.0 wt %, about 3.0 wt % to about 19.0 wt %, about 3.0 wt % to about 18.0 wt %, about 3.0 wt % to about 17.0 wt %, about 4.0 wt % to about 16.0 wt %, about 4.0 wt % to about 15.0 wt %, about 4.0 wt % to about 14.0 wt %, about 4.0 wt % to about 13.0 wt %, about 4.0 wt % to about 12.0 wt %, about 4.0 wt % to about 11.0 wt %, about 4.0 wt % to about 10.0 wt %, about 4.0 wt % to about 9.0 wt %, about 4.0 wt % to about 8.0 wt %, about 4.0 wt % to about 7.0 wt %, about 4.0 wt % to about 6.0 wt %, about 4.0 wt % to about 5.0 wt %, about 5.0 wt % to about 20.0 wt %, about 5.0 wt % to about 19.0 wt %, about 5.0 wt % to about 18.0 wt %, about 5.0 wt % to about 17.0 wt %, about 5.0 wt % to about 16.0 wt %, about 5.0 wt % to about 15.0 wt %, about 5.0 wt % to about 14.0 wt %, about 5.0 wt % to about 13.0 wt %, about 5.0 wt % to about 12.0 wt %, about 5.0 wt % to about 11.0 wt %, about 5.0 wt % to about 10.0 wt %, about 5.0 wt % to about 9.0 wt %, about 5.0 wt % to about 8.0 wt %, about 5.0 wt % to about 7.0 wt %, about 5.0 wt % to about 6.0 wt %, about 6.0 wt % to about 20.0 wt %, about 6.0 wt % to about 19.0 wt %, about 6.0 wt % to about 18.0 wt %, about 6.0 wt % to about 17.0 wt %, about 6.0 wt % to about 16.0 wt %, about 6.0 wt % to about 15.0 wt %, about 6.0 wt % to about 14.0 wt %, about 6.0 wt % to about 13.0 wt %, about 6.0 wt % to about 12.0 wt %, about 6.0 wt % to about 11.0 wt %, about 6.0 wt % to about 10.0 wt %, about 6.0 wt % to about 9.0 wt %, about 6.0 wt % to about 8.0 wt %, about 6.0 wt % to about 7.0 wt %, about 7.0 wt % to about 20.0 wt %, about 7.0 wt % to about 19.0 wt %, about 7.0 wt % to about 18.0 wt %, about 7.0 wt % to about 17.0 wt %, about 7.0 wt % to about 16.0 wt %, about 7.0 wt % to about 15.0 wt %, about 7.0 wt % to about 14.0 wt %, about 7.0 wt % to about 13.0 wt %, about 7.0 wt % to about 12.0 wt %, about 7.0 wt % to about 11.0 wt %, about 7.0 wt % to about 10.0 wt %, about 7.0 wt % to about 9.0 wt %, about 7.0 wt % to about 8.0 wt %, about 8.0 wt % to about 20.0 wt %, about 8.0 wt % to about 19.0 wt %, about 8.0 wt % to about 18.0 wt %, about 8.0 wt % to about 17.0 wt %, about 8.0 wt % to about 16.0 wt %, about 8.0 wt % to about 15.0 wt %, about 8.0 wt % to about 14.0 wt %, about 8.0 wt % to about 13.0 wt %, about 8.0 wt % to about 12.0 wt %, about 8.0 wt % to about 11.0 wt %, about 8.0 wt % to about 10.0 wt %, about 8.0 wt % to about 9.0 wt %, about 9.0 wt % to about 20.0 wt %, about 9.0 wt % to about 19.0 wt %, about 9.0 wt % to about 18.0 wt %, about 9.0 wt % to about 17.0 wt %, about 9.0 wt % to about 16.0 wt %, about 9.0 wt % to about 15.0 wt %, about 9.0 wt % to about 14.0 wt %, about 9.0 wt % to about 13.0 wt %, about 9.0 wt % to about 12.0 wt %, about 9.0 wt % to about 11.0 wt %, about 9.0 wt % to about 10.0 wt %, about 10.0 wt % to about 20.0 wt %, about 10.0 wt % to about 19.0 wt %, about 10.0 wt % to about 18.0 wt %, about 10.0 wt % to about 17.0 wt %, about 10.0 wt % to about 16.0 wt %, about 10.0 wt % to about 15.0 wt %, about 10.0 wt % to about 14.0 wt %, about 10.0 wt % to about 13.0 wt %, about 10.0 wt % to about 12.0 wt %, about 10.0 wt % to about 11.0 wt %, about 11.0 wt % to about 20.0 wt %, about 11.0 wt % to about 19.0 wt %, about 11.0 wt % to about 18.0 wt %, about 11.0 wt % to about 17.0 wt %, about 11.0 wt % to about 16.0 wt %, about 11.0 wt % to about 15.0 wt %, about 11.0 wt % to about 14.0 wt %, about 11.0 wt % to about 13.0 wt %, about 11.0 wt % to about 12.0 wt %, about 12.0 wt % to about 20.0 wt %, about 12.0 wt % to about 19.0 wt %, about 12.0 wt % to about 18.0 wt %, about 12.0 wt % to about 17.0 wt %, about 12.0 wt % to about 16.0 wt %, about 12.0 wt % to about 15.0 wt %, about 12.0 wt % to about 14.0 wt %, about 12.0 wt % to about 13.0 wt %, about 13.0 wt % to about 20.0 wt %, about 13.0 wt % to about 19.0 wt %, about 13.0 wt % to about 18.0 wt %, about 13.0 wt % to about 17.0 wt %, about 13.0 wt % to about 16.0 wt %, about 13.0 wt % to about 15.0 wt %, about 13.0 wt % to about 14.0 wt %, about 14.0 wt % to about 20.0 wt %, about 14.0 wt % to about 19.0 wt %, about 14.0 wt % to about 18.0 wt %, about 14.0 wt % to about 17.0 wt %, about 14.0 wt % to about 16.0 wt %, about 14.0 wt % to about 15.0 wt %, about 15.0 wt % to about 20.0 wt %, about 15.0 wt % to about 19.0 wt %, about 15.0 wt % to about 18.0 wt %, about 15.0 wt % to about 17.0 wt %, about 15.0 wt % to about 16.0 wt %, about 16.0 wt % to about 20.0 wt %, about 16.0 wt % to about 19.0 wt %, about 16.0 wt % to about 18.0 wt %, about 16.0 wt % to about 17.0 wt %, about 17.0 wt % to about 20.0 wt %, about 17.0 wt % to about 19.0 wt %, about 17.0 wt % to about 18.0 wt %, about 18.0 wt % to about 20.0 wt %, about 18.0 wt % to about 19.0 wt %, or about 19.0 wt % to about 20.0 wt %.

In any aspect or embodiment described herein, the at least one active component includes, consists essentially of, or is at least one (e.g., 1, 2, 3, 4, 5, 6, 7, 8, 9, 10, or more) biopesticide, at least one (e.g., 1, 2, 3, 4, 5, 6, 7, 8, 9, 10, or more) biostimulant, or a combination thereof, and (i) the composition (e.g., a dry composition, such as a wettable powder or granules) comprises at least one filler (e.g., the composition does not comprise a solvent, the at least one filler includes clay, or a combination thereof) and optionally further comprises at least one (e.g., 1, 2, 3, 4, 5, 6, 7, 8, 9, 10, or more) binder, or (ii) the composition (e.g. an aqueous composition or suspension concentrate) comprises the at least one solvent (e.g., the composition does not comprise a filler, the at least one solvent comprises polyoxyethylene (20) sorbitan monolaurate, or a combination thereof) and optionally further comprises (a) at least one (e.g., 1, 2, 3, 4, 5, 6, 7, 8, 9, 10, or more) anti-freezing agent or freezing point depressant (e.g., propylene glycol, urea, or a combination thereof), (b) at least one (e.g., 1, 2, 3, 4, 5, 6, 7, 8, 9, 10, or more) preservative (e.g., methyl p-hydroxybenzoate), (c) at least one (e.g., 1, 2, 3, 4, 5, 6, 7, 8, 9, 10, or more) protectant (e.g., polyethylene glycol), or (d) a combination thereof.

In any aspect or embodiment described herein, the at least one binder includes, consists essentially of, or is a starch, cellulose derivative (e.g., methyl cellulose, hydroxypropyl cellulose, carboxymethyl cellulose, or a combination thereof), gelatin, polyvinyl alcohol, polyvinyl acetate, lignosulfonate, bentonite clay, alginate, pectin, polyacrylamide, or a combination thereof.

In any aspect or embodiment described herein, the at least one protectant includes, consists essentially of, or is at least one polyethylene glycol (e.g., a polyethylene glycol having a molecular weight of about 200 to about 1000, about 300 to about 500, about 350 to about 450, or about 400), at least one polypropylene glycol (e.g., a polypropylene glycol having a molecular weight of about 200 to about 1000, about 300 to about 500, or about 400), or a combination thereof.

In any aspect or embodiment described herein, the at least one polyethylene glycol has a molecular weight of about 200 to about 1000, about 200 to about 900, about 200 to about 800, about 200 to about 700, about 200 to about 600, about 200 to about 500, about 200 to about 400, about 200 to about 300, about 300 to about 1000, about 300 to about 900, about 300 to about 800, about 300 to about 700, about 300 to about 600, about 300 to about 500, about 300 to about 400, about 400 to about 1000, about 400 to about 900, about 400 to about 800, about 400 to about 700, about 400 to about 600, about 400 to about 500, about 500 to about 1000, about 500 to about 900, about 500 to about 800, about 500 to about 700, about 500 to about 600, about 600 to about 1000, about 600 to about 900, about 600 to about 800, about 600 to about 700, about 700 to about 1000, about 700 to about 900, about 700 to about 800, about 800 to about 1000, about 800 to about 900, or about 900 to about 1000.

In any aspect or embodiment described herein, the at least one polypropylene glycol has a molecular weight of about 200 to about 1000, about 200 to about 900, about 200 to about 800, about 200 to about 700, about 200 to about 600, about 200 to about 500, about 200 to about 400, about 200 to about 300, about 300 to about 1000, about 300 to about 900, about 300 to about 800, about 300 to about 700, about 300 to about 600, about 300 to about 500, about 300 to about 400, about 400 to about 1000, about 400 to about 900, about 400 to about 800, about 400 to about 700, about 400 to about 600, about 400 to about 500, about 500 to about 1000, about 500 to about 900, about 500 to about 800, about 500 to about 700, about 500 to about 600, about 600 to about 1000, about 600 to about 900, about 600 to about 800, about 600 to about 700, about 700 to about 1000, about 700 to about 900, about 700 to about 800, about 800 to about 1000, about 800 to about 900, or about 900 to about 1000.

Exemplary Dry Biopesticide(s) and/or Biostimulant(s) Containing Compositions/Formulations

In any aspect or embodiment described herein, the at least one active component includes, consists essentially of, or is at least one (e.g., 1, 2, 3, 4, 5, 6, 7, 8, 9, 10, or more) biopesticide, at least one (e.g., 1, 2, 3, 4, 5, 6, 7, 8, 9, 10, or more) biostimulant, or a combination thereof, and the composition (e.g., a dry composition, such as a wettable powder or granules) comprises at least one filler (e.g., the composition does not comprise a solvent, the at least one filler includes clay, or a combination thereof) and optionally further comprises at least one (e.g., 1, 2, 3, 4, 5, 6, 7, 8, 9, 10, or more) binder.

In any aspect or embodiment described herein, (i) the composition has a D90 particle size of less than about 100 micron (e.g., less than about 99, less than about 98, less than about 97, less than about 96, less than about 95, less than about 94, less than about 93, less than about 92, less than about 91, less than about 90, less than about 89, less than about 88, less than about 87, less than about 86, less than about 85, less than about 84, less than about 83, less than about 82, less than about 81, less than about 80, less than about 75, less than about 70, less than about 65, or less than about 60 micron); (ii) the composition has a D50 particle size of less than about 10 micron (e.g., less than about 9, less than about 8, less than about 7, less than about 6, or less than about 5 micron); (iii) the at least one active component is present in an amount of about 5.0 wt % to about 90.0 wt % (e.g., about 5.0 wt % to about 25.0 wt %); (iv) the at least one oxidized lignin is present in the composition in an amount of about 0.5 to about 15.0 wt % (e.g., about 0.5 to about 5.0 wt % or about 1.0 to about 10 wt %); (v) the at least one surfactant is present in an amount of about 0.01 wt % to about 7.5 wt % (e.g., about 0.1 wt % to about 7.0 wt %, about 0.5 wt % to about 6.5 wt %, about 4.0 wt % to about 6.0 wt %, or about 5.0 wt %); (vi) the at least one filler is present in an amount of about 5.0 wt % to about 90.0 wt % (e.g., about 55.0 wt % to about 90.0 wt % (e.g., about 60.0 wt % to about 80.0 wt %, about 65.0 wt % to about 75.0 wt %, or about 71.0 wt %); (vii) the at least one binder is present in an amount of less than or equal to about 10.0 wt % (e.g., about 1.0 wt % to about 5.0 wt %); (viii) the at least one nutrient (e.g., at least one (e.g., 1, 2, 3, 4, 5, 6, 7, 8, 9, 10, or more) micronutrient, at least one (e.g., 1, 2, 3, 4, 5, 6, 7, 8, 9, 10, or more) macronutrient, or a combination thereof) is present in an amount of less than or equal to about 20.0 wt % (e.g., at least one micronutrient in an amount of less than or equal to about 3.0 wt %, at least one macronutrient in an amount of less than or equal to about 20.0 wt %, or a combination thereof); or (ix) a combination thereof.

In any aspect or embodiment described herein, the composition has a D90 particle size of less than about 100 micron (e.g., less than about 99, less than about 98, less than about 97, less than about 96, less than about 95, less than about 94, less than about 93, less than about 92, less than about 91, less than about 90, less than about 89, less than about 88, less than about 87, less than about 86, less than about 85, less than about 84, less than about 83, less than about less than 82, less than about 81, less than about 80, less than about 75, less than about 70, less than about 65, or less than about 60 micron). For example, in any aspect or embodiment described herein, the composition has a D90 particle size of about 10 to about 100 micron, about 10 to about 90 micron, about 10 to about 80 micron, about 10 to about 70 micron, about 10 to about 60 micron, about 10 to about 50 micron, about 10 to about 40 micron, about 10 to about 30 micron, about 10 to about 20 micron, about 20 to about 100 micron, about 20 to about 90 micron, about 20 to about 80 micron, about 20 to about 70 micron, about 20 to about 60 micron, about 20 to about 50 micron, about 20 to about 40 micron, about 20 to about 30 micron, about 30 to about 100 micron, about 30 to about 90 micron, about 30 to about 80 micron, about 30 to about 70 micron, about 30 to about 60 micron, about 30 to about 50 micron, about 30 to about 40 micron, about 40 to about 100 micron, about 40 to about 90 micron, about 40 to about 80 micron, about 40 to about 70 micron, about 40 to about 60 micron, about 40 to about 50 micron, about 50 to about 100 micron, about 50 to about 90 micron, about 50 to about 80 micron, about 50 to about 70 micron, about 50 to about 60 micron, about 60 to about 100 micron, about 60 to about 90 micron, about 60 to about 80 micron, about 60 to about 70 micron, about 70 to about 100 micron, about 70 to about 90 micron, about 70 to about 80 micron, about 80 to about 100 micron, about 80 to about 90 micron, or about 90 to about 100 micron.

In any aspect or embodiment described herein, the composition has a D50 particle size of less than about 10 micron (e.g., less than about 9, less than about 8, less than about 7, less than about 6, or less than about 5 micron). For example, in any aspect or embodiment described herein, the composition has a D50 particle size of about 1 micron to about 10 micron, about 1 micron to about 9 micron, about 1 micron to about 8 micron, about 1 micron to about 7 micron, about 1 micron to about 6 micron, about 1 micron to about 5 micron, about 1 micron to about 4 micron, about 1 micron to about 3 micron, about 1 micron to about 2 micron, about 2 micron to about 10 micron, about 2 micron to about 9 micron, about 2 micron to about 8 micron, about 2 micron to about 7 micron, about 2 micron to about 6 micron, about 2 micron to about 5 micron, about 2 micron to about 4 micron, about 2 micron to about 3 micron, about 3 micron to about 10 micron, about 3 micron to about 9 micron, about 3 micron to about 8 micron, about 3 micron to about 7 micron, about 3 micron to about 6 micron, about 3 micron to about 5 micron, about 3 micron to about 4 micron, about 4 micron to about 10 micron, about 4 micron to about 9 micron, about 4 micron to about 8 micron, about 4 micron to about 7 micron, about 4 micron to about 6 micron, about 4 micron to about 5 micron, about 5 micron to about 10 micron, about 5 micron to about 9 micron, about 5 micron to about 8 micron, about 5 micron to about 7 micron, about 5 micron to about 6 micron, about 6 micron to about 10 micron, about 6 micron to about 9 micron, about 6 micron to about 8 micron, about 6 micron to about 7 micron, about 7 micron to about 10 micron, about 7 micron to about 9 micron, about 7 micron to about 8 micron, about 8 micron to about 10 micron, about 8 micron to about 9 micron, or about 9 micron to about 10 micron.

In any aspect or embodiment described herein, the at least one active component is present in an amount of about 5.0 wt % to about 90.0 wt % (e.g., about 5.0 wt % to about 25.0 wt %). For example, in any aspect or embodiment described herein, the at least one active component is present in an amount of about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 90.0 wt %, about 70.0 wt % to about 85.0 wt %, about 70.0 wt % to about 80.0 wt %, about 75.0 wt % to about 90.0 wt %, about 75.0 wt % to about 85.0 wt %, or about 80.0 wt % to about 90.0 wt %.

In any aspect or embodiment described herein, the at least one oxidized lignin is present in the composition in an amount of about 0.5 to about 15.0 wt % (e.g., about 0.5 to about 5.0 wt % or about 1.0 to about 10.0 wt %). For example, in any aspect or embodiment described herein, the at least one oxidized lignin is present in the composition in an amount of about 0.5 to about 15.0 wt %, about 0.5 to about 14.0 wt %, about 0.5 to about 13.0 wt %, about 0.5 to about 12.0 wt %, about 0.5 to about 11.0 wt %, about 0.5 to about 10.0 wt %, about 0.5 to about 9.0 wt %, about 0.5 to about 8.0 wt %, about 0.5 to about 7.0 wt %, about 0.5 to about 6.0 wt %, about 0.5 to about 5.0 wt %, about 0.5 to about 4.0 wt %, about 0.5 to about 3.0 wt %, about 1.0 to about 15.0 wt %, about 1.0 to about 14.0 wt %, about 1.0 to about 13.0 wt %, about 1.0 to about 12.0 wt %, about 1.0 to about 11.0 wt %, about 1.0 to about 10.0 wt %, about 1.0 to about 9.0 wt %, about 1.0 to about 8.0 wt %, about 1.0 to about 7.0 wt %, about 1.0 to about 6.0 wt %, about 1.0 to about 5.0 wt %, about 1.0 to about 4.0 wt %, about 1.0 to about 3.0 wt %, about 2.0 to about 15.0 wt %, about 2.0 to about 14.0 wt %, about 2.0 to about 13.0 wt %, about 2.0 to about 12.0 wt %, about 2.0 to about 11.0 wt %, about 2.0 to about 10.0 wt %, about 2.0 to about 9.0 wt %, about 2.0 to about 8.0 wt %, about 2.0 to about 7.0 wt %, about 2.0 to about 6.0 wt %, about 2.0 to about 5.0 wt %, about 2.0 to about 4.0 wt %, about 3.0 to about 15.0 wt %, about 3.0 to about 14.0 wt %, about 3.0 to about 13.0 wt %, about 3.0 to about 12.0 wt %, about 3.0 to about 11.0 wt %, about 3.0 to about 10.0 wt %, about 3.0 to about 9.0 wt %, about 3.0 to about 8.0 wt %, about 3.0 to about 7.0 wt %, about 3.0 to about 6.0 wt %, about 3.0 to about 5.0 wt %, about 4.0 to about 15.0 wt %, about 4.0 to about 14.0 wt %, about 4.0 to about 13.0 wt %, about 4.0 to about 12.0 wt %, about 4.0 to about 11.0 wt %, about 4.0 to about 10.0 wt %, about 4.0 to about 9.0 wt %, about 4.0 to about 8.0 wt %, about 4.0 to about 7.0 wt %, about 4.0 to about 6.0 wt %, about 5.0 to about 15.0 wt %, about 5.0 to about 14.0 wt %, about 5.0 to about 13.0 wt %, about 5.0 to about 12.0 wt %, about 5.0 to about 11.0 wt %, about 5.0 to about 10.0 wt %, about 5.0 to about 9.0 wt %, about 5.0 to about 8.0 wt %, about 5.0 to about 7.0 wt %, about 6.0 to about 15.0 wt %, about 6.0 to about 14.0 wt %, about 6.0 to about 13.0 wt %, about 6.0 to about 12.0 wt %, about 6.0 to about 11.0 wt %, about 6.0 to about 10.0 wt %, about 6.0 to about 9.0 wt %, about 6.0 to about 8.0 wt %, about 7.0 to about 15.0 wt %, about 7.0 to about 14.0 wt %, about 7.0 to about 13.0 wt %, about 7.0 to about 12.0 wt %, about 7.0 to about 11.0 wt %, about 7.0 to about 10.0 wt %, about 7.0 to about 9.0 wt %, about 8.0 to about 15.0 wt %, about 8.0 to about 14.0 wt %, about 8.0 to about 13.0 wt %, about 8.0 to about 12.0 wt %, about 8.0 to about 11.0 wt %, about 8.0 to about 10.0 wt %, about 9.0 to about 15.0 wt %, about 9.0 to about 14.0 wt %, about 9.0 to about 13.0 wt %, about 9.0 to about 12.0 wt %, about 9.0 to about 11.0 wt %, about 10.0 to about 15.0 wt %, about 10.0 to about 14.0 wt %, about 10.0 to about 13.0 wt %, about 10.0 to about 12.0 wt %, about 11.0 to about 15.0 wt %, about 11.0 to about 14.0 wt %, about 11.0 to about 13.0 wt %, about 12.0 to about 15.0 wt %, about 12.0 to about 14.0 wt %, or about 13.0 to about 15.0 wt %.

In any aspect or embodiment described herein, the at least one surfactant is present in an amount of about 0.01 wt % to about 7.5 wt % (e.g., about 0.1 wt % to about 7.0 wt %, about 0.5 wt % to about 6.5 wt %, about 4.0 wt % to about 6.0 wt %, or about 5.0 wt %). For example, in any aspect or embodiment described herein, the at least one surfactant is present in an amount of about 0.01 wt % to about 7.5 wt %, about 0.01 wt % to about 7.0 wt %, about 0.01 wt % to about 6.5 wt %, about 0.01 wt % to about 6.0 wt %, about 0.01 wt % to about 5.5 wt %, about 0.01 wt % to about 5.0 wt %, about 0.01 wt % to about 4.5 wt %, about 0.01 wt % to about 4.0 wt %, about 0.01 wt % to about 3.5 wt %, about 0.01 wt % to about 3.0 wt %, about 0.01 wt % to about 2.5 wt %, about 0.01 wt % to about 2.0 wt %, about 0.01 wt % to about 1.5 wt %, about 0.1 wt % to about 7.5 wt %, about 0.1 wt % to about 7.0 wt %, about 0.1 wt % to about 6.5 wt %, about 0.1 wt % to about 6.0 wt %, about 0.1 wt % to about 5.5 wt %, about 0.1 wt % to about 5.0 wt %, about 0.1 wt % to about 4.5 wt %, about 0.1 wt % to about 4.0 wt %, about 0.1 wt % to about 3.5 wt %, about 0.1 wt % to about 3.0 wt %, about 0.1 wt % to about 2.5 wt %, about 0.1 wt % to about 2.0 wt %, about 0.1 wt % to about 1.5 wt %, about 0.5 wt % to about 7.5 wt %, about 0.5 wt % to about 7.0 wt %, about 0.5 wt % to about 6.5 wt %, about 0.5 wt % to about 6.0 wt %, about 0.5 wt % to about 5.5 wt %, about 0.5 wt % to about 5.0 wt %, about 0.5 wt % to about 4.5 wt %, about 0.5 wt % to about 4.0 wt %, about 0.5 wt % to about 3.5 wt %, about 0.5 wt % to about 3.0 wt %, about 0.5 wt % to about 2.5 wt %, about 0.5 wt % to about 2.0 wt %, about 0.1 wt % to about 1.5 wt %, about 1.0 wt % to about 7.5 wt %, about 1.0 wt % to about 7.0 wt %, about 1.0 wt % to about 6.5 wt %, about 1.0 wt % to about 6.0 wt %, about 1.0 wt % to about 5.5 wt %, about 1.0 wt % to about 5.0 wt %, about 1.0 wt % to about 4.5 wt %, about 1.0 wt % to about 4.0 wt %, about 1.0 wt % to about 3.5 wt %, about 1.0 wt % to about 3.0 wt %, about 1.0 wt % to about 2.5 wt %, about 1.0 wt % to about 2.0 wt %, about 1.5 wt % to about 7.5 wt %, about 1.5 wt % to about 7.0 wt %, about 1.5 wt % to about 6.5 wt %, about 1.5 wt % to about 6.0 wt %, about 1.5 wt % to about 5.5 wt %, about 1.5 wt % to about 5.0 wt %, about 1.5 wt % to about 4.5 wt %, about 1.5 wt % to about 4.0 wt %, about 1.5 wt % to about 3.5 wt %, about 1.5 wt % to about 3.0 wt %, about 1.5 wt % to about 2.5 wt %, about 2.0 wt % to about 7.5 wt %, about 2.0 wt % to about 7.0 wt %, about 2.0 wt % to about 6.5 wt %, about 2.0 wt % to about 6.0 wt %, about 2.0 wt % to about 5.5 wt %, about 2.0 wt % to about 5.0 wt %, about 2.0 wt % to about 4.5 wt %, about 2.0 wt % to about 4.0 wt %, about 2.0 wt % to about 3.5 wt %, about 2.0 wt % to about 3.0 wt %, about 2.5 wt % to about 7.5 wt %, about 2.5 wt % to about 7.0 wt %, about 2.5 wt % to about 6.5 wt %, about 2.5 wt % to about 6.0 wt %, about 2.5 wt % to about 5.5 wt %, about 2.5 wt % to about 5.0 wt %, about 2.5 wt % to about 4.5 wt %, about 2.5 wt % to about 4.0 wt %, about 2.5 wt % to about 3.5 wt %, about 3.0 wt % to about 7.5 wt %, about 3.0 wt % to about 7.0 wt %, about 3.0 wt % to about 6.5 wt %, about 3.0 wt % to about 6.0 wt %, about 3.0 wt % to about 5.5 wt %, about 3.0 wt % to about 5.0 wt %, about 3.0 wt % to about 4.5 wt %, about 3.0 wt % to about 4.0 wt %, about 3.5 wt % to about 7.5 wt %, about 3.5 wt % to about 7.0 wt %, about 3.5 wt % to about 6.5 wt %, about 3.5 wt % to about 6.0 wt %, about 3.5 wt % to about 5.5 wt %, about 3.5 wt % to about 5.0 wt %, about 3.5 wt % to about 4.5 wt %, about 4.0 wt % to about 7.5 wt %, about 4.0 wt % to about 7.0 wt %, about 4.0 wt % to about 6.5 wt %, about 4.0 wt % to about 6.0 wt %, about 4.0 wt % to about 5.5 wt %, about 4.0 wt % to about 5.0 wt %, about 4.5 wt % to about 7.5 wt %, about 4.5 wt % to about 7.0 wt %, about 4.5 wt % to about 6.5 wt %, about 4.5 wt % to about 6.0 wt %, about 4.5 wt % to about 5.5 wt %, about 5.0 wt % to about 7.5 wt %, about 5.0 wt % to about 7.0 wt %, about 5.0 wt % to about 6.5 wt %, about 5.0 wt % to about 6.0 wt %, about 5.5 wt % to about 7.5 wt %, about 5.5 wt % to about 7.0 wt %, about 5.5 wt % to about 6.5 wt %, about 6.0 wt % to about 7.5 wt %, about 6.0 wt % to about 7.0 wt %, or about 6.5 wt % to about 7.5 wt %.

In any aspect or embodiment described herein, the at least one filler is present in an amount of about 5.0 wt % to about 90.0 wt % (e.g., about 55.0 wt % to about 90.0 wt % (e.g., about 60.0 wt % to about 80.0 wt %, about 65.0 wt % to about 75.0 wt %, or about 71.0 wt %). For example, in any aspect or embodiment described herein, the at least one filler is present in an amount of about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 90.0 wt %, about 70.0 wt % to about 85.0 wt %, about 70.0 wt % to about 80.0 wt %, about 75.0 wt % to about 90.0 wt %, about 75.0 wt % to about 85.0 wt %, or about 80.0 wt % to about 90.0 wt %.

In any aspect or embodiment described herein, the at least one binder is present in an amount of less than or equal to about 10.0 wt % (e.g., about 1.0 wt % to about 5.0 wt %). For example, in any aspect or embodiment described herein the at least one binder is present in an amount of about 0.01 wt % to about 10.0 wt %, about 0.01 wt % to about 9.0 wt %, about 0.01 wt % to about 8.0 wt %, about 0.01 wt % to about 7.0 wt %, about 0.01 wt % to about 6.0 wt %, about 0.01 wt % to about 5.0 wt %, about 0.01 wt % to about 4.0 wt %, about 0.01 wt % to about 3.0 wt %, about 0.01 wt % to about 2.0 wt %, about 0.01 wt % to about 1.0 wt %, about 0.1 wt % to about 10.0 wt %, about 0.1 wt % to about 9.0 wt %, about 0.1 wt % to about 8.0 wt %, about 0.1 wt % to about 7.0 wt %, about 0.1 wt % to about 6.0 wt %, about 0.1 wt % to about 5.0 wt %, about 0.1 wt % to about 4.0 wt %, about 0.1 wt % to about 3.0 wt %, about 0.1 wt % to about 2.0 wt %, about 0.1 wt % to about 1.0 wt %, about 1.0 wt % to about 10.0 wt %, about 1.0 wt % to about 9.0 wt %, about 1.0 wt % to about 8.0 wt %, about 1.0 wt % to about 7.0 wt %, about 1.0 wt % to about 6.0 wt %, about 1.0 wt % to about 5.0 wt %, about 1.0 wt % to about 4.0 wt %, about 1.0 wt % to about 3.0 wt %, about 1.0 wt % to about 2.0 wt %, about 2.0 wt % to about 10.0 wt %, about 2.0 wt % to about 9.0 wt %, about 2.0 wt % to about 8.0 wt %, about 2.0 wt % to about 7.0 wt %, about 2.0 wt % to about 6.0 wt %, about 2.0 wt % to about 5.0 wt %, about 2.0 wt % to about 4.0 wt %, about 2.0 wt % to about 3.0 wt %, about 3.0 wt % to about 10.0 wt %, about 3.0 wt % to about 9.0 wt %, about 3.0 wt % to about 8.0 wt %, about 3.0 wt % to about 7.0 wt %, about 3.0 wt % to about 6.0 wt %, about 3.0 wt % to about 5.0 wt %, about 3.0 wt % to about 4.0 wt %, about 4.0 wt % to about 10.0 wt %, about 4.0 wt % to about 9.0 wt %, about 4.0 wt % to about 8.0 wt %, about 4.0 wt % to about 7.0 wt %, about 4.0 wt % to about 6.0 wt %, about 4.0 wt % to about 5.0 wt %, about 5.0 wt % to about 10.0 wt %, about 5.0 wt % to about 9.0 wt %, about 5.0 wt % to about 8.0 wt %, about 5.0 wt % to about 7.0 wt %, about 5.0 wt % to about 6.0 wt %, about 6.0 wt % to about 10.0 wt %, about 6.0 wt % to about 9.0 wt %, about 6.0 wt % to about 8.0 wt %, about 6.0 wt % to about 7.0 wt %, about 7.0 wt % to about 10.0 wt %, about 7.0 wt % to about 9.0 wt %, about 7.0 wt % to about 8.0 wt %, about 8.0 wt % to about 10.0 wt %, about 8.0 wt % to about 9.0 wt %, or about 9.0 wt % to about 10.0 wt %.

In any aspect or embodiment described herein, the at least one nutrient (e.g., at least one (e.g., 1, 2, 3, 4, 5, 6, 7, 8, 9, 10, or more) micronutrient, at least one (e.g., 1, 2, 3, 4, 5, 6, 7, 8, 9, 10, or more) macronutrient, or a combination thereof) is present in an amount of less than or equal to about 20.0 wt % (e.g., at least one micronutrient in an amount of less than or equal to about 3.0 wt %, at least one macronutrient in an amount of less than or equal to about 20.0 wt %, or a combination thereof). For example, in any aspect or embodiment described herein, the at least one nutrient is present in an amount of about 0.1 wt % to about 20.0 wt %, about 0.1 wt % to about 19.0 wt %, about 0.1 wt % to about 18.0 wt %, about 0.1 wt % to about 17.0 wt %, about 0.1 wt % to about 16.0 wt %, about 0.1 wt % to about 15.0 wt %, about 0.1 wt % to about 14.0 wt %, about 0.1 wt % to about 13.0 wt %, about 0.1 wt % to about 12.0 wt %, about 0.1 wt % to about 11.0 wt %, about 0.1 wt % to about 10.0 wt %, about 0.1 wt % to about 9.0 wt %, about 0.1 wt % to about 8.0 wt %, about 0.1 wt % to about 7.0 wt %, about 0.1 wt % to about 6.0 wt %, about 0.1 wt % to about 5.0 wt %, about 0.1 wt % to about 4.0 wt %, about 0.1 wt % to about 3.0 wt %, about 0.1 wt % to about 2.0 wt %, about 0.1 wt % to about 1.0 wt %, about 0.5 wt % to about 20.0 wt %, about 0.5 wt % to about 19.0 wt %, about 0.5 wt % to about 18.0 wt %, about 0.5 wt % to about 17.0 wt %, about 0.5 wt % to about 16.0 wt %, about 0.5 wt % to about 15.0 wt %, about 0.5 wt % to about 14.0 wt %, about 0.5 wt % to about 13.0 wt %, about 0.5 wt % to about 12.0 wt %, about 0.5 wt % to about 11.0 wt %, about 0.5 wt % to about 10.0 wt %, about 0.5 wt % to about 9.0 wt %, about 0.5 wt % to about 8.0 wt %, about 0.5 wt % to about 7.0 wt %, about 0.5 wt % to about 6.0 wt %, about 0.5 wt % to about 5.0 wt %, about 0.5 wt % to about 4.0 wt %, about 0.5 wt % to about 3.0 wt %, about 0.5 wt % to about 2.0 wt %, about 1.0 wt % to about 20.0 wt %, about 1.0 wt % to about 19.0 wt %, about 1.0 wt % to about 18.0 wt %, about 1.0 wt % to about 17.0 wt %, about 1.0 wt % to about 16.0 wt %, about 1.0 wt % to about 15.0 wt %, about 1.0 wt % to about 14.0 wt %, about 1.0 wt % to about 13.0 wt %, about 1.0 wt % to about 12.0 wt %, about 1.0 wt % to about 11.0 wt %, about 1.0 wt % to about 10.0 wt %, about 1.0 wt % to about 9.0 wt %, about 1.0 wt % to about 8.0 wt %, about 1.0 wt % to about 7.0 wt %, about 1.0 wt % to about 6.0 wt %, about 1.0 wt % to about 5.0 wt %, about 1.0 wt % to about 4.0 wt %, about 1.0 wt % to about 3.0 wt %, about 1.0 wt % to about 2.0 wt %, about 2.0 wt % to about 20.0 wt %, about 2.0 wt % to about 19.0 wt %, about 2.0 wt % to about 18.0 wt %, about 2.0 wt % to about 17.0 wt %, about 2.0 wt % to about 16.0 wt %, about 2.0 wt % to about 15.0 wt %, about 2.0 wt % to about 14.0 wt %, about 2.0 wt % to about 13.0 wt %, about 2.0 wt % to about 12.0 wt %, about 2.0 wt % to about 11.0 wt %, about 2.0 wt % to about 10.0 wt %, about 2.0 wt % to about 9.0 wt %, about 2.0 wt % to about 8.0 wt %, about 2.0 wt % to about 7.0 wt %, about 2.0 wt % to about 6.0 wt %, about 2.0 wt % to about 5.0 wt %, about 2.0 wt % to about 4.0 wt %, about 2.0 wt % to about 3.0 wt %, about 3.0 wt % to about 20.0 wt %, about 3.0 wt % to about 19.0 wt %, about 3.0 wt % to about 18.0 wt %, about 3.0 wt % to about 17.0 wt %, about 3.0 wt % to about 16.0 wt %, about 3.0 wt % to about 15.0 wt %, about 3.0 wt % to about 14.0 wt %, about 3.0 wt % to about 13.0 wt %, about 3.0 wt % to about 12.0 wt %, about 3.0 wt % to about 11.0 wt %, about 3.0 wt % to about 10.0 wt %, about 3.0 wt % to about 9.0 wt %, about 3.0 wt % to about 8.0 wt %, about 3.0 wt % to about 7.0 wt %, about 3.0 wt % to about 6.0 wt %, about 3.0 wt % to about 5.0 wt %, about 3.0 wt % to about 4.0 wt %, about 4.0 wt % to about 20.0 wt %, about 3.0 wt % to about 19.0 wt %, about 3.0 wt % to about 18.0 wt %, about 3.0 wt % to about 17.0 wt %, about 4.0 wt % to about 16.0 wt %, about 4.0 wt % to about 15.0 wt %, about 4.0 wt % to about 14.0 wt %, about 4.0 wt % to about 13.0 wt %, about 4.0 wt % to about 12.0 wt %, about 4.0 wt % to about 11.0 wt %, about 4.0 wt % to about 10.0 wt %, about 4.0 wt % to about 9.0 wt %, about 4.0 wt % to about 8.0 wt %, about 4.0 wt % to about 7.0 wt %, about 4.0 wt % to about 6.0 wt %, about 4.0 wt % to about 5.0 wt %, about 5.0 wt % to about 20.0 wt %, about 5.0 wt % to about 19.0 wt %, about 5.0 wt % to about 18.0 wt %, about 5.0 wt % to about 17.0 wt %, about 5.0 wt % to about 16.0 wt %, about 5.0 wt % to about 15.0 wt %, about 5.0 wt % to about 14.0 wt %, about 5.0 wt % to about 13.0 wt %, about 5.0 wt % to about 12.0 wt %, about 5.0 wt % to about 11.0 wt %, about 5.0 wt % to about 10.0 wt %, about 5.0 wt % to about 9.0 wt %, about 5.0 wt % to about 8.0 wt %, about 5.0 wt % to about 7.0 wt %, about 5.0 wt % to about 6.0 wt %, about 6.0 wt % to about 20.0 wt %, about 6.0 wt % to about 19.0 wt %, about 6.0 wt % to about 18.0 wt %, about 6.0 wt % to about 17.0 wt %, about 6.0 wt % to about 16.0 wt %, about 6.0 wt % to about 15.0 wt %, about 6.0 wt % to about 14.0 wt %, about 6.0 wt % to about 13.0 wt %, about 6.0 wt % to about 12.0 wt %, about 6.0 wt % to about 11.0 wt %, about 6.0 wt % to about 10.0 wt %, about 6.0 wt % to about 9.0 wt %, about 6.0 wt % to about 8.0 wt %, about 6.0 wt % to about 7.0 wt %, about 7.0 wt % to about 20.0 wt %, about 7.0 wt % to about 19.0 wt %, about 7.0 wt % to about 18.0 wt %, about 7.0 wt % to about 17.0 wt %, about 7.0 wt % to about 16.0 wt %, about 7.0 wt % to about 15.0 wt %, about 7.0 wt % to about 14.0 wt %, about 7.0 wt % to about 13.0 wt %, about 7.0 wt % to about 12.0 wt %, about 7.0 wt % to about 11.0 wt %, about 7.0 wt % to about 10.0 wt %, about 7.0 wt % to about 9.0 wt %, about 7.0 wt % to about 8.0 wt %, about 8.0 wt % to about 20.0 wt %, about 8.0 wt % to about 19.0 wt %, about 8.0 wt % to about 18.0 wt %, about 8.0 wt % to about 17.0 wt %, about 8.0 wt % to about 16.0 wt %, about 8.0 wt % to about 15.0 wt %, about 8.0 wt % to about 14.0 wt %, about 8.0 wt % to about 13.0 wt %, about 8.0 wt % to about 12.0 wt %, about 8.0 wt % to about 11.0 wt %, about 8.0 wt % to about 10.0 wt %, about 8.0 wt % to about 9.0 wt %, about 9.0 wt % to about 20.0 wt %, about 9.0 wt % to about 19.0 wt %, about 9.0 wt % to about 18.0 wt %, about 9.0 wt % to about 17.0 wt %, about 9.0 wt % to about 16.0 wt %, about 9.0 wt % to about 15.0 wt %, about 9.0 wt % to about 14.0 wt %, about 9.0 wt % to about 13.0 wt %, about 9.0 wt % to about 12.0 wt %, about 9.0 wt % to about 11.0 wt %, about 9.0 wt % to about 10.0 wt %, about 10.0 wt % to about 20.0 wt %, about 10.0 wt % to about 19.0 wt %, about 10.0 wt % to about 18.0 wt %, about 10.0 wt % to about 17.0 wt %, about 10.0 wt % to about 16.0 wt %, about 10.0 wt % to about 15.0 wt %, about 10.0 wt % to about 14.0 wt %, about 10.0 wt % to about 13.0 wt %, about 10.0 wt % to about 12.0 wt %, about 10.0 wt % to about 11.0 wt %, about 11.0 wt % to about 20.0 wt %, about 11.0 wt % to about 19.0 wt %, about 11.0 wt % to about 18.0 wt %, about 11.0 wt % to about 17.0 wt %, about 11.0 wt % to about 16.0 wt %, about 11.0 wt % to about 15.0 wt %, about 11.0 wt % to about 14.0 wt %, about 11.0 wt % to about 13.0 wt %, about 11.0 wt % to about 12.0 wt %, about 12.0 wt % to about 20.0 wt %, about 12.0 wt % to about 19.0 wt %, about 12.0 wt % to about 18.0 wt %, about 12.0 wt % to about 17.0 wt %, about 12.0 wt % to about 16.0 wt %, about 12.0 wt % to about 15.0 wt %, about 12.0 wt % to about 14.0 wt %, about 12.0 wt % to about 13.0 wt %, about 13.0 wt % to about 20.0 wt %, about 13.0 wt % to about 19.0 wt %, about 13.0 wt % to about 18.0 wt %, about 13.0 wt % to about 17.0 wt %, about 13.0 wt % to about 16.0 wt %, about 13.0 wt % to about 15.0 wt %, about 13.0 wt % to about 14.0 wt %, about 14.0 wt % to about 20.0 wt %, about 14.0 wt % to about 19.0 wt %, about 14.0 wt % to about 18.0 wt %, about 14.0 wt % to about 17.0 wt %, about 14.0 wt % to about 16.0 wt %, about 14.0 wt % to about 15.0 wt %, about 15.0 wt % to about 20.0 wt %, about 15.0 wt % to about 19.0 wt %, about 15.0 wt % to about 18.0 wt %, about 15.0 wt % to about 17.0 wt %, about 15.0 wt % to about 16.0 wt %, about 16.0 wt % to about 20.0 wt %, about 16.0 wt % to about 19.0 wt %, about 16.0 wt % to about 18.0 wt %, about 16.0 wt % to about 17.0 wt %, about 17.0 wt % to about 20.0 wt %, about 17.0 wt % to about 19.0 wt %, about 17.0 wt % to about 18.0 wt %, about 18.0 wt % to about 20.0 wt %, about 18.0 wt % to about 19.0 wt %, or about 19.0 wt % to about 20.0 wt %.

In any aspect or embodiment described herein, the at least one micronutrient is present in an amount of about 0.1 wt % to about 3.0 wt %, about 0.1 wt % to about 2.5 wt %, about 0.1 wt % to about 2.0 wt %, about 0.1 wt % to about 1.5 wt %, about 0.1 wt % to about 1.0 wt %, about 0.1 wt % to about 0.5 wt %, about 0.5 wt % to about 3.0 wt %, about 0.5 wt % to about 2.5 wt %, about 0.5 wt % to about 2.0 wt %, about 0.5 wt % to about 1.5 wt %, about 0.5 wt % to about 1.0 wt %, about 1.0 wt % to about 3.0 wt %, about 1.0 wt % to about 2.5 wt %, about 1.0 wt % to about 2.0 wt %, about 1.0 wt % to about 1.5 wt %, about 1.5 wt % to about 3.0 wt %, about 1.5 wt % to about 2.5 wt %, about 1.5 wt % to about 2.0 wt %, about 2.0 wt % to about 3.0 wt %, about 2.0 wt % to about 2.5 wt %, or about 2.5 wt % to about 3.0 wt %. In any aspect or embodiment described herein, the at least one macronutrient is present in an amount of about 0.1 wt % to about 20.0 wt %, about 0.1 wt % to about 19.0 wt %, about 0.1 wt % to about 18.0 wt %, about 0.1 wt % to about 17.0 wt %, about 0.1 wt % to about 16.0 wt %, about 0.1 wt % to about 15.0 wt %, about 0.1 wt % to about 14.0 wt %, about 0.1 wt % to about 13.0 wt %, about 0.1 wt % to about 12.0 wt %, about 0.1 wt % to about 11.0 wt %, about 0.1 wt % to about 10.0 wt %, about 0.1 wt % to about 9.0 wt %, about 0.1 wt % to about 8.0 wt %, about 0.1 wt % to about 7.0 wt %, about 0.1 wt % to about 6.0 wt %, about 0.1 wt % to about 5.0 wt %, about 0.1 wt % to about 4.0 wt %, about 0.1 wt % to about 3.0 wt %, about 0.1 wt % to about 2.0 wt %, about 0.1 wt % to about 1.0 wt %, about 0.5 wt % to about 20.0 wt %, about 0.5 wt % to about 19.0 wt %, about 0.5 wt % to about 18.0 wt %, about 0.5 wt % to about 17.0 wt %, about 0.5 wt % to about 16.0 wt %, about 0.5 wt % to about 15.0 wt %, about 0.5 wt % to about 14.0 wt %, about 0.5 wt % to about 13.0 wt %, about 0.5 wt % to about 12.0 wt %, about 0.5 wt % to about 11.0 wt %, about 0.5 wt % to about 10.0 wt %, about 0.5 wt % to about 9.0 wt %, about 0.5 wt % to about 8.0 wt %, about 0.5 wt % to about 7.0 wt %, about 0.5 wt % to about 6.0 wt %, about 0.5 wt % to about 5.0 wt %, about 0.5 wt % to about 4.0 wt %, about 0.5 wt % to about 3.0 wt %, about 0.5 wt % to about 2.0 wt %, about 1.0 wt % to about 20.0 wt %, about 1.0 wt % to about 19.0 wt %, about 1.0 wt % to about 18.0 wt %, about 1.0 wt % to about 17.0 wt %, about 1.0 wt % to about 16.0 wt %, about 1.0 wt % to about 15.0 wt %, about 1.0 wt % to about 14.0 wt %, about 1.0 wt % to about 13.0 wt %, about 1.0 wt % to about 12.0 wt %, about 1.0 wt % to about 11.0 wt %, about 1.0 wt % to about 10.0 wt %, about 1.0 wt % to about 9.0 wt %, about 1.0 wt % to about 8.0 wt %, about 1.0 wt % to about 7.0 wt %, about 1.0 wt % to about 6.0 wt %, about 1.0 wt % to about 5.0 wt %, about 1.0 wt % to about 4.0 wt %, about 1.0 wt % to about 3.0 wt %, about 1.0 wt % to about 2.0 wt %, about 2.0 wt % to about 20.0 wt %, about 2.0 wt % to about 19.0 wt %, about 2.0 wt % to about 18.0 wt %, about 2.0 wt % to about 17.0 wt %, about 2.0 wt % to about 16.0 wt %, about 2.0 wt % to about 15.0 wt %, about 2.0 wt % to about 14.0 wt %, about 2.0 wt % to about 13.0 wt %, about 2.0 wt % to about 12.0 wt %, about 2.0 wt % to about 11.0 wt %, about 2.0 wt % to about 10.0 wt %, about 2.0 wt % to about 9.0 wt %, about 2.0 wt % to about 8.0 wt %, about 2.0 wt % to about 7.0 wt %, about 2.0 wt % to about 6.0 wt %, about 2.0 wt % to about 5.0 wt %, about 2.0 wt % to about 4.0 wt %, about 2.0 wt % to about 3.0 wt %, about 3.0 wt % to about 20.0 wt %, about 3.0 wt % to about 19.0 wt %, about 3.0 wt % to about 18.0 wt %, about 3.0 wt % to about 17.0 wt %, about 3.0 wt % to about 16.0 wt %, about 3.0 wt % to about 15.0 wt %, about 3.0 wt % to about 14.0 wt %, about 3.0 wt % to about 13.0 wt %, about 3.0 wt % to about 12.0 wt %, about 3.0 wt % to about 11.0 wt %, about 3.0 wt % to about 10.0 wt %, about 3.0 wt % to about 9.0 wt %, about 3.0 wt % to about 8.0 wt %, about 3.0 wt % to about 7.0 wt %, about 3.0 wt % to about 6.0 wt %, about 3.0 wt % to about 5.0 wt %, about 3.0 wt % to about 4.0 wt %, about 4.0 wt % to about 20.0 wt %, about 3.0 wt % to about 19.0 wt %, about 3.0 wt % to about 18.0 wt %, about 3.0 wt % to about 17.0 wt %, about 4.0 wt % to about 16.0 wt %, about 4.0 wt % to about 15.0 wt %, about 4.0 wt % to about 14.0 wt %, about 4.0 wt % to about 13.0 wt %, about 4.0 wt % to about 12.0 wt %, about 4.0 wt % to about 11.0 wt %, about 4.0 wt % to about 10.0 wt %, about 4.0 wt % to about 9.0 wt %, about 4.0 wt % to about 8.0 wt %, about 4.0 wt % to about 7.0 wt %, about 4.0 wt % to about 6.0 wt %, about 4.0 wt % to about 5.0 wt %, about 5.0 wt % to about 20.0 wt %, about 5.0 wt % to about 19.0 wt %, about 5.0 wt % to about 18.0 wt %, about 5.0 wt % to about 17.0 wt %, about 5.0 wt % to about 16.0 wt %, about 5.0 wt % to about 15.0 wt %, about 5.0 wt % to about 14.0 wt %, about 5.0 wt % to about 13.0 wt %, about 5.0 wt % to about 12.0 wt %, about 5.0 wt % to about 11.0 wt %, about 5.0 wt % to about 10.0 wt %, about 5.0 wt % to about 9.0 wt %, about 5.0 wt % to about 8.0 wt %, about 5.0 wt % to about 7.0 wt %, about 5.0 wt % to about 6.0 wt %, about 6.0 wt % to about 20.0 wt %, about 6.0 wt % to about 19.0 wt %, about 6.0 wt % to about 18.0 wt %, about 6.0 wt % to about 17.0 wt %, about 6.0 wt % to about 16.0 wt %, about 6.0 wt % to about 15.0 wt %, about 6.0 wt % to about 14.0 wt %, about 6.0 wt % to about 13.0 wt %, about 6.0 wt % to about 12.0 wt %, about 6.0 wt % to about 11.0 wt %, about 6.0 wt % to about 10.0 wt %, about 6.0 wt % to about 9.0 wt %, about 6.0 wt % to about 8.0 wt %, about 6.0 wt % to about 7.0 wt %, about 7.0 wt % to about 20.0 wt %, about 7.0 wt % to about 19.0 wt %, about 7.0 wt % to about 18.0 wt %, about 7.0 wt % to about 17.0 wt %, about 7.0 wt % to about 16.0 wt %, about 7.0 wt % to about 15.0 wt %, about 7.0 wt % to about 14.0 wt %, about 7.0 wt % to about 13.0 wt %, about 7.0 wt % to about 12.0 wt %, about 7.0 wt % to about 11.0 wt %, about 7.0 wt % to about 10.0 wt %, about 7.0 wt % to about 9.0 wt %, about 7.0 wt % to about 8.0 wt %, about 8.0 wt % to about 20.0 wt %, about 8.0 wt % to about 19.0 wt %, about 8.0 wt % to about 18.0 wt %, about 8.0 wt % to about 17.0 wt %, about 8.0 wt % to about 16.0 wt %, about 8.0 wt % to about 15.0 wt %, about 8.0 wt % to about 14.0 wt %, about 8.0 wt % to about 13.0 wt %, about 8.0 wt % to about 12.0 wt %, about 8.0 wt % to about 11.0 wt %, about 8.0 wt % to about 10.0 wt %, about 8.0 wt % to about 9.0 wt %, about 9.0 wt % to about 20.0 wt %, about 9.0 wt % to about 19.0 wt %, about 9.0 wt % to about 18.0 wt %, about 9.0 wt % to about 17.0 wt %, about 9.0 wt % to about 16.0 wt %, about 9.0 wt % to about 15.0 wt %, about 9.0 wt % to about 14.0 wt %, about 9.0 wt % to about 13.0 wt %, about 9.0 wt % to about 12.0 wt %, about 9.0 wt % to about 11.0 wt %, about 9.0 wt % to about 10.0 wt %, about 10.0 wt % to about 20.0 wt %, about 10.0 wt % to about 19.0 wt %, about 10.0 wt % to about 18.0 wt %, about 10.0 wt % to about 17.0 wt %, about 10.0 wt % to about 16.0 wt %, about 10.0 wt % to about 15.0 wt %, about 10.0 wt % to about 14.0 wt %, about 10.0 wt % to about 13.0 wt %, about 10.0 wt % to about 12.0 wt %, about 10.0 wt % to about 11.0 wt %, about 11.0 wt % to about 20.0 wt %, about 11.0 wt % to about 19.0 wt %, about 11.0 wt % to about 18.0 wt %, about 11.0 wt % to about 17.0 wt %, about 11.0 wt % to about 16.0 wt %, about 11.0 wt % to about 15.0 wt %, about 11.0 wt % to about 14.0 wt %, about 11.0 wt % to about 13.0 wt %, about 11.0 wt % to about 12.0 wt %, about 12.0 wt % to about 20.0 wt %, about 12.0 wt % to about 19.0 wt %, about 12.0 wt % to about 18.0 wt %, about 12.0 wt % to about 17.0 wt %, about 12.0 wt % to about 16.0 wt %, about 12.0 wt % to about 15.0 wt %, about 12.0 wt % to about 14.0 wt %, about 12.0 wt % to about 13.0 wt %, about 13.0 wt % to about 20.0 wt %, about 13.0 wt % to about 19.0 wt %, about 13.0 wt % to about 18.0 wt %, about 13.0 wt % to about 17.0 wt %, about 13.0 wt % to about 16.0 wt %, about 13.0 wt % to about 15.0 wt %, about 13.0 wt % to about 14.0 wt %, about 14.0 wt % to about 20.0 wt %, about 14.0 wt % to about 19.0 wt %, about 14.0 wt % to about 18.0 wt %, about 14.0 wt % to about 17.0 wt %, about 14.0 wt % to about 16.0 wt %, about 14.0 wt % to about 15.0 wt %, about 15.0 wt % to about 20.0 wt %, about 15.0 wt % to about 19.0 wt %, about 15.0 wt % to about 18.0 wt %, about 15.0 wt % to about 17.0 wt %, about 15.0 wt % to about 16.0 wt %, about 16.0 wt % to about 20.0 wt %, about 16.0 wt % to about 19.0 wt %, about 16.0 wt % to about 18.0 wt %, about 16.0 wt % to about 17.0 wt %, about 17.0 wt % to about 20.0 wt %, about 17.0 wt % to about 19.0 wt %, about 17.0 wt % to about 18.0 wt %, about 18.0 wt % to about 20.0 wt %, about 18.0 wt % to about 19.0 wt %, or about 19.0 wt % to about 20.0 wt %.

Exemplary Aqueous Biopesticide(s) and/or Biostimulant(s) Containing Compositions/Formulations

In any aspect or embodiment described herein, the at least one active component includes, consists essentially of, or is at least one (e.g., 1, 2, 3, 4, 5, 6, 7, 8, 9, 10, or more) biopesticide, at least one (e.g., 1, 2, 3, 4, 5, 6, 7, 8, 9, 10, or more) biostimulant, or a combination thereof, and the composition (e.g. an aqueous composition or suspension concentrate) comprises the at least one solvent (e.g., the composition does not comprise a filler, the at least one solvent comprises polyoxyethylene (20) sorbitan monolaurate, or a combination thereof) and optionally further comprises (a) at least one (e.g., 1, 2, 3, 4, 5, 6, 7, 8, 9, 10, or more) anti-freezing agent or freezing point depressant (e.g., propylene glycol, urea, or a combination thereof), (b) at least one (e.g., 1, 2, 3, 4, 5, 6, 7, 8, 9, 10, or more) preservative (e.g., methyl p-hydroxybenzoate), (c) at least one (e.g., 1, 2, 3, 4, 5, 6, 7, 8, 9, 10, or more) protectant (e.g., polyethylene glycol), or (d) a combination thereof.

In any aspect or embodiment described herein, (i) the composition has a D50 particle size of less than about 15 micron (e.g., less than about 14, less than about 13, less than about 12, less than about 11, less than about 10, less than about 9, less than about 8, less than about 7, less than about 6, or less than about 5 micron); (ii) the at least one active component is present in an amount of about 5.0 wt % to about 90.0 wt % (e.g., about 5.0 wt % to about 25.0 wt %); (iii) the at least one oxidized lignin is present in the composition in an amount of about 0.5 to about 15.0 wt % (e.g., about 0.5 to about 5.0 wt % or about 1.0 to about 10.0 wt %); (iv) the at least one surfactant is present in an amount of about 0.01 wt % to about 7.5 wt % (e.g., about 0.1 wt % to about 7.0 wt %, about 0.5 wt % to about 6.5 wt %, about 4.0 wt % to about 6.0 wt %, or about 5.0 wt %); (v) the at least one solvent is present in the composition in an amount of about 60.0 wt % to about 90.0 wt % (e.g., about 65.0 wt % to about 90.0 wt %, about 70.0 wt % to about 90.0 wt %, or about 80.0 wt % to about 82.0 wt %); (vi) the at least one anti-freezing agent or freezing point depressant (e.g. urea) is present in an amount of about 0.01 wt % to about 1.5 wt % (e.g., about 0.05 wt % to about 1.0 wt % or about 0.3 wt %); (vii) the at least one nutrient (e.g., at least one (e.g., 1, 2, 3, 4, 5, 6, 7, 8, 9, 10, or more) micronutrient, at least one (e.g., 1, 2, 3, 4, 5, 6, 7, 8, 9, 10, or more) macronutrient, or a combination thereof) is present in an amount of less than or equal to about 20.0 wt % (e.g., at least one micronutrient in an amount of less than or equal to about 3.0 wt %, at least one macronutrient in an amount of less than or equal to about 20.0 wt %, or a combination thereof); (viii) the at least one preservative is present in the composition in an amount of less than or equal to about 0.5 wt % (e.g., less than or equal to about 0.4 wt %, less than or equal to about 0.3 wt %, less than or equal to about 0.2 wt %, less than or equal to about 0.1 wt %, about 0.01 wt % to about 0.5 wt %); (ix) the at least one protectant is present in the composition in an amount of less than or equal to about 2.0 wt % (e.g., less than or equal to about 1.9 wt %, less than or equal to about 1.8 wt %, less than or equal to about 1.7 wt %, less than or equal to about 1.6 wt %, less than or equal to about 1.5 wt %, less than or equal to about 1.4 wt %, less than or equal to about 1.3 wt %, less than or equal to about 1.2 wt %, less than or equal to about 1.1 wt %, less than or equal to about 1.0 wt %, or about 0.1 wt % to about 2.0 wt %); or (x) a combination thereof.

In any aspect or embodiment described herein, the composition has a D50 particle size of less than about 15 micron (e.g., less than about 14, less than about 13, less than about 12, less than about 11, less than about 10, less than about 9, less than about 8, less than about 7, less than about 6, or less than about 5 micron). For example, in any aspect or embodiment described herein, the composition has a D50 particle size of about 1 micron to about 15 micron, about 2 micron to about 15 micron, about 3 micron to about 15 micron, about 4 micron to about 15 micron, about 5 micron to about 15 micron, about 6 micron to about 15 micron, about 7 micron to about 15 micron, about 8 micron to about 15 micron, about 9 micron to about 15 micron, about 10 micron to about 15 micron, about 11 micron to about 15 micron, about 12 micron to about 15 micron, about 13 micron to about 15 micron, about 14 micron to about 15 micron, about 1 micron to about 14 micron, about 2 micron to about 14 micron, about 3 micron to about 14 micron, about 4 micron to about 14 micron, about 5 micron to about 14 micron, about 6 micron to about 14 micron, about 7 micron to about 14 micron, about 8 micron to about 14 micron, about 9 micron to about 14 micron, about 10 micron to about 14 micron, about 11 micron to about 14 micron, about 12 micron to about 14 micron, about 13 micron to about 14 micron, about 1 micron to about 13 micron, about 2 micron to about 13 micron, about 3 micron to about 13 micron, about 4 micron to about 13 micron, about 5 micron to about 13 micron, about 6 micron to about 13 micron, about 7 micron to about 13 micron, about 8 micron to about 13 micron, about 9 micron to about 13 micron, about 10 micron to about 13 micron, about 11 micron to about 13 micron, about 12 micron to about 13 micron, about 1 micron to about 12 micron, about 2 micron to about 12 micron, about 3 micron to about 12 micron, about 4 micron to about 12 micron, about 5 micron to about 12 micron, about 6 micron to about 12 micron, about 7 micron to about 12 micron, about 8 micron to about 12 micron, about 9 micron to about 12 micron, about 10 micron to about 12 micron, about 11 micron to about 12 micron, about 1 micron to about 11 micron, about 2 micron to about 11 micron, about 3 micron to about 11 micron, about 4 micron to about 11 micron, about 5 micron to about 11 micron, about 6 micron to about 11 micron, about 7 micron to about 11 micron, about 8 micron to about 11 micron, about 9 micron to about 11 micron, about 10 micron to about 11 micron, about 1 micron to about 10 micron, about 2 micron to about 10 micron, about 3 micron to about 10 micron, about 4 micron to about 10 micron, about 5 micron to about 10 micron, about 6 micron to about 10 micron, about 7 micron to about 10 micron, about 8 micron to about 10 micron, about 9 micron to about 10 micron, about 1 micron to about 9 micron, about 2 micron to about 9 micron, about 3 micron to about 9 micron, about 4 micron to about 9 micron, about 5 micron to about 9 micron, about 6 micron to about 9 micron, about 7 micron to about 9 micron, about 8 micron to about 9 micron, about 1 micron to about 8 micron, about 2 micron to about 8 micron, about 3 micron to about 8 micron, about 4 micron to about 8 micron, about 5 micron to about 8 micron, about 6 micron to about 8 micron, about 7 micron to about 8 micron, about 1 micron to about 7 micron, about 2 micron to about 7 micron, about 3 micron to about 7 micron, about 4 micron to about 7 micron, about 5 micron to about 7 micron, about 6 micron to about 7 micron, about 1 micron to about 6 micron, about 2 micron to about 6 micron, about 3 micron to about 6 micron, about 4 micron to about 6 micron, about 5 micron to about 6 micron, about 1 micron to about 5 micron, about 2 micron to about 5 micron, about 3 micron to about 5 micron, about 4 micron to about 5 micron, about 1 micron to about 4 micron, about 2 micron to about 4 micron, about 3 micron to about 4 micron, about 1 micron to about 3 micron, about 2 micron to about 3 micron, or about 1 micron to about 2 micron.

In any aspect or embodiment described herein, the at least one active component is present in an amount of about 5.0 wt % to about 90.0 wt % (e.g., about 5.0 wt % to about 25.0 wt %). For example, in any aspect or embodiment described herein, the at least one active component is present in an amount of about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 90.0 wt %, about 70.0 wt % to about 85.0 wt %, about 70.0 wt % to about 80.0 wt %, about 75.0 wt % to about 90.0 wt %, about 75.0 wt % to about 85.0 wt %, or about 80.0 wt % to about 90.0 wt %.

In any aspect or embodiment described herein, the at least one oxidized lignin is present in the composition in an amount of about 0.5 to about 15.0 wt % (e.g., about 0.5 to about 5.0 wt % or about 1.0 to about 10.0 wt %). For example, in any aspect or embodiment described herein, the at least one oxidized lignin is present in the composition in an amount of about 0.5 to about 15.0 wt %, about 0.5 to about 14.0 wt %, about 0.5 to about 13.0 wt %, about 0.5 to about 12.0 wt %, about 0.5 to about 11.0 wt %, about 0.5 to about 10.0 wt %, about 0.5 to about 9.0 wt %, about 0.5 to about 8.0 wt %, about 0.5 to about 7.0 wt %, about 0.5 to about 6.0 wt %, about 0.5 to about 5.0 wt %, about 0.5 to about 4.0 wt %, about 0.5 to about 3.0 wt %, about 0.5 to about 2.0 wt %, about 1.0 to about 15.0 wt %, about 1.0 to about 14.0 wt %, about 1.0 to about 13.0 wt %, about 1.0 to about 12.0 wt %, about 1.0 to about 11.0 wt %, about 1.0 to about 10.0 wt %, about 1.0 to about 9.0 wt %, about 1.0 to about 8.0 wt %, about 1.0 to about 7.0 wt %, about 1.0 to about 6.0 wt %, about 1.0 to about 5.0 wt %, about 1.0 to about 4.0 wt %, about 1.0 to about 3.0 wt %, about 2.0 to about 15.0 wt %, about 2.0 to about 14.0 wt %, about 2.0 to about 13.0 wt %, about 2.0 to about 12.0 wt %, about 2.0 to about 11.0 wt %, about 2.0 to about 10.0 wt %, about 2.0 to about 9.0 wt %, about 2.0 to about 8.0 wt %, about 2.0 to about 7.0 wt %, about 2.0 to about 6.0 wt %, about 2.0 to about 5.0 wt %, about 2.0 to about 4.0 wt %, about 3.0 to about 15.0 wt %, about 3.0 to about 14.0 wt %, about 3.0 to about 13.0 wt %, about 3.0 to about 12.0 wt %, about 3.0 to about 11.0 wt %, about 3.0 to about 10.0 wt %, about 3.0 to about 9.0 wt %, about 3.0 to about 8.0 wt %, about 3.0 to about 7.0 wt %, about 3.0 to about 6.0 wt %, about 3.0 to about 5.0 wt %, about 4.0 to about 15.0 wt %, about 4.0 to about 14.0 wt %, about 4.0 to about 13.0 wt %, about 4.0 to about 12.0 wt %, about 4.0 to about 11.0 wt %, about 4.0 to about 10.0 wt %, about 4.0 to about 9.0 wt %, about 4.0 to about 8.0 wt %, about 4.0 to about 7.0 wt %, about 4.0 to about 6.0 wt %, about 5.0 to about 15.0 wt %, about 5.0 to about 14.0 wt %, about 5.0 to about 13.0 wt %, about 5.0 to about 12.0 wt %, about 5.0 to about 11.0 wt %, about 5.0 to about 10.0 wt %, about 5.0 to about 9.0 wt %, about 5.0 to about 8.0 wt %, about 5.0 to about 7.0 wt %, about 6.0 to about 15.0 wt %, about 6.0 to about 14.0 wt %, about 6.0 to about 13.0 wt %, about 6.0 to about 12.0 wt %, about 6.0 to about 11.0 wt %, about 6.0 to about 10.0 wt %, about 6.0 to about 9.0 wt %, about 6.0 to about 8.0 wt %, about 7.0 to about 15.0 wt %, about 7.0 to about 14.0 wt %, about 7.0 to about 13.0 wt %, about 7.0 to about 12.0 wt %, about 7.0 to about 11.0 wt %, about 7.0 to about 10.0 wt %, about 7.0 to about 9.0 wt %, about 8.0 to about 15.0 wt %, about 8.0 to about 14.0 wt %, about 8.0 to about 13.0 wt %, about 8.0 to about 12.0 wt %, about 8.0 to about 11.0 wt %, about 8.0 to about 10.0 wt %, about 9.0 to about 15.0 wt %, about 9.0 to about 14.0 wt %, about 9.0 to about 13.0 wt %, about 9.0 to about 12.0 wt %, about 9.0 to about 11.0 wt %, about 10.0 to about 15.0 wt %, about 10.0 to about 14.0 wt %, about 10.0 to about 13.0 wt %, about 10.0 to about 12.0 wt %, about 11.0 to about 15.0 wt %, about 11.0 to about 14.0 wt %, about 11.0 to about 13.0 wt %, about 12.0 to about 15.0 wt %, about 12.0 to about 14.0 wt %, or about 13.0 to about 15.0 wt %.

In any aspect or embodiment described herein, the at least one surfactant is present in an amount of about 0.01 wt % to about 7.5 wt % (e.g., about 0.1 wt % to about 7.0 wt %, about 0.5 wt % to about 6.5 wt %, about 4.0 wt % to about 6.0 wt %, or about 5.0 wt %). For example, in any aspect or embodiment described herein, the at least one surfactant is present in an amount of about 0.01 wt % to about 7.5 wt %, about 0.01 wt % to about 7.0 wt %, about 0.01 wt % to about 6.5 wt %, about 0.01 wt % to about 6.0 wt %, about 0.01 wt % to about 5.5 wt %, about 0.01 wt % to about 5.0 wt %, about 0.01 wt % to about 4.5 wt %, about 0.01 wt % to about 4.0 wt %, about 0.01 wt % to about 3.5 wt %, about 0.01 wt % to about 3.0 wt %, about 0.01 wt % to about 2.5 wt %, about 0.01 wt % to about 2.0 wt %, about 0.01 wt % to about 1.5 wt %, about 0.1 wt % to about 7.5 wt %, about 0.1 wt % to about 7.0 wt %, about 0.1 wt % to about 6.5 wt %, about 0.1 wt % to about 6.0 wt %, about 0.1 wt % to about 5.5 wt %, about 0.1 wt % to about 5.0 wt %, about 0.1 wt % to about 4.5 wt %, about 0.1 wt % to about 4.0 wt %, about 0.1 wt % to about 3.5 wt %, about 0.1 wt % to about 3.0 wt %, about 0.1 wt % to about 2.5 wt %, about 0.1 wt % to about 2.0 wt %, about 0.1 wt % to about 1.5 wt %, about 0.5 wt % to about 7.5 wt %, about 0.5 wt % to about 7.0 wt %, about 0.5 wt % to about 6.5 wt %, about 0.5 wt % to about 6.0 wt %, about 0.5 wt % to about 5.5 wt %, about 0.5 wt % to about 5.0 wt %, about 0.5 wt % to about 4.5 wt %, about 0.5 wt % to about 4.0 wt %, about 0.5 wt % to about 3.5 wt %, about 0.5 wt % to about 3.0 wt %, about 0.5 wt % to about 2.5 wt %, about 0.5 wt % to about 2.0 wt %, about 0.1 wt % to about 1.5 wt %, about 1.0 wt % to about 7.5 wt %, about 1.0 wt % to about 7.0 wt %, about 1.0 wt % to about 6.5 wt %, about 1.0 wt % to about 6.0 wt %, about 1.0 wt % to about 5.5 wt %, about 1.0 wt % to about 5.0 wt %, about 1.0 wt % to about 4.5 wt %, about 1.0 wt % to about 4.0 wt %, about 1.0 wt % to about 3.5 wt %, about 1.0 wt % to about 3.0 wt %, about 1.0 wt % to about 2.5 wt %, about 1.0 wt % to about 2.0 wt %, about 1.5 wt % to about 7.5 wt %, about 1.5 wt % to about 7.0 wt %, about 1.5 wt % to about 6.5 wt %, about 1.5 wt % to about 6.0 wt %, about 1.5 wt % to about 5.5 wt %, about 1.5 wt % to about 5.0 wt %, about 1.5 wt % to about 4.5 wt %, about 1.5 wt % to about 4.0 wt %, about 1.5 wt % to about 3.5 wt %, about 1.5 wt % to about 3.0 wt %, about 1.5 wt % to about 2.5 wt %, about 2.0 wt % to about 7.5 wt %, about 2.0 wt % to about 7.0 wt %, about 2.0 wt % to about 6.5 wt %, about 2.0 wt % to about 6.0 wt %, about 2.0 wt % to about 5.5 wt %, about 2.0 wt % to about 5.0 wt %, about 2.0 wt % to about 4.5 wt %, about 2.0 wt % to about 4.0 wt %, about 2.0 wt % to about 3.5 wt %, about 2.0 wt % to about 3.0 wt %, about 2.5 wt % to about 7.5 wt %, about 2.5 wt % to about 7.0 wt %, about 2.5 wt % to about 6.5 wt %, about 2.5 wt % to about 6.0 wt %, about 2.5 wt % to about 5.5 wt %, about 2.5 wt % to about 5.0 wt %, about 2.5 wt % to about 4.5 wt %, about 2.5 wt % to about 4.0 wt %, about 2.5 wt % to about 3.5 wt %, about 3.0 wt % to about 7.5 wt %, about 3.0 wt % to about 7.0 wt %, about 3.0 wt % to about 6.5 wt %, about 3.0 wt % to about 6.0 wt %, about 3.0 wt % to about 5.5 wt %, about 3.0 wt % to about 5.0 wt %, about 3.0 wt % to about 4.5 wt %, about 3.0 wt % to about 4.0 wt %, about 3.5 wt % to about 7.5 wt %, about 3.5 wt % to about 7.0 wt %, about 3.5 wt % to about 6.5 wt %, about 3.5 wt % to about 6.0 wt %, about 3.5 wt % to about 5.5 wt %, about 3.5 wt % to about 5.0 wt %, about 3.5 wt % to about 4.5 wt %, about 4.0 wt % to about 7.5 wt %, about 4.0 wt % to about 7.0 wt %, about 4.0 wt % to about 6.5 wt %, about 4.0 wt % to about 6.0 wt %, about 4.0 wt % to about 5.5 wt %, about 4.0 wt % to about 5.0 wt %, about 4.5 wt % to about 7.5 wt %, about 4.5 wt % to about 7.0 wt %, about 4.5 wt % to about 6.5 wt %, about 4.5 wt % to about 6.0 wt %, about 4.5 wt % to about 5.5 wt %, about 5.0 wt % to about 7.5 wt %, about 5.0 wt % to about 7.0 wt %, about 5.0 wt % to about 6.5 wt %, about 5.0 wt % to about 6.0 wt %, about 5.5 wt % to about 7.5 wt %, about 5.5 wt % to about 7.0 wt %, about 5.5 wt % to about 6.5 wt %, about 6.0 wt % to about 7.5 wt %, about 6.0 wt % to about 7.0 wt %, or about 6.5 wt % to about 7.5 wt %.

In any aspect or embodiment described herein, the at least one solvent is present in the composition in an amount of about 60.0 wt % to about 90.0 wt % (e.g., about 65.0 wt % to about 90.0 wt %, about 70.0 wt % to about 90.0 wt %, or about 80.0 wt % to about 82.0 wt %). For example, in any aspect or embodiment described herein, the at least one solvent is present in the composition in an amount of about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 60.0 wt % to about 65.0 wt %, about 65.0 wt % to about 90.0 wt %, about 65.0 wt % to about 85.0 wt %, about 65.0 wt % to about 80.0 wt %, about 65.0 wt % to about 75.0 wt %, about 65.0 wt % to about 70.0 wt %, about 70.0 wt % to about 90.0 wt %, about 70.0 wt % to about 85.0 wt %, about 70.0 wt % to about 80.0 wt %, about 70.0 wt % to about 75.0 wt %, about 75.0 wt % to about 90.0 wt %, about 75.0 wt % to about 85.0 wt %, about 75.0 wt % to about 80.0 wt %, about 80.0 wt % to about 90.0 wt %, about 80.0 wt % to about 85.0 wt %, or about 85.0 wt % to about 90.0 wt %.

In any aspect or embodiment described herein, the at least one anti-freezing agent or freezing point depressant (e.g. urea) is present in an amount of about 0.01 wt % to about 1.5 wt % (e.g., about 0.05 wt % to about 1.0 wt % or about 0.3 wt %). For example, in any aspect or embodiment described herein, the at least one anti-freezing agent or freezing point depressant (e.g. urea) is present in an amount of about 0.01 wt % to about 1.5 wt %, about 0.01 wt % to about 1.25 wt %, about 0.01 wt % to about 1.0 wt %, about 0.01 wt % to about 0.75 wt %, about 0.01 wt % to about 0.5 wt %, about 0.01 wt % to about 0.25 wt %, about 0.1 wt % to about 1.5 wt %, about 0.1 wt % to about 1.25 wt %, about 0.1 wt % to about 1.0 wt %, about 0.1 wt % to about 0.75 wt %, about 0.1 wt % to about 0.5 wt %, about 0.1 wt % to about 0.25 wt %, about 0.25 wt % to about 1.5 wt %, about 0.25 wt % to about 1.25 wt %, about 0.25 wt % to about 1.0 wt %, about 0.25 wt % to about 0.75 wt %, about 0.25 wt % to about 0.5 wt %, about 0.5 wt % to about 1.5 wt %, about 0.5 wt % to about 1.25 wt %, about 0.5 wt % to about 1.0 wt %, about 0.5 wt % to about 0.75 wt %, about 0.75 wt % to about 1.5 wt %, about 0.75 wt % to about 1.25 wt %, about 0.75 wt % to about 1.0 wt %, about 1.0 wt % to about 1.5 wt %, about 1.0 wt % to about 1.25 wt %, or about 1.25 wt % to about 1.5 wt %.

In any aspect or embodiment described herein, the at least one nutrient (e.g., at least one (e.g., 1, 2, 3, 4, 5, 6, 7, 8, 9, 10, or more) micronutrient, at least one (e.g., 1, 2, 3, 4, 5, 6, 7, 8, 9, 10, or more) macronutrient, or a combination thereof) is present in an amount of less than or equal to about 20.0 wt % (e.g., at least one micronutrient in an amount of less than or equal to about 3.0 wt %, at least one macronutrient in an amount of less than or equal to about 20.0 wt %, or a combination thereof). For example, in any aspect or embodiment described herein, the at least one nutrient is present in an amount of about 0.1 wt % to about 20.0 wt %, about 0.1 wt % to about 19.0 wt %, about 0.1 wt % to about 18.0 wt %, about 0.1 wt % to about 17.0 wt %, about 0.1 wt % to about 16.0 wt %, about 0.1 wt % to about 15.0 wt %, about 0.1 wt % to about 14.0 wt %, about 0.1 wt % to about 13.0 wt %, about 0.1 wt % to about 12.0 wt %, about 0.1 wt % to about 11.0 wt %, about 0.1 wt % to about 10.0 wt %, about 0.1 wt % to about 9.0 wt %, about 0.1 wt % to about 8.0 wt %, about 0.1 wt % to about 7.0 wt %, about 0.1 wt % to about 6.0 wt %, about 0.1 wt % to about 5.0 wt %, about 0.1 wt % to about 4.0 wt %, about 0.1 wt % to about 3.0 wt %, about 0.1 wt % to about 2.0 wt %, about 0.1 wt % to about 1.0 wt %, about 0.5 wt % to about 20.0 wt %, about 0.5 wt % to about 19.0 wt %, about 0.5 wt % to about 18.0 wt %, about 0.5 wt % to about 17.0 wt %, about 0.5 wt % to about 16.0 wt %, about 0.5 wt % to about 15.0 wt %, about 0.5 wt % to about 14.0 wt %, about 0.5 wt % to about 13.0 wt %, about 0.5 wt % to about 12.0 wt %, about 0.5 wt % to about 11.0 wt %, about 0.5 wt % to about 10.0 wt %, about 0.5 wt % to about 9.0 wt %, about 0.5 wt % to about 8.0 wt %, about 0.5 wt % to about 7.0 wt %, about 0.5 wt % to about 6.0 wt %, about 0.5 wt % to about 5.0 wt %, about 0.5 wt % to about 4.0 wt %, about 0.5 wt % to about 3.0 wt %, about 0.5 wt % to about 2.0 wt %, about 1.0 wt % to about 20.0 wt %, about 1.0 wt % to about 19.0 wt %, about 1.0 wt % to about 18.0 wt %, about 1.0 wt % to about 17.0 wt %, about 1.0 wt % to about 16.0 wt %, about 1.0 wt % to about 15.0 wt %, about 1.0 wt % to about 14.0 wt %, about 1.0 wt % to about 13.0 wt %, about 1.0 wt % to about 12.0 wt %, about 1.0 wt % to about 11.0 wt %, about 1.0 wt % to about 10.0 wt %, about 1.0 wt % to about 9.0 wt %, about 1.0 wt % to about 8.0 wt %, about 1.0 wt % to about 7.0 wt %, about 1.0 wt % to about 6.0 wt %, about 1.0 wt % to about 5.0 wt %, about 1.0 wt % to about 4.0 wt %, about 1.0 wt % to about 3.0 wt %, about 1.0 wt % to about 2.0 wt %, about 2.0 wt % to about 20.0 wt %, about 2.0 wt % to about 19.0 wt %, about 2.0 wt % to about 18.0 wt %, about 2.0 wt % to about 17.0 wt %, about 2.0 wt % to about 16.0 wt %, about 2.0 wt % to about 15.0 wt %, about 2.0 wt % to about 14.0 wt %, about 2.0 wt % to about 13.0 wt %, about 2.0 wt % to about 12.0 wt %, about 2.0 wt % to about 11.0 wt %, about 2.0 wt % to about 10.0 wt %, about 2.0 wt % to about 9.0 wt %, about 2.0 wt % to about 8.0 wt %, about 2.0 wt % to about 7.0 wt %, about 2.0 wt % to about 6.0 wt %, about 2.0 wt % to about 5.0 wt %, about 2.0 wt % to about 4.0 wt %, about 2.0 wt % to about 3.0 wt %, about 3.0 wt % to about 20.0 wt %, about 3.0 wt % to about 19.0 wt %, about 3.0 wt % to about 18.0 wt %, about 3.0 wt % to about 17.0 wt %, about 3.0 wt % to about 16.0 wt %, about 3.0 wt % to about 15.0 wt %, about 3.0 wt % to about 14.0 wt %, about 3.0 wt % to about 13.0 wt %, about 3.0 wt % to about 12.0 wt %, about 3.0 wt % to about 11.0 wt %, about 3.0 wt % to about 10.0 wt %, about 3.0 wt % to about 9.0 wt %, about 3.0 wt % to about 8.0 wt %, about 3.0 wt % to about 7.0 wt %, about 3.0 wt % to about 6.0 wt %, about 3.0 wt % to about 5.0 wt %, about 3.0 wt % to about 4.0 wt %, about 4.0 wt % to about 20.0 wt %, about 3.0 wt % to about 19.0 wt %, about 3.0 wt % to about 18.0 wt %, about 3.0 wt % to about 17.0 wt %, about 4.0 wt % to about 16.0 wt %, about 4.0 wt % to about 15.0 wt %, about 4.0 wt % to about 14.0 wt %, about 4.0 wt % to about 13.0 wt %, about 4.0 wt % to about 12.0 wt %, about 4.0 wt % to about 11.0 wt %, about 4.0 wt % to about 10.0 wt %, about 4.0 wt % to about 9.0 wt %, about 4.0 wt % to about 8.0 wt %, about 4.0 wt % to about 7.0 wt %, about 4.0 wt % to about 6.0 wt %, about 4.0 wt % to about 5.0 wt %, about 5.0 wt % to about 20.0 wt %, about 5.0 wt % to about 19.0 wt %, about 5.0 wt % to about 18.0 wt %, about 5.0 wt % to about 17.0 wt %, about 5.0 wt % to about 16.0 wt %, about 5.0 wt % to about 15.0 wt %, about 5.0 wt % to about 14.0 wt %, about 5.0 wt % to about 13.0 wt %, about 5.0 wt % to about 12.0 wt %, about 5.0 wt % to about 11.0 wt %, about 5.0 wt % to about 10.0 wt %, about 5.0 wt % to about 9.0 wt %, about 5.0 wt % to about 8.0 wt %, about 5.0 wt % to about 7.0 wt %, about 5.0 wt % to about 6.0 wt %, about 6.0 wt % to about 20.0 wt %, about 6.0 wt % to about 19.0 wt %, about 6.0 wt % to about 18.0 wt %, about 6.0 wt % to about 17.0 wt %, about 6.0 wt % to about 16.0 wt %, about 6.0 wt % to about 15.0 wt %, about 6.0 wt % to about 14.0 wt %, about 6.0 wt % to about 13.0 wt %, about 6.0 wt % to about 12.0 wt %, about 6.0 wt % to about 11.0 wt %, about 6.0 wt % to about 10.0 wt %, about 6.0 wt % to about 9.0 wt %, about 6.0 wt % to about 8.0 wt %, about 6.0 wt % to about 7.0 wt %, about 7.0 wt % to about 20.0 wt %, about 7.0 wt % to about 19.0 wt %, about 7.0 wt % to about 18.0 wt %, about 7.0 wt % to about 17.0 wt %, about 7.0 wt % to about 16.0 wt %, about 7.0 wt % to about 15.0 wt %, about 7.0 wt % to about 14.0 wt %, about 7.0 wt % to about 13.0 wt %, about 7.0 wt % to about 12.0 wt %, about 7.0 wt % to about 11.0 wt %, about 7.0 wt % to about 10.0 wt %, about 7.0 wt % to about 9.0 wt %, about 7.0 wt % to about 8.0 wt %, about 8.0 wt % to about 20.0 wt %, about 8.0 wt % to about 19.0 wt %, about 8.0 wt % to about 18.0 wt %, about 8.0 wt % to about 17.0 wt %, about 8.0 wt % to about 16.0 wt %, about 8.0 wt % to about 15.0 wt %, about 8.0 wt % to about 14.0 wt %, about 8.0 wt % to about 13.0 wt %, about 8.0 wt % to about 12.0 wt %, about 8.0 wt % to about 11.0 wt %, about 8.0 wt % to about 10.0 wt %, about 8.0 wt % to about 9.0 wt %, about 9.0 wt % to about 20.0 wt %, about 9.0 wt % to about 19.0 wt %, about 9.0 wt % to about 18.0 wt %, about 9.0 wt % to about 17.0 wt %, about 9.0 wt % to about 16.0 wt %, about 9.0 wt % to about 15.0 wt %, about 9.0 wt % to about 14.0 wt %, about 9.0 wt % to about 13.0 wt %, about 9.0 wt % to about 12.0 wt %, about 9.0 wt % to about 11.0 wt %, about 9.0 wt % to about 10.0 wt %, about 10.0 wt % to about 20.0 wt %, about 10.0 wt % to about 19.0 wt %, about 10.0 wt % to about 18.0 wt %, about 10.0 wt % to about 17.0 wt %, about 10.0 wt % to about 16.0 wt %, about 10.0 wt % to about 15.0 wt %, about 10.0 wt % to about 14.0 wt %, about 10.0 wt % to about 13.0 wt %, about 10.0 wt % to about 12.0 wt %, about 10.0 wt % to about 11.0 wt %, about 11.0 wt % to about 20.0 wt %, about 11.0 wt % to about 19.0 wt %, about 11.0 wt % to about 18.0 wt %, about 11.0 wt % to about 17.0 wt %, about 11.0 wt % to about 16.0 wt %, about 11.0 wt % to about 15.0 wt %, about 11.0 wt % to about 14.0 wt %, about 11.0 wt % to about 13.0 wt %, about 11.0 wt % to about 12.0 wt %, about 12.0 wt % to about 20.0 wt %, about 12.0 wt % to about 19.0 wt %, about 12.0 wt % to about 18.0 wt %, about 12.0 wt % to about 17.0 wt %, about 12.0 wt % to about 16.0 wt %, about 12.0 wt % to about 15.0 wt %, about 12.0 wt % to about 14.0 wt %, about 12.0 wt % to about 13.0 wt %, about 13.0 wt % to about 20.0 wt %, about 13.0 wt % to about 19.0 wt %, about 13.0 wt % to about 18.0 wt %, about 13.0 wt % to about 17.0 wt %, about 13.0 wt % to about 16.0 wt %, about 13.0 wt % to about 15.0 wt %, about 13.0 wt % to about 14.0 wt %, about 14.0 wt % to about 20.0 wt %, about 14.0 wt % to about 19.0 wt %, about 14.0 wt % to about 18.0 wt %, about 14.0 wt % to about 17.0 wt %, about 14.0 wt % to about 16.0 wt %, about 14.0 wt % to about 15.0 wt %, about 15.0 wt % to about 20.0 wt %, about 15.0 wt % to about 19.0 wt %, about 15.0 wt % to about 18.0 wt %, about 15.0 wt % to about 17.0 wt %, about 15.0 wt % to about 16.0 wt %, about 16.0 wt % to about 20.0 wt %, about 16.0 wt % to about 19.0 wt %, about 16.0 wt % to about 18.0 wt %, about 16.0 wt % to about 17.0 wt %, about 17.0 wt % to about 20.0 wt %, about 17.0 wt % to about 19.0 wt %, about 17.0 wt % to about 18.0 wt %, about 18.0 wt % to about 20.0 wt %, about 18.0 wt % to about 19.0 wt %, or about 19.0 wt % to about 20.0 wt %.

In any aspect or embodiment described herein, the at least one micronutrient is present in an amount of about 0.1 wt % to about 3.0 wt %, about 0.1 wt % to about 2.5 wt %, about 0.1 wt % to about 2.0 wt %, about 0.1 wt % to about 1.5 wt %, about 0.1 wt % to about 1.0 wt %, about 0.1 wt % to about 0.5 wt %, about 0.5 wt % to about 3.0 wt %, about 0.5 wt % to about 2.5 wt %, about 0.5 wt % to about 2.0 wt %, about 0.5 wt % to about 1.5 wt %, about 0.5 wt % to about 1.0 wt %, about 1.0 wt % to about 3.0 wt %, about 1.0 wt % to about 2.5 wt %, about 1.0 wt % to about 2.0 wt %, about 1.0 wt % to about 1.5 wt %, about 1.5 wt % to about 3.0 wt %, about 1.5 wt % to about 2.5 wt %, about 1.5 wt % to about 2.0 wt %, about 2.0 wt % to about 3.0 wt %, about 2.0 wt % to about 2.5 wt %, or about 2.5 wt % to about 3.0 wt %. In any aspect or embodiment described herein, the at least one macronutrient is present in an amount of about 0.1 wt % to about 20.0 wt %, about 0.1 wt % to about 19.0 wt %, about 0.1 wt % to about 18.0 wt %, about 0.1 wt % to about 17.0 wt %, about 0.1 wt % to about 16.0 wt %, about 0.1 wt % to about 15.0 wt %, about 0.1 wt % to about 14.0 wt %, about 0.1 wt % to about 13.0 wt %, about 0.1 wt % to about 12.0 wt %, about 0.1 wt % to about 11.0 wt %, about 0.1 wt % to about 10.0 wt %, about 0.1 wt % to about 9.0 wt %, about 0.1 wt % to about 8.0 wt %, about 0.1 wt % to about 7.0 wt %, about 0.1 wt % to about 6.0 wt %, about 0.1 wt % to about 5.0 wt %, about 0.1 wt % to about 4.0 wt %, about 0.1 wt % to about 3.0 wt %, about 0.1 wt % to about 2.0 wt %, about 0.1 wt % to about 1.0 wt %, about 0.5 wt % to about 20.0 wt %, about 0.5 wt % to about 19.0 wt %, about 0.5 wt % to about 18.0 wt %, about 0.5 wt % to about 17.0 wt %, about 0.5 wt % to about 16.0 wt %, about 0.5 wt % to about 15.0 wt %, about 0.5 wt % to about 14.0 wt %, about 0.5 wt % to about 13.0 wt %, about 0.5 wt % to about 12.0 wt %, about 0.5 wt % to about 11.0 wt %, about 0.5 wt % to about 10.0 wt %, about 0.5 wt % to about 9.0 wt %, about 0.5 wt % to about 8.0 wt %, about 0.5 wt % to about 7.0 wt %, about 0.5 wt % to about 6.0 wt %, about 0.5 wt % to about 5.0 wt %, about 0.5 wt % to about 4.0 wt %, about 0.5 wt % to about 3.0 wt %, about 0.5 wt % to about 2.0 wt %, about 1.0 wt % to about 20.0 wt %, about 1.0 wt % to about 19.0 wt %, about 1.0 wt % to about 18.0 wt %, about 1.0 wt % to about 17.0 wt %, about 1.0 wt % to about 16.0 wt %, about 1.0 wt % to about 15.0 wt %, about 1.0 wt % to about 14.0 wt %, about 1.0 wt % to about 13.0 wt %, about 1.0 wt % to about 12.0 wt %, about 1.0 wt % to about 11.0 wt %, about 1.0 wt % to about 10.0 wt %, about 1.0 wt % to about 9.0 wt %, about 1.0 wt % to about 8.0 wt %, about 1.0 wt % to about 7.0 wt %, about 1.0 wt % to about 6.0 wt %, about 1.0 wt % to about 5.0 wt %, about 1.0 wt % to about 4.0 wt %, about 1.0 wt % to about 3.0 wt %, about 1.0 wt % to about 2.0 wt %, about 2.0 wt % to about 20.0 wt %, about 2.0 wt % to about 19.0 wt %, about 2.0 wt % to about 18.0 wt %, about 2.0 wt % to about 17.0 wt %, about 2.0 wt % to about 16.0 wt %, about 2.0 wt % to about 15.0 wt %, about 2.0 wt % to about 14.0 wt %, about 2.0 wt % to about 13.0 wt %, about 2.0 wt % to about 12.0 wt %, about 2.0 wt % to about 11.0 wt %, about 2.0 wt % to about 10.0 wt %, about 2.0 wt % to about 9.0 wt %, about 2.0 wt % to about 8.0 wt %, about 2.0 wt % to about 7.0 wt %, about 2.0 wt % to about 6.0 wt %, about 2.0 wt % to about 5.0 wt %, about 2.0 wt % to about 4.0 wt %, about 2.0 wt % to about 3.0 wt %, about 3.0 wt % to about 20.0 wt %, about 3.0 wt % to about 19.0 wt %, about 3.0 wt % to about 18.0 wt %, about 3.0 wt % to about 17.0 wt %, about 3.0 wt % to about 16.0 wt %, about 3.0 wt % to about 15.0 wt %, about 3.0 wt % to about 14.0 wt %, about 3.0 wt % to about 13.0 wt %, about 3.0 wt % to about 12.0 wt %, about 3.0 wt % to about 11.0 wt %, about 3.0 wt % to about 10.0 wt %, about 3.0 wt % to about 9.0 wt %, about 3.0 wt % to about 8.0 wt %, about 3.0 wt % to about 7.0 wt %, about 3.0 wt % to about 6.0 wt %, about 3.0 wt % to about 5.0 wt %, about 3.0 wt % to about 4.0 wt %, about 4.0 wt % to about 20.0 wt %, about 3.0 wt % to about 19.0 wt %, about 3.0 wt % to about 18.0 wt %, about 3.0 wt % to about 17.0 wt %, about 4.0 wt % to about 16.0 wt %, about 4.0 wt % to about 15.0 wt %, about 4.0 wt % to about 14.0 wt %, about 4.0 wt % to about 13.0 wt %, about 4.0 wt % to about 12.0 wt %, about 4.0 wt % to about 11.0 wt %, about 4.0 wt % to about 10.0 wt %, about 4.0 wt % to about 9.0 wt %, about 4.0 wt % to about 8.0 wt %, about 4.0 wt % to about 7.0 wt %, about 4.0 wt % to about 6.0 wt %, about 4.0 wt % to about 5.0 wt %, about 5.0 wt % to about 20.0 wt %, about 5.0 wt % to about 19.0 wt %, about 5.0 wt % to about 18.0 wt %, about 5.0 wt % to about 17.0 wt %, about 5.0 wt % to about 16.0 wt %, about 5.0 wt % to about 15.0 wt %, about 5.0 wt % to about 14.0 wt %, about 5.0 wt % to about 13.0 wt %, about 5.0 wt % to about 12.0 wt %, about 5.0 wt % to about 11.0 wt %, about 5.0 wt % to about 10.0 wt %, about 5.0 wt % to about 9.0 wt %, about 5.0 wt % to about 8.0 wt %, about 5.0 wt % to about 7.0 wt %, about 5.0 wt % to about 6.0 wt %, about 6.0 wt % to about 20.0 wt %, about 6.0 wt % to about 19.0 wt %, about 6.0 wt % to about 18.0 wt %, about 6.0 wt % to about 17.0 wt %, about 6.0 wt % to about 16.0 wt %, about 6.0 wt % to about 15.0 wt %, about 6.0 wt % to about 14.0 wt %, about 6.0 wt % to about 13.0 wt %, about 6.0 wt % to about 12.0 wt %, about 6.0 wt % to about 11.0 wt %, about 6.0 wt % to about 10.0 wt %, about 6.0 wt % to about 9.0 wt %, about 6.0 wt % to about 8.0 wt %, about 6.0 wt % to about 7.0 wt %, about 7.0 wt % to about 20.0 wt %, about 7.0 wt % to about 19.0 wt %, about 7.0 wt % to about 18.0 wt %, about 7.0 wt % to about 17.0 wt %, about 7.0 wt % to about 16.0 wt %, about 7.0 wt % to about 15.0 wt %, about 7.0 wt % to about 14.0 wt %, about 7.0 wt % to about 13.0 wt %, about 7.0 wt % to about 12.0 wt %, about 7.0 wt % to about 11.0 wt %, about 7.0 wt % to about 10.0 wt %, about 7.0 wt % to about 9.0 wt %, about 7.0 wt % to about 8.0 wt %, about 8.0 wt % to about 20.0 wt %, about 8.0 wt % to about 19.0 wt %, about 8.0 wt % to about 18.0 wt %, about 8.0 wt % to about 17.0 wt %, about 8.0 wt % to about 16.0 wt %, about 8.0 wt % to about 15.0 wt %, about 8.0 wt % to about 14.0 wt %, about 8.0 wt % to about 13.0 wt %, about 8.0 wt % to about 12.0 wt %, about 8.0 wt % to about 11.0 wt %, about 8.0 wt % to about 10.0 wt %, about 8.0 wt % to about 9.0 wt %, about 9.0 wt % to about 20.0 wt %, about 9.0 wt % to about 19.0 wt %, about 9.0 wt % to about 18.0 wt %, about 9.0 wt % to about 17.0 wt %, about 9.0 wt % to about 16.0 wt %, about 9.0 wt % to about 15.0 wt %, about 9.0 wt % to about 14.0 wt %, about 9.0 wt % to about 13.0 wt %, about 9.0 wt % to about 12.0 wt %, about 9.0 wt % to about 11.0 wt %, about 9.0 wt % to about 10.0 wt %, about 10.0 wt % to about 20.0 wt %, about 10.0 wt % to about 19.0 wt %, about 10.0 wt % to about 18.0 wt %, about 10.0 wt % to about 17.0 wt %, about 10.0 wt % to about 16.0 wt %, about 10.0 wt % to about 15.0 wt %, about 10.0 wt % to about 14.0 wt %, about 10.0 wt % to about 13.0 wt %, about 10.0 wt % to about 12.0 wt %, about 10.0 wt % to about 11.0 wt %, about 11.0 wt % to about 20.0 wt %, about 11.0 wt % to about 19.0 wt %, about 11.0 wt % to about 18.0 wt %, about 11.0 wt % to about 17.0 wt %, about 11.0 wt % to about 16.0 wt %, about 11.0 wt % to about 15.0 wt %, about 11.0 wt % to about 14.0 wt %, about 11.0 wt % to about 13.0 wt %, about 11.0 wt % to about 12.0 wt %, about 12.0 wt % to about 20.0 wt %, about 12.0 wt % to about 19.0 wt %, about 12.0 wt % to about 18.0 wt %, about 12.0 wt % to about 17.0 wt %, about 12.0 wt % to about 16.0 wt %, about 12.0 wt % to about 15.0 wt %, about 12.0 wt % to about 14.0 wt %, about 12.0 wt % to about 13.0 wt %, about 13.0 wt % to about 20.0 wt %, about 13.0 wt % to about 19.0 wt %, about 13.0 wt % to about 18.0 wt %, about 13.0 wt % to about 17.0 wt %, about 13.0 wt % to about 16.0 wt %, about 13.0 wt % to about 15.0 wt %, about 13.0 wt % to about 14.0 wt %, about 14.0 wt % to about 20.0 wt %, about 14.0 wt % to about 19.0 wt %, about 14.0 wt % to about 18.0 wt %, about 14.0 wt % to about 17.0 wt %, about 14.0 wt % to about 16.0 wt %, about 14.0 wt % to about 15.0 wt %, about 15.0 wt % to about 20.0 wt %, about 15.0 wt % to about 19.0 wt %, about 15.0 wt % to about 18.0 wt %, about 15.0 wt % to about 17.0 wt %, about 15.0 wt % to about 16.0 wt %, about 16.0 wt % to about 20.0 wt %, about 16.0 wt % to about 19.0 wt %, about 16.0 wt % to about 18.0 wt %, about 16.0 wt % to about 17.0 wt %, about 17.0 wt % to about 20.0 wt %, about 17.0 wt % to about 19.0 wt %, about 17.0 wt % to about 18.0 wt %, about 18.0 wt % to about 20.0 wt %, about 18.0 wt % to about 19.0 wt %, or about 19.0 wt % to about 20.0 wt %.

In any aspect or embodiment described herein, the at least one preservative is present in the composition in an amount of less than or equal to about 0.5 wt % (e.g., less than or equal to about 0.4 wt %, less than or equal to about 0.3 wt %, less than or equal to about 0.2 wt %, less than or equal to 0.1 wt %, or about 0.01 wt % to about 0.5 wt %). For example, in any aspect or embodiment described herein, the at least one preservative is present in the composition in an amount of about 0.01 wt % to about 0.5 wt %, about 0.01 wt % to about 0.4 wt %, about 0.01 wt % to about 0.3 wt %, about 0.01 wt % to about 0.2 wt %, about 0.1 wt % to about 0.5 wt %, about 0.1 wt % to about 0.4 wt %, about 0.1 wt % to about 0.3 wt %, about 0.1 wt % to about 0.2 wt %, about 0.2 wt % to about 0.5 wt %, about 0.2 wt % to about 0.4 wt %, about 0.2 wt % to about 0.3 wt %, about 0.3 wt % to about 0.5 wt %, about 0.3 wt % to about 0.4 wt %, or about 0.4 wt % to about 0.5 wt %.

In any aspect or embodiment described herein, the at least one protectant is present in the composition in an amount of less than or equal to about 2.0 wt % (e.g., less than or equal to about 1.9 wt %, less than or equal to about 1.8 wt %, less than or equal to about 1.7 wt %, less than or equal to about 1.6 wt %, less than or equal to about 1.5 wt %, less than or equal to about 1.4 wt %, less than or equal to about 1.3 wt %, less than or equal to about 1.2 wt %, less than or equal to about 1.1 wt %, less than or equal to about 1.0 wt %, or about 0.1 wt % to about 2.0 wt %). For example, in any aspect or embodiment described herein, the at least one protectant is present in the composition in an amount of about 0.1 wt % to about 2.0 wt %, about 0.1 wt % to about 1.8 wt %, about 0.1 wt % to about 1.6 wt %, about 0.1 wt % to about 1.4 wt %, about 0.1 wt % to about 1.2 wt %, about 0.1 wt % to about 1.0 wt %, about 0.1 wt % to about 0.8 wt %, about 0.1 wt % to about 0.6 wt %, about 0.1 wt % to about 0.4 wt %, about 0.2 wt % to about 2.0 wt %, about 0.2 wt % to about 1.8 wt %, about 0.2 wt % to about 1.6 wt %, about 0.2 wt % to about 1.4 wt %, about 0.2 wt % to about 1.2 wt %, about 0.2 wt % to about 1.0 wt %, about 0.2 wt % to about 0.8 wt %, about 0.2 wt % to about 0.6 wt %, about 0.2 wt % to about 0.4 wt %, about 0.4 wt % to about 2.0 wt %, about 0.4 wt % to about 1.8 wt %, about 0.4 wt % to about 1.6 wt %, about 0.4 wt % to about 1.4 wt %, about 0.4 wt % to about 1.2 wt %, about 0.4 wt % to about 1.0 wt %, about 0.4 wt % to about 0.8 wt %, about 0.4 wt % to about 0.6 wt %, about 0.6 wt % to about 2.0 wt %, about 0.6 wt % to about 1.8 wt %, about 0.6 wt % to about 1.6 wt %, about 0.6 wt % to about 1.4 wt %, about 0.6 wt % to about 1.2 wt %, about 0.6 wt % to about 1.0 wt %, about 0.6 wt % to about 0.8 wt %, about 0.8 wt % to about 2.0 wt %, about 0.8 wt % to about 1.8 wt %, about 0.8 wt % to about 1.6 wt %, about 0.8 wt % to about 1.4 wt %, about 0.8 wt % to about 1.2 wt %, about 0.8 wt % to about 1.0 wt %, about 1.0 wt % to about 2.0 wt %, about 1.0 wt % to about 1.8 wt %, about 1.0 wt % to about 1.6 wt %, about 1.0 wt % to about 1.4 wt %, about 1.0 wt % to about 1.2 wt %, about 1.2 wt % to about 2.0 wt %, about 1.2 wt % to about 1.8 wt %, about 1.2 wt % to about 1.6 wt %, about 1.2 wt % to about 1.4 wt %, about 1.4 wt % to about 2.0 wt %, about 1.4 wt % to about 1.8 wt %, about 1.4 wt % to about 1.6 wt %, about 1.6 wt % to about 2.0 wt %, about 1.6 wt % to about 1.8 wt %, or about 1.8 wt % to about 2.0 wt %.

### Exemplary Active Components

In any of the aspects or embodiments described herein, when present, the at least one (e.g., 1, 2, 3, 4, 5, 6, 7, 8, 9, 10, or more) pesticide can be any pesticide known in the art, including at least one (e.g., 1, 2, 3, 4, 5, 6, 7, 8, 9, 10, or more) fungicide, at least one (e.g., 1, 2, 3, 4, 5, 6, 7, 8, 9, 10, or more) herbicide, at least one (e.g., 1, 2, 3, 4, 5, 6, 7, 8, 9, 10, or more) insecticide, at least one (e.g., 1, 2, 3, 4, 5, 6, 7, 8, 9, 10, or more) biopesticide or its capsules, at least one (e.g., 1, 2, 3, 4, 5, 6, 7, 8, 9, 10, or more) algicide, at least one (e.g., 1, 2, 3, 4, 5, 6, 7, 8, 9, 10, or more) bactericide, at least one (e.g., 1, 2, 3, 4, 5, 6, 7, 8, 9, 10, or more) miticide, at least one (e.g., 1, 2, 3, 4, 5, 6, 7, 8, 9, 10, or more) molluscicide, at least one (e.g., 1, 2, 3, 4, 5, 6, 7, 8, 9, 10, or more) nematicide, at least one (e.g., 1, 2, 3, 4, 5, 6, 7, 8, 9, 10, or more) rodenticide, at least one (e.g., 1, 2, 3, 4, 5, 6, 7, 8, 9, 10, or more) virucide, or a combination thereof. For example, in any aspect or embodiment described herein, the pesticide includes, consists essentially of, or is mesotrione.

In any aspect or embodiment described herein, the at least one (e.g., 1, 2, 3, 4, 5, 6, 7, 8, 9, 10, or more) insecticide includes, consists essentially of, or is, for example, a carbamate (e.g., carbaryl, methiocarb, or a combination thereof); an organophosphate (e.g., acephate, chlorpyrifos, malathion, phosmet, or a combination thereof); a phenylpyrazole (e.g., fipronil); a pyrethroid (e.g., bifenthrin, cyfluthrin, fenpropathrin, fluvalinate, lambda-cyhalothrin, permethrin, or a combination thereof); a botanical (e.g., a pyrethrin); a neonicotinoid (e.g., acetamiprid, dinotefuran, imidacloprid, thiamethoxam, or a combination thereof); a butanolide (e.g., flupyradifurone); a spinosyn (e.g., spinosad); a glycoside (e.g., abamectin); an avermectin (e.g., emamectin benzoate, milbemectin, or a combination thereof); a juvenile hormone mimic (e.g., s-Kinoprene, fenoxycarb, or a combination thereof); a pyridine-insect growth regulator (e.g., pyriproxyfen); a pyridine azomethine (e.g., pymetrozine, pyrifluquinazon, or a combination thereof); a tetrazine (e.g., clofentezine); a thiazolidinones (e.g., hexythiazox); a 2,4-diphenyloxazoline derivative (e.g., etoxazole); a biopesticide (e.g., Bacillus thuringiensis kurstaki, Bacillus thuringiensis israelensis, or a combination thereof); an organotin miticides (e.g., fenbutatin-oxide); a pyrroles (e.g., chlorfenapyr); a benzolureas-insect growth regulator (e.g., diflubenzuron, novaluron, or a combination thereof); a buprofezin (e.g., buprofezin); a cyromazine-insect growth regulator (e.g., cyromazine); a diacylhydrazine (e.g., tebufenozide, methoxyfenozide, or a combination hereof); a trifluromethyl aminohydrazone (e.g., hydramethylnon); a carbazate (e.g., bifenazate); a napthoquinone derivative (e.g., acequinocyl); a mitochondrial electron transport inhibitors of complex I (METI-I) acaricides and insecticides (e.g., pyridaben, fenpyroximate, tolfenpyrad, fenazaquin, or a combination thereof); a semicarbazone (e.g., metaflumizone); a tetronic acid (e.g., spiromesifen); a tetramic acid (e.g., spirotetramat); a beta-ketonitrile (e.g., cyflumetofen); an anthranillic diamide (e.g., cyantraniliprole); a pyridine carboxamide (e.g., flonicamid); a biopesticide insect growth regulator (e.g., azadirachtin); a pyridalyl (e.g., pyridalyl); a biopesticide (e.g., Beauveria bassiana, isaria fumosorosea Apopka strain 97 (ATCC20874), Steinernema felitae, Steinernema carpocapsae, or a combination thereof); an capsule of a pesticide (e.g., lambda-cyhalothrin capsules, pendimethalin capsules, cyfluthrin capsules, or a combination thereof); an oil (e.g., botanical oil, a clarified hydrophobic extract of neem oil, mineral oil, petroleum, or a combination thereof); a soap (e.g., potassium salts of fatty acids); a pyrethrin and an oil (e.g., pyrethrins and canola oil); a pyrethrin (e.g., pyrethrin and piperonyl butoxide); an organophosphate and pyrethroid (e.g., chlorpyrifos and cyfluthrin); a pyrethroid and neonicotinoid (e.g., cyfluthrin and imidacloprid); a glycoside and carbazate (e.g., abamectin and bifenazate); or a combination thereof. For example, in any aspect or embodiment described herein, the pesticide includes, consists essentially of, or is a pyrethroid (e.g., bifenthrin, pendimethalin, permethrin, resmethrin, allethrin, cypermethrin, deltamethrin, sumithrin, or a combination thereof). In any aspect or embodiment described herein, the pesticide includes, consists essentially of, or is neem oil.

In any of the aspects or embodiments described herein, when present, the at least one (e.g., 1, 2, 3, 4, 5, 6, 7, 8, 9, 10, or more) fungicide can be any fungicide known in the art. In any aspect or embodiment described herein, the at least one (e.g., 1, 2, 3, 4, 5, 6, 7, 8, 9, 10, or more) fungicide includes, consists essentially of, or is, for example, methylparaben, azoxystrobin, bifujunzhi, coumethoxystrobin, coumoxystrobin; dimoxystrobin, enestroburin, enoxastrobin, fenaminstrobin, fenoxystrobin, flufenoxystrobin, fluoxastrobin, jiaxiangjunzhi, kresoxim-methyl, mandestrobin, metominostrobin, orysastrobin, picoxystrobin, pyraclostrobin, pyrametostrobin, pyraoxystrobin, triclopyricarb, trifloxystrobin, methyl 2-[2-(2,5-dimethylphenyloxymethyl)phenyl]-3-methoxyacrylate, pyribencarb, triclopyricarb/chlorodincarb, famoxadon, fenamidon, cyazofamid, amisulbrom, benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthio-biphenyl-2-yl)-3-difluoromethyl-1-methyl-1H-pyr-azole-4-carboxamide, N-(2-(1,3,3-trimethylbutyl)phenyl)-1,3-dimethyl-5-fluoro-1H-pyrazole-4-ca-rboxamide, N-[9-(dichloromethylene)-1,2,3,4-tetrahydro-1,4-methanonaphthal-en-5-yl]-3-(difluoromethyl)-1-methyl-H-pyrazole-4-carboxamide, diflumetorim, binapacryl, dinobuton, dinocap, meptyl-dinocap, fluazinam, ferimzone, ametoctradin, silthiofam, azaconazole, bitertanol, bromuconazole, cyproconazole, difenoconazole, diniconazole, diniconazole-M, epoxiconazole; fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, imazalil, pefurazoate, prochloraz, triflumizole, pyrimidines, fenarimol, nuarimol, pyrifenox, triforine, aldimorph, dodemorph, dodemorph acetate, fenpropimorph, tridemorph, fenpropidin, piperalin, spiroxamine, fenhexamid, benalaxyl, benalaxyl-M, kiralaxyl; metalaxyl, metalaxyl-M (mefenoxam), ofurace; oxadixyl, hymexazole, octhilinone, oxolinic acid, bupirimate, benomyl, carbendazim, fuberidazole, thiabendazole, thiophanate-methyl, 5-chloro-7-(4-methyl-piperidin-1-yl)-6-(2,4,6-trifluorophenyl)-[1,2,4]tri-azolo [1,5-a]pyrimidine, diethofencarb, ethaboxam, pencycuron, fluopicolid, zoxainid, metrafenon, pyriofenon, cyprodinil, mepanipyrim, pyrimethanil, fluoroimide, iprodione, procymidone, vinclozolin fenpiclonil, fludioxonil, quinoxyfen, edifenphos, iprobenfos, pyrazophos, isoprothiolane, dicloran, quintozene, tecnazene, tolclofos-methyl, biphenyl, chloroneb, etridiazole, dimethomorph, flumorph, mandipropamid, pyrimorph, benthiavalicarb, iprovalicarb, valifenalate and 4-fluorophenyl N-(1-(1-(4-cyanophenyl) ethanesulfonyl) but-2-yl) carbamate, propamocarb, propamocarb hydrochloride, ferbam, mancozeb, maneb, metiram, propineb, thiram, zineb, ziram, anilazine, chlorothalonil, captafol, captan, folpet, dichlofluanid, dichlorophen, flusulfamide, hexachlorobenzene, pentachlorophenol, phthalid, tolylfluanid, N-(4-chloro-2-nitrophenyl)-N-ethyl-4-methylbenzenesulfonamide, guanidine, dithianon, validamycin, polyoxin B, pyroquilon, tricyclazole, carpropamid, dicyclomet, fenoxanil, or a combination thereof.

In any of the aspects or embodiments described herein, when present, the at least one (e.g., 1, 2, 3, 4, 5, 6, 7, 8, 9, 10, or more) herbicide can be any herbicide known in the art. In any aspect or embodiment described herein, the at least one (e.g., 1, 2, 3, 4, 5, 6, 7, 8, 9, 10, or more) herbicide includes, consists essentially of, or is, for example, acetochlor, acifluorfen, alloxydim, amidosulfuron, aminopyralid, atrazine, beflubutamid, bispyribac, butafenacil, cafenstrole, carfentrazone, chlorimuron, chlorotoluron, cinidon-ethyl, clethodim, clodinafop, clomazone, cloproxydim, clopyralid, cloransulam, cyanazine, cyclosulfamuron, cycloxydim, cyhalofop, daimuron, dicamba, diclofop, diclosulam, diflufenican, dimethenamid, diquat, dithiopyr, diuron, ethalfluralin, fenoxaprop, flazasulfuron, florasulam, fluazifop, flucarbazone, flufenacet, flufenican, flufenpyr, flumetsulam, flumiclorac, flumioxazin, fluroxypyr, fluthiacet, fomesafen, foramsulfuron, glufosinate, glyphosate, halosafen, halosulfuron, haloxyfop, imazamethabenz, imazamox, imazapic, imazapyr, imazaquin, imazethapyr, imazosulfuron, iodosulfuron, ioxynil, isoxaben, isoxaflutole, lactofen, linuron, mefenacet, mefluidide, mesosulfuron, mesotrione, metamifop, metazachlor, metosulam, metribuzin, MSMA, napropamide, nicosulfuron, norflurazon, oryzalin, oxadiazon, oxyfluorfen, paraquat, pebulate, pendimethalin, penoxsulam, picloram, picolinafen, pinoxaden, primisulfuron, profoxydim, propanil, pyraflufen, pyrazosulfuron, pyribenzoxim, pyriminobac, pyrithiobac, pyroxasulfone, pyroxsulam, quinclorac, quinmerac, quizalofop, rimsulfuron, sethoxydim, simazine, sulcotrione, sulfentrazone, sulfometuron, tefuryltrione, tembotrione, tepraloxydim, terbacil, thiazopyr, thidiazuron, thiencarbazone, thifensulfuron, thiobencarb, topramezone, tralkoxydim, triasulfuron, tribenuron, triclopyr, trifloxysulfuron, trifluralin, triflusulfuron, tritosulfuron, or a combination thereof.

As used herein, “biostimulant” includes a substance or micro-organism that, when applied to seeds, plants, or the rhizosphere, stimulates natural processes to enhance or benefit nutrient uptake, nutrient efficiency, tolerance to abiotic stress, and/or crop quality and yield. Thus, biostimulants are used, by itself or in combination with other substances or microbes as described herein, for the purpose of stimulating natural processes in plants or in the soil in order to, among other things: improve nutrient and/or water use efficiency by plants, help plants tolerate abiotic stress, and/or improve characteristics (e.g., physical, chemical, and/or biological characteristics) of the soil as a medium for plant growth. Thus, biostimulants are substance(s), microorganism(s), or mixtures thereof, that, when applied to seeds, plants, the rhizosphere, soil, or other growth media, act to support a plant's natural nutrition processes independently of the biostimulant's nutrient content, thereby improving nutrient availability, uptake and/or use efficiency, tolerance to abiotic stress, and/or consequent growth, development, quality, and/or yield. For example, in any aspect or embodiment described herein, the at least one biostimulant comprises, consists essentially of, or is at least one (e.g., 1, 2, 3, 4, 5, 6, 7, 8, 9, 10, or more) humic acid and/or fulvic acid (e.g., peat, decomposed plant residue, decomposed animal residue, decomposed microbial residue, of a combination thereof), at least one (e.g., 1, 2, 3, 4, 5, 6, 7, 8, 9, 10, or more) protein hydrolysate, at least one (e.g., 1, 2, 3, 4, 5, 6, 7, 8, 9, 10, or more) seaweed extract (e.g., a soluble seaweed powder extract, a seaweed liquid extract, or a combination thereof), at least one (e.g., 1, 2, 3, 4, 5, 6, 7, 8, 9, 10, or more) plant extract, at least one (e.g., 1, 2, 3, 4, 5, 6, 7, 8, 9, 10, or more) chitosan biopolymer, at least one (e.g., 1, 2, 3, 4, 5, 6, 7, 8, 9, 10, or more) inorganic compound (e.g., phosphites, silicon, or a combination thereof), manure (e.g., liquid manure), at least one (e.g., 1, 2, 3, 4, 5, 6, 7, 8, 9, 10, or more) fungi (e.g., Rhizobium), at least one (e.g., 1, 2, 3, 4, 5, 6, 7, 8, 9, 10, or more) bacteria (e.g., Bacillus), or a combination thereof.

### Exemplary Nutrient Compositions/Formulations

An aspect of the present disclosure relates to a composition or formulation (e.g., an agricultural composition or formulation, or a nutrient composition or formulation) comprising, consisting essentially of, or consisting of: at least one (e.g., 1, 2, 3, 4, 5, 6, 7, 8, 9, 10, or more) nutrient (e.g., Cu₂O, MnCO₃, ZnO, ZnSO₄, or a combination thereof); at least one (e.g., 1, 2, 3, 4, 5, 6, 7, 8, 9, 10, or more) oxidized lignin; at least one (e.g., 1, 2, 3, 4, 5, 6, 7, 8, 9, 10, or more) solvent (e.g., water); and optionally, at least one (e.g., 1, 2, 3, 4, 5, 6, 7, 8, 9, 10, or more) surfactant (e.g., an anionic surfactant). For example, in any aspect or embodiment describe herein, the composition comprises at least one solvent (e.g., propylene glycol) and the nutrients includes Cu₂O, MnCO₃, ZnO, or a combination thereof. In a further example, in any aspect or embodiment described herein, the composition does not include a surfactant and the nutrient includes, consists essentially of, or is ZnSO₄. In any aspect or embodiment described herein, the solvent includes, consists essentially of, or is a polar protic solvent or a polar aprotic solvent (e.g., water, propylene glycol, ethylene glycol, glycerin, diethylene glycol monobutyl ether, 1-methoxy-2-propanol, ethanol, isopropanol, propanol, acetone, dimethylformamide, dimethyl sulfoxide, tetrahydrofuran, acetonitrile, dimethylacetamide, or a combination thereof). In any aspect or embodiment described herein, the composition (e.g., an agricultural composition or formulation, or a nutrient composition or formulation) has a D90 particle size of below about 30 micron (e.g., less than about 29, less than about 28, less than about 27, less than about 26, less than about 25, less than about 24, less than about 23, less than about 22, less than about 21, or less than about 20 micron), the composition (e.g., an agricultural composition or formulation, or a nutrient composition or formulation) has a D50 particle size of less than about 10 micron (e.g., less than about 9, less than about 8, less than about 7, less than about 6, or less than about 5 micron), or a combination thereof.

In any aspect or embodiment described herein, the composition has a D90 particle size is about 1 to about 30 micron, about 1 to about 25 micron, about 1 to about 20 micron, about 1 to about 15 micron, about 1 to about 10 micron, about 1 to about 5 micron, about 5 to about 30 micron, about 5 to about 25 micron, about 5 to about 20 micron, about 5 to about 15 micron, about 5 to about 10 micron, about 10 to about 30 micron, about 10 to about 25 micron, about 10 to about 20 micron, about 10 to about 15 micron, about 15 to about 30 micron, about 15 to about 25 micron, about 15 to about 20 micron, about 20 to about 30 micron, about 20 to about 25 micron, or about 25 to about 30 micron.

In any aspect or embodiment described herein, the composition has a D50 particle size of about 1 micron to about 10 micron, about 1 micron to about 9 micron, about 1 micron to about 8 micron, about 1 micron to about 7 micron, about 1 micron to about 6 micron, about 1 micron to about 5 micron, about 1 micron to about 4 micron, about 1 micron to about 3 micron, about 1 micron to about 2 micron, about 2 micron to about 10 micron, about 2 micron to about 9 micron, about 2 micron to about 8 micron, about 2 micron to about 7 micron, about 2 micron to about 6 micron, about 2 micron to about 5 micron, about 2 micron to about 4 micron, about 2 micron to about 3 micron, about 3 micron to about 10 micron, about 3 micron to about 9 micron, about 3 micron to about 8 micron, about 3 micron to about 7 micron, about 3 micron to about 6 micron, about 3 micron to about 5 micron, about 3 micron to about 4 micron, about 4 micron to about 10 micron, about 4 micron to about 9 micron, about 4 micron to about 8 micron, about 4 micron to about 7 micron, about 4 micron to about 6 micron, about 4 micron to about 5 micron, about 5 micron to about 10 micron, about 5 micron to about 9 micron, about 5 micron to about 8 micron, about 5 micron to about 7 micron, about 5 micron to about 6 micron, about 6 micron to about 10 micron, about 6 micron to about 9 micron, about 6 micron to about 8 micron, about 6 micron to about 7 micron, about 7 micron to about 10 micron, about 7 micron to about 9 micron, about 7 micron to about 8 micron, about 8 micron to about 10 micron, about 8 micron to about 9 micron, or about 9 micron to about 10 micron.

A further aspect of the present disclosure relates to a method of making the composition or formulation of the present disclosure comprising nutrients, the method comprising combining, and optionally mixing, the components of the composition. For example, in any aspect or embodiment described herein, mixing includes mixing with milling beads, mixing until the composition has a desired particle size, such as described herein, or a combination thereof.

In any aspect or embodiment describe herein, the at least one nutrient includes at least one (e.g., 1, 2, 3, 4, 5, 6, 7, 8, 9, 10, or more) micronutrient, at least one (e.g., 1, 2, 3, 4, 5, 6, 7, 8, 9, 10, or more) macronutrient, or a combination thereof. For example, in any aspect or embodiment described herein, the at least one macronutrient includes, consists essentially of, or is nitrogen (N), phosphorus (P), potassium (K), or a combination thereof. As a further example, in any aspect or embodiment described herein, the at least one micronutrient includes, consists essentially of, or is sulphur(S), magnesium (Mg), calcium (Ca), zinc (Zn), iron (Fe), boron (B), manganese (Mn), copper (Cu), molybdenum (Mo), chlorine (Cl), nickel (Ni), iodine (I), sodium (Na), cobalt (Co), selenium (Se), fluorine (F), or a combination thereof. In any aspect or embodiment describe herein, the nutrient includes, consists essentially of, or is calcium sulfate, monoammonium phosphate, diammonium phosphate, superphosphate, rock phosphate, ammonium nitrate, potassium nitrate, sodium nitrate, calcium nitrate, magnesium sulfate, potassium-magnesium sulfate, gypsum, ammonium sulfate, elemental sulfur, sodium nitrate, sodium molybdate, potassium iodate, potassium nitrate, potassium sulfate, muriate of potash (MOP), potassium chloride, iron oxide, ferrous sulfate sulfa, zinc oxysulfate, zinc oxide, zinc chloride, zinc nitrate, boric acid, ammonium molybdate, copper sulfate, copper chloride, chromium oxides, sodium selenate, manganese sulfate, manganese oxide, copper sulfates, cobalt sulfate, sodium fluoride, calcium fluoride, or a combination thereof.

In any aspect or embodiment describe herein, the nutrient includes, consists essentially of, or is potassium sulfate, potassium nitrate, ammonium sulfate, ammonium nitrate, urea, ammonium sulfate, calcium nitrate, monopotassium phosphate, diammonium phosphate, triple superphosphate, magnesium sulfate, or a combination thereof.

### Exemplary Water-Insoluble Nutrient Compositions/Formulations

In any aspect or embodiment describe herein, the composition or formulation comprises at least one surfactant (e.g., polyoxethylene (20) sorbitan monolaurate), the at least one nutrient comprises, consists essentially of, or consists of, at least one (e.g., 1, 2, 3, 4, 5, 6, 7, 8, 9, 10, or more) water-insoluble nutrient (e.g., Cu₂O, MnCO₃, ZnO, or a combination thereof), and the composition further comprises: (i) at least one (e.g., 1, 2, 3, 4, 5, 6, 7, 8, 9, 10, or more) defoamer (e.g., a silicone defoamer (e.g., silicone defoamer); (ii) at least one (e.g., 1, 2, 3, 4, 5, 6, 7, 8, 9, 10, or more) stabilizer or thickener (e.g., a cellulose-based thickener (e.g., carboxymethyl cellulose (CMC), hydroxyethyl cellulose (HEC), methyl cellulose (MC), microcrystalline cellulose (MCC)), a starch-based thickener (e.g., cornstarch, potato starch, tapioca starch, rice starch, or a combination thereof), a guar gum derivative (e.g., guar gum, hydroxypropyl guar (HPG), carboxymethyl guar (CMG), xanthan gum, agar-agar, locust bean gum (carob gum), pectin, alginate, gellan gum, acacia gum (gum arabic), carrageenan, or a combination thereof), a polyacrylic acid derivative (e.g., carbomer, acrylates/C10-30 alkyl acrylate crosspolymer, polyethylene glycol (PEG), polyvinyl alcohol (PVA), or a combination thereof), a silica-based thickener (e.g., colloidal silica, fumed silica, bentonite, montmorillonite, hectorite, sodium polyacrylate, hydroxypropyl methylcellulose (HPMC), or a combination thereof), or a combination thereof); (iii) at least one (e.g., 1, 2, 3, 4, 5, 6, 7, 8, 9, 10, or more) anti-freezing agent or freezing point depressant (e.g., propylene glycol, urea, or a combination thereof), or (iv) a combination thereof. Furthermore, in any aspect or embodiment described herein, (i) the at least one surfactant includes, consists essentially of, or is an anionic surfactant (e.g., alkylnapthalene sulfonate), (ii) the at least one solvent includes, consists essentially of, or is water, (iii) the at least one anti-freezing agent or freezing point depressant includes, consists essentially of, or is propylene glycol, or (iv) a combination thereof.

In any aspect or embodiment described herein, (i) the oxidized lignin is present in an amount of about 0.5 to about 10.0 wt % (e.g., about 1.0 to about 10.0 wt %, about 0.5 to about 5.0 wt %, or about 1.0 wt % to about 5.0 wt %); (ii) the at least one nutrient (e.g., the at least one water-insoluble nutrient) is present in an amount of about 25.0 wt % to about 50.0 wt % (e.g., about 30.0 wt % to about 42.0 wt % or about 35.0 wt % to about 38.0 wt %); (iii) the at least one solvent is present in an amount of about 40.0 wt % to about 70.0 wt % (e.g., about 45.0 wt % to about 65.0 wt % or about 49.0 wt % to about 60.0 wt %); (iv) the at least one surfactant is present in an amount of about 0.01 wt % to about 5.0 wt % (e.g., about 0.1 wt % to about 2.5 wt %); (v) the at least one anti-freezing agent or freezing point depressant is present in an amount of about 1.0 wt % to about 15.0 wt % (e.g., about 1.0 wt % to about 10.0 wt % or about 3.0 wt % to about 8.0 wt %); (vi) the at least one defoamer is present in an amount of about 0.01 wt % to about 2.0 wt % (e.g., about 0.05 wt % to about 0.5 wt % or about 0.05 wt % to about 0.25 wt %); (v) the at least one stabilizer or thickener is present in an amount of about 0.01 wt % to about 2.0 wt % (e.g., about 0.05% to about 0.5 wt % or about 0.05 wt % to about 0.25 wt %); or (vi) a combination thereof.

In any aspect or embodiment describe herein, the oxidized lignin is present in an amount of about 0.5 to about 10.0 wt % (e.g., about 1.0 to about 10.0 wt %, about 0.5 to about 5.0 wt %, or about 1.0 wt % to about 5.0 wt %). For example, in any aspect or embodiment describe herein, the oxidized lignin is present in an amount of about 0.5 to about 10.0 wt %, about 0.5 to about 9.0 wt %, about 0.5 to about 8.0 wt %, about 0.5 to about 7.0 wt %, about 0.5 to about 6.0 wt %, about 0.5 to about 5.0 wt %, about 0.5 to about 4.0 wt %, about 0.5 to about 3.0 wt %, about 0.5 to about 2.0 wt %, about 1.0 to about 10.0 wt %, about 1.0 to about 9.0 wt %, about 1.0 to about 8.0 wt %, about 1.0 to about 7.0 wt %, about 1.0 to about 6.0 wt %, about 1.0 to about 5.0 wt %, about 1.0 to about 4.0 wt %, about 1.0 to about 3.0 wt %, about 1.0 to about 2.0 wt %, about 2.0 to about 10.0 wt %, about 2.0 to about 9.0 wt %, about 2.0 to about 8.0 wt %, about 2.0 to about 7.0 wt %, about 2.0 to about 6.0 wt %, about 2.0 to about 5.0 wt %, about 2.0 to about 4.0 wt %, about 3.0 to about 10.0 wt %, about 3.0 to about 9.0 wt %, about 3.0 to about 8.0 wt %, about 3.0 to about 7.0 wt %, about 3.0 to about 6.0 wt %, about 3.0 to about 5.0 wt %, about 3.0 to about 4.0 wt %, about 4.0 to about 10.0 wt %, about 4.0 to about 9.0 wt %, about 4.0 to about 8.0 wt %, about 4.0 to about 7.0 wt %, about 4.0 to about 6.0 wt %, about 4.0 to about 5.0 wt %, about 5.0 to about 10.0 wt %, about 5.0 to about 9.0 wt %, about 5.0 to about 8.0 wt %, about 5.0 to about 7.0 wt %, about 5.0 to about 6.0 wt %, about 6.0 to about 10.0 wt %, about 6.0 to about 9.0 wt %, about 6.0 to about 8.0 wt %, about 6.0 to about 7.0 wt %, about 7.0 to about 10.0 wt %, about 7.0 to about 9.0 wt %, about 7.0 to about 8.0 wt %, about 8.0 to about 10.0 wt %, about 8.0 to about 9.0 wt %, or about 9.0 to about 10.0 wt %.

In any aspect or embodiment describe herein, the at least one nutrient (e.g., at least one water-insoluble nutrient) is present in an amount of about 25.0 wt % to about 50.0 wt % (e.g., about 30.0 wt % to about 42.0 wt % or about 35.0 wt % to about 38.0 wt %). For example, in any aspect or embodiment describe herein, the at least one nutrient is present in an amount of about 25.0 wt % to about 50.0 wt %, about 25.0 wt % to about 45.0 wt %, about 25.0 wt % to about 40.0 wt %, about 25.0 wt % to about 35.0 wt %, about 25.0 wt % to about 30.0 wt %, about 30.0 wt % to about 50.0 wt %, about 30.0 wt % to about 45.0 wt %, about 30.0 wt % to about 40.0 wt %, about 30.0 wt % to about 45.0 wt %, about 35.0 wt % to about 50.0 wt %, about 35.0 wt % to about 45.0 wt %, about 35.0 wt % to about 40.0 wt %, about 40.0 wt % to about 50.0 wt %, about 40.0 wt % to about 45.0 wt %, or about 45.0 wt % to about 50.0 wt %.

In any aspect or embodiment describe herein, the at least one solvent is present in an amount of about 40.0 wt % to about 70.0 wt % (e.g., about 45.0 wt % to about 65.0 wt % or about 49.0 wt % to about 60.0 wt %). For example, in any aspect or embodiment describe herein, the at least one solvent is present in an amount of about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 40.0 wt % to about 45.0 wt %, about 45.0 wt % to about 70.0 wt %, about 45.0 wt % to about 65.0 wt %, about 45.0 wt % to about 60.0 wt %, about 45.0 wt % to about 55.0 wt %, about 45.0 wt % to about 50.0 wt %, about 50.0 wt % to about 70.0 wt %, about 50.0 wt % to about 65.0 wt %, about 50.0 wt % to about 60.0 wt %, about 50.0 wt % to about 55.0 wt %, about 55.0 wt % to about 70.0 wt %, about 55.0 wt % to about 65.0 wt %, about 55.0 wt % to about 60.0 wt %, about 60.0 wt % to about 70.0 wt %, about 60.0 wt % to about 65.0 wt %, or about 65.0 wt % to about 70.0 wt %.

In any aspect or embodiment describe herein, the at least one surfactant is present in an amount of about 0.01 wt % to about 5.0 wt % (e.g., about 0.1 wt % to about 2.5 wt %). For example, in any aspect or embodiment describe herein, the at least one surfactant is present in an amount of about 0.01 wt % to about 5.0 wt %, about 0.01 wt % to about 4.5 wt %, about 0.01 wt % to about 4.0 wt %, about 0.01 wt % to about 3.5 wt %, about 0.01 wt % to about 3.0 wt %, about 0.01 wt % to about 2.5 wt %, about 0.01 wt % to about 2.0 wt %, about 0.01 wt % to about 1.5 wt %, about 0.01 wt % to about 1.0 wt %, about 0.01 wt % to about 0.5 wt %, about 0.25 wt % to about 5.0 wt %, about 0.25 wt % to about 4.5 wt %, about 0.25 wt % to about 4.0 wt %, about 0.25 wt % to about 3.5 wt %, about 0.25 wt % to about 3.0 wt %, about 0.25 wt % to about 2.5 wt %, about 0.25 wt % to about 2.0 wt %, about 0.25 wt % to about 1.5 wt %, about 0.25 wt % to about 1.0 wt %, about 0.25 wt % to about 0.5 wt %, about 0.5 wt % to about 5.0 wt %, about 0.5 wt % to about 4.5 wt %, about 0.5 wt % to about 4.0 wt %, about 0.5 wt % to about 3.5 wt %, about 0.5 wt % to about 3.0 wt %, about 0.5 wt % to about 2.5 wt %, about 0.5 wt % to about 2.0 wt %, about 0.5 wt % to about 1.5 wt %, about 0.5 wt % to about 1.0 wt %, about 0.5 wt % to about 5.0 wt %, about 0.5 wt % to about 4.5 wt %, about 0.5 wt % to about 4.0 wt %, about 0.5 wt % to about 3.5 wt %, about 0.5 wt % to about 3.0 wt %, about 0.5 wt % to about 2.5 wt %, about 0.5 wt % to about 2.0 wt %, about 0.5 wt % to about 1.5 wt %, about 0.5 wt % to about 1.0 wt %, about 1.0 wt % to about 5.0 wt %, about 1.0 wt % to about 4.5 wt %, about 1.0 wt % to about 4.0 wt %, about 1.0 wt % to about 3.5 wt %, about 1.0 wt % to about 3.0 wt %, about 1.0 wt % to about 2.5 wt %, about 1.0 wt % to about 2.0 wt %, about 1.0 wt % to about 1.5 wt %, about 1.5 wt % to about 5.0 wt %, about 1.5 wt % to about 4.5 wt %, about 1.5 wt % to about 4.0 wt %, about 1.5 wt % to about 3.5 wt %, about 1.5 wt % to about 3.0 wt %, about 1.5 wt % to about 2.5 wt %, about 1.5 wt % to about 2.0 wt %, about 2.0 wt % to about 5.0 wt %, about 2.0 wt % to about 4.5 wt %, about 2.0 wt % to about 4.0 wt %, about 2.0 wt % to about 3.5 wt %, about 2.0 wt % to about 3.0 wt %, about 2.0 wt % to about 2.5 wt %, about 2.5 wt % to about 5.0 wt %, about 2.5 wt % to about 4.5 wt %, about 2.5 wt % to about 4.0 wt %, about 2.5 wt % to about 3.5 wt %, about 2.5 wt % to about 3.0 wt %, about 3.0 wt % to about 5.0 wt %, about 3.0 wt % to about 4.5 wt %, about 3.0 wt % to about 4.0 wt %, about 3.0 wt % to about 3.5 wt %, about 3.5 wt % to about 5.0 wt %, about 3.5 wt % to about 4.5 wt %, about 3.5 wt % to about 4.0 wt %, about 4.0 wt % to about 5.0 wt %, about 4.0 wt % to about 4.5 wt %, or about 4.5 wt % to about 5.0 wt %.

In any aspect or embodiment describe herein, the at least one anti-freezing agent or freezing point depressant is present in an amount of about 1.0 wt % to about 15.0 wt % (e.g., about 1.0 wt % to about 10.0 wt % or about 3.0 wt % to about 8.0 wt %). For example, in any aspect or embodiment describe herein, the at least one anti-freezing agent or freezing point depressant is present in an amount of about 1.0 wt % to about 15.0 wt %, about 1.0 wt % to about 15.0 wt %, about 1.0 wt % to about 14.0 wt %, about 1.0 wt % to about 13.0 wt %, about 1.0 wt % to about 12.0 wt %, about 1.0 wt % to about 11.0 wt %, about 1.0 wt % to about 10.0 wt %, about 1.0 wt % to about 9.0 wt %, about 1.0 wt % to about 8.0 wt %, about 1.0 wt % to about 7.0 wt %, about 1.0 wt % to about 6.0 wt %, about 1.0 wt % to about 5.0 wt %, about 1.0 wt % to about 4.0 wt %, about 1.0 wt % to about 3.0 wt %, about 1.0 wt % to about 2.0 wt %, about 2.0 wt % to about 15.0 wt %, about 2.0 wt % to about 14.0 wt %, about 2.0 wt % to about 13.0 wt %, about 2.0 wt % to about 12.0 wt %, about 2.0 wt % to about 11.0 wt %, about 2.0 wt % to about 10.0 wt %, about 2.0 wt % to about 9.0 wt %, about 2.0 wt % to about 8.0 wt %, about 2.0 wt % to about 7.0 wt %, about 2.0 wt % to about 6.0 wt %, about 2.0 wt % to about 5.0 wt %, about 2.0 wt % to about 4.0 wt %, about 2.0 wt % to about 3.0 wt %, about 3.0 wt % to about 15.0 wt %, about 3.0 wt % to about 14.0 wt %, about 3.0 wt % to about 13.0 wt %, about 3.0 wt % to about 12.0 wt %, about 3.0 wt % to about 11.0 wt %, about 3.0 wt % to about 10.0 wt %, about 3.0 wt % to about 9.0 wt %, about 3.0 wt % to about 8.0 wt %, about 3.0 wt % to about 7.0 wt %, about 3.0 wt % to about 6.0 wt %, about 3.0 wt % to about 5.0 wt %, about 3.0 wt % to about 4.0 wt %, about 4.0 wt % to about 15.0 wt %, about 4.0 wt % to about 14.0 wt %, about 4.0 wt % to about 13.0 wt %, about 4.0 wt % to about 12.0 wt %, about 4.0 wt % to about 11.0 wt %, about 4.0 wt % to about 10.0 wt %, about 4.0 wt % to about 9.0 wt %, about 4.0 wt % to about 8.0 wt %, about 4.0 wt % to about 7.0 wt %, about 4.0 wt % to about 6.0 wt %, about 4.0 wt % to about 5.0 wt %, about 5.0 wt % to about 15.0 wt %, about 5.0 wt % to about 14.0 wt %, about 5.0 wt % to about 13.0 wt %, about 5.0 wt % to about 12.0 wt %, about 5.0 wt % to about 11.0 wt %, about 5.0 wt % to about 10.0 wt %, about 5.0 wt % to about 9.0 wt %, about 5.0 wt % to about 8.0 wt %, about 5.0 wt % to about 7.0 wt %, about 5.0 wt % to about 6.0 wt %, about 6.0 wt % to about 15.0 wt %, about 6.0 wt % to about 14.0 wt %, about 6.0 wt % to about 13.0 wt %, about 6.0 wt % to about 12.0 wt %, about 6.0 wt % to about 11.0 wt %, about 6.0 wt % to about 10.0 wt %, about 6.0 wt % to about 9.0 wt %, about 6.0 wt % to about 8.0 wt %, about 6.0 wt % to about 7.0 wt %, about 7.0 wt % to about 15.0 wt %, about 7.0 wt % to about 14.0 wt %, about 7.0 wt % to about 13.0 wt %, about 7.0 wt % to about 12.0 wt %, about 7.0 wt % to about 11.0 wt %, about 7.0 wt % to about 10.0 wt %, about 7.0 wt % to about 9.0 wt %, about 7.0 wt % to about 8.0 wt %, about 8.0 wt % to about 15.0 wt %, about 8.0 wt % to about 14.0 wt %, about 8.0 wt % to about 13.0 wt %, about 8.0 wt % to about 12.0 wt %, about 8.0 wt % to about 11.0 wt %, about 8.0 wt % to about 10.0 wt %, about 8.0 wt % to about 9.0 wt %, about 9.0 wt % to about 15.0 wt %, about 9.0 wt % to about 14.0 wt %, about 9.0 wt % to about 13.0 wt %, about 9.0 wt % to about 12.0 wt %, about 9.0 wt % to about 11.0 wt %, about 9.0 wt % to about 10.0 wt %, about 10.0 wt % to about 15.0 wt %, about 10.0 wt % to about 14.0 wt %, about 10.0 wt % to about 13.0 wt %, about 10.0 wt % to about 12.0 wt %, about 10.0 wt % to about 11.0 wt %, about 11.0 wt % to about 15.0 wt %, about 11.0 wt % to about 14.0 wt %, about 11.0 wt % to about 13.0 wt %, about 11.0 wt % to about 12.0 wt %, about 12.0 wt % to about 15.0 wt %, about 12.0 wt % to about 14.0 wt %, about 12.0 wt % to about 13.0 wt %, about 13.0 wt % to about 15.0 wt %, about 13.0 wt % to about 14.0 wt %, or about 14.0 wt % to about 15.0 wt %.

In any aspect or embodiment describe herein, the at least one defoamer is present in an amount of about 0.01 wt % to about 2.0 wt % (e.g., about 0.05 wt % to about 0.5 wt % or about 0.05 wt % to about 0.25 wt %). For example, in any aspect or embodiment describe herein, the at least one defoamer is present in an amount of about 0.01 wt % to about 2.0 wt %, about 0.01 wt % to about 1.75 wt %, about 0.01 wt % to about 1.5 wt %, about 0.01 wt % to about 1.25 wt %, about 0.01 wt % to about 1.0 wt %, about 0.01 wt % to about 0.75 wt %, about 0.01 wt % to about 0.5 wt %, about 0.01 wt % to about 0.25 wt %, about 0.1 wt % to about 2.0 wt %, about 0.1 wt % to about 1.75 wt %, about 0.1 wt % to about 1.5 wt %, about 0.1 wt % to about 1.25 wt %, about 0.1 wt % to about 1.0 wt %, about 0.1 wt % to about 0.75 wt %, about 0.1 wt % to about 0.5 wt %, about 0.25 wt % to about 2.0 wt %, about 0.25 wt % to about 1.75 wt %, about 0.25 wt % to about 1.5 wt %, about 0.25 wt % to about 1.25 wt %, about 0.25 wt % to about 1.0 wt %, about 0.25 wt % to about 0.75 wt %, about 0.25 wt % to about 0.5 wt %, about 0.5 wt % to about 2.0 wt %, about 0.5 wt % to about 1.75 wt %, about 0.5 wt % to about 1.5 wt %, about 0.5 wt % to about 1.25 wt %, about 0.5 wt % to about 1.0 wt %, about 0.5 wt % to about 0.75 wt %, about 0.75 wt % to about 2.0 wt %, about 0.75 wt % to about 1.75 wt %, about 0.75 wt % to about 1.5 wt %, about 0.75 wt % to about 1.25 wt %, about 0.75 wt % to about 1.0 wt %, about 1.0 wt % to about 2.0 wt %, about 1.0 wt % to about 1.75 wt %, about 1.0 wt % to about 1.5 wt %, about 1.0 wt % to about 1.25 wt %, about 1.25 wt % to about 2.0 wt %, about 1.25 wt % to about 1.75 wt %, about 1.25 wt % to about 1.5 wt %, about 1.5 wt % to about 2.0 wt %, about 1.5 wt % to about 1.75 wt %, or about 1.75 wt % to about 2.0 wt %.

In any aspect or embodiment describe herein, the at least one stabilizer or thickener is present in an amount of about 0.01 wt % to about 2.0 wt % (e.g., about 0.05% to about 0.5 wt % or about 0.05 wt % to about 0.25 wt %). For example, in any aspect or embodiment describe herein, the at least one stabilizer or thickener is present in an amount of about 0.01 wt % to about 2.0 wt %, about 0.01 wt % to about 1.75 wt %, about 0.01 wt % to about 1.5 wt %, about 0.01 wt % to about 1.25 wt %, about 0.01 wt % to about 1.0 wt %, about 0.01 wt % to about 0.75 wt %, about 0.01 wt % to about 0.5 wt %, about 0.01 wt % to about 0.25 wt %, about 0.1 wt % to about 2.0 wt %, about 0.1 wt % to about 1.75 wt %, about 0.1 wt % to about 1.5 wt %, about 0.1 wt % to about 1.25 wt %, about 0.1 wt % to about 1.0 wt %, about 0.1 wt % to about 0.75 wt %, about 0.1 wt % to about 0.5 wt %, about 0.25 wt % to about 2.0 wt %, about 0.25 wt % to about 1.75 wt %, about 0.25 wt % to about 1.5 wt %, about 0.25 wt % to about 1.25 wt %, about 0.25 wt % to about 1.0 wt %, about 0.25 wt % to about 0.75 wt %, about 0.25 wt % to about 0.5 wt %, about 0.5 wt % to about 2.0 wt %, about 0.5 wt % to about 1.75 wt %, about 0.5 wt % to about 1.5 wt %, about 0.5 wt % to about 1.25 wt %, about 0.5 wt % to about 1.0 wt %, about 0.5 wt % to about 0.75 wt %, about 0.75 wt % to about 2.0 wt %, about 0.75 wt % to about 1.75 wt %, about 0.75 wt % to about 1.5 wt %, about 0.75 wt % to about 1.25 wt %, about 0.75 wt % to about 1.0 wt %, about 1.0 wt % to about 2.0 wt %, about 1.0 wt % to about 1.75 wt %, about 1.0 wt % to about 1.5 wt %, about 1.0 wt % to about 1.25 wt %, about 1.25 wt % to about 2.0 wt %, about 1.25 wt % to about 1.75 wt %, about 1.25 wt % to about 1.5 wt %, about 1.5 wt % to about 2.0 wt %, about 1.5 wt % to about 1.75 wt %, or about 1.75 wt % to about 2.0 wt %.

### Exemplary Water-Soluble Nutrient Compositions/Formulations

In any aspect or embodiment describe herein, (i) the at least one nutrient comprises, consists essentially of, or consists of, at least one (e.g., 1, 2, 3, 4, 5, 6, 7, 8, 9, 10, or more) water-soluble nutrient (e.g., ZnSO₄); (ii) the composition does not include a surfactant (e.g., a surfactant as described herein and/or the composition does not include a defoamer, such as described herein); or (iii) a combination thereof.

In any aspect or embodiment describe herein, (i) the at least one nutrient (e.g., at least one water-soluble nutrient) is present in an amount of about 5.0 wt % to about 20.0 wt % (e.g., about 5.0 wt % to about 15.0 wt %); (ii) the at least one oxidized lignin is present in an amount of about 5.0 wt % to about 20.0 wt % (e.g., about 5.0 wt % to about 15.0 wt %); (iii) the at least one solvent (e.g., water) is present in an amount of about 60.0 wt % to about 90.0 wt %; or (iv) a combination thereof.

In any aspect or embodiment described herein, the at least one nutrient is present in the water-soluble nutrient composition/formulation in an amount of about 5.0 wt % to about 20.0 wt % (e.g., about 5.0 wt % to about 15.0 wt %). For example, in any aspect or embodiment described herein, the at least one nutrient is present in the water-soluble nutrient composition/formulation in an amount of about 5.0 wt % to about 20.0 wt %, about 5.0 wt % to about 17.5 wt %, about 5.0 wt % to about 15.0 wt %, about 5.0 wt % to about 12.5 wt %, about 5.0 wt % to about 10.0 wt %, about 5.0 wt % to about 7.5 wt %, about 7.5 wt % to about 20.0 wt %, about 7.5 wt % to about 17.5 wt %, about 7.5 wt % to about 15.0 wt %, about 7.5 wt % to about 12.5 wt %, about 7.5 wt % to about 10.0 wt %, about 10.0 wt % to about 20.0 wt %, about 10.0 wt % to about 17.5 wt %, about 10.0 wt % to about 15.0 wt %, about 10.0 wt % to about 12.5 wt %, about 12.5 wt % to about 20.0 wt %, about 12.5 wt % to about 17.5 wt %, about 12.5 wt % to about 15.0 wt %, about 15.0 wt % to about 20.0 wt %, about 15.0 wt % to about 17.5 wt %, or about 17.5 wt % to about 20.0 wt %.

In any aspect or embodiment described herein, the at least one oxidized lignin is present in the water-soluble nutrient composition/formulation in an amount of about 5.0 wt % to about 20.0 wt % (e.g., about 5.0 wt % to about 15.0 wt %). For example, in any aspect or embodiment described herein, the at least one oxidized lignin is present in the water-soluble nutrient composition/formulation in an amount of about 5.0 wt % to about 20.0 wt %, about 5.0 wt % to about 17.5 wt %, about 5.0 wt % to about 15.0 wt %, about 5.0 wt % to about 12.5 wt %, about 5.0 wt % to about 10.0 wt %, about 5.0 wt % to about 7.5 wt %, about 7.5 wt % to about 20.0 wt %, about 7.5 wt % to about 17.5 wt %, about 7.5 wt % to about 15.0 wt %, about 7.5 wt % to about 12.5 wt %, about 7.5 wt % to about 10.0 wt %, about 10.0 wt % to about 20.0 wt %, about 10.0 wt % to about 17.5 wt %, about 10.0 wt % to about 15.0 wt %, about 10.0 wt % to about 12.5 wt %, about 12.5 wt % to about 20.0 wt %, about 12.5 wt % to about 17.5 wt %, about 12.5 wt % to about 15.0 wt %, about 15.0 wt % to about 20.0 wt %, about 15.0 wt % to about 17.5 wt %, or about 17.5 wt % to about 20.0 wt %.

In any aspect or embodiment described herein, the at least one solvent (e.g., water) is present in the water-soluble nutrient composition/formulation in an amount of about 60.0 wt % to about 90.0 wt %. For example, in any aspect or embodiment described herein, the at least one solvent (e.g., water) is present in the water-soluble nutrient composition formulation in an amount of about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 60.0 wt % to about 65.0 wt %, about 65.0 wt % to about 90.0 wt %, about 65.0 wt % to about 85.0 wt %, about 65.0 wt % to about 80.0 wt %, about 65.0 wt % to about 75.0 wt %, about 65.0 wt % to about 70.0 wt %, about 70.0 wt % to about 90.0 wt %, about 70.0 wt % to about 85.0 wt %, about 70.0 wt % to about 80.0 wt %, about 70.0 wt % to about 75.0 wt %, about 75.0 wt % to about 90.0 wt %, about 75.0 wt % to about 85.0 wt %, about 75.0 wt % to about 80.0 wt %, about 80.0 wt % to about 90.0 wt %, about 80.0 wt % to about 85.0 wt %, or about 85.0 wt % to about 90.0 wt %.

### Stabilizers or Thickeners

In any aspect or embodiment described herein, the at least one (e.g., 1, 2, 3, 4, 5, 6, 7, 8, 9, 10, or more) stabilizer or thickener includes, consists essentially of, or is a cellulose-based thickener (e.g., carboxymethyl cellulose (CMC), hydroxyethyl cellulose (HEC), methyl cellulose (MC), microcrystalline cellulose (MCC)), a starch-based thickener (e.g., cornstarch, potato starch, tapioca starch, rice starch, or a combination thereof), a guar gum derivative (e.g., guar gum, hydroxypropyl guar (HPG), carboxymethyl guar (CMG), xanthan gum, agar-agar, locust bean gum (carob gum), pectin, alginate, gellan gum, acacia gum (gum arabic), carrageenan, or a combination thereof), a polyacrylic acid derivative (e.g., carbomer, acrylates/C10-30 alkyl acrylate crosspolymer, polyethylene glycol (PEG), polyvinyl alcohol (PVA), or a combination thereof), a silica-based thickener (e.g., colloidal silica, fumed silica, bentonite, montmorillonite, hectorite, sodium polyacrylate, hydroxypropyl methylcellulose (HPMC), or a combination thereof), or a combination thereof. For example, in any aspect or embodiment described herein, the at least one stabilizer or thickener includes, consists essentially of, or is xanthan gum.

### Exemplary Agricultural Methods

Another aspect of the present disclosure relates to an agricultural method comprising, consisting essentially of, or consisting of, contacting a plant (e.g., a plurality of plants), a seed (e.g., a plurality of seeds), soil (e.g., soil near, containing, and/or adjacent a plant (e.g., a plurality of plants) and/or seed (e.g., a plurality of seeds)), or a combination, with the composition or formulation of the present disclosure (e.g., the nutrient composition/formulation of the present disclosure, the active component composition/formulation of the present disclosure, or a combination thereof).

A further aspect of the present disclosure relates to a method of applying to or treating a plant (e.g., a plurality of plants), a seed (e.g., a plurality of seeds), soil (e.g., soil near, containing and/or adjacent a plant (e.g., a plurality of plants) and/or seed (e.g., a plurality of seeds)), or a combination, with the composition or formulation of the present disclosure, the method comprising, consisting essentially of, or consisting of, contacting a plant (e.g., a plurality of plants), a seed (e.g., a plurality of seeds), soil (e.g., soil near, containing, and/or adjacent a plant (e.g., a plurality of plants) and/or seed (e.g., a plurality of seeds)), or a combination, with the composition or formulation of the present disclosure (e.g., applying the composition/formulation to and/or treating a plant (e.g., plurality of plants), a seed (e.g., a plurality of seeds), soil (e.g., soil, near, containing or adjacent to a plant and/or a seed (e.g., a plurality of plants and/or seeds)), or a combination thereof).

### Exemplary Remediation and Purification Methods and Compositions

An aspect of the present disclosure relates to a method of performing remediation (e.g., soil or water remediation), the method comprising, consisting essentially of, or consisting of, contacting or treating a material to be remediated or contaminated material (e.g., soil, water, or a combination thereof) with an adsorbent material comprising, consisting essentially of, or consisting of, at least one (e.g., 1, 2, 3, 4, 5, 6, 7, 8, 9, 10, or more) oxidized lignin.

A further aspect of the present disclosure relates to a method of purifying (e.g., water), the method comprising, consisting essentially of, or consisting of, contacting or treating a material to be purified or contaminated material (e.g., water) with an adsorbent material comprising, consisting essentially of, or consisting of, at least one (e.g., 1, 2, 3, 4, 5, 6, 7, 8, 9, 10, or more) oxidized lignin. For example, in any aspect or embodiment described herein, the method of purifying method further comprises, consists essentially of, or consists of, separating a contaminant (e.g., at least one heavy metal) adsorbed oxidized lignin from the material to be purified or contaminated material.

In any aspect or embodiment described herein, the adsorbent material further comprises, consists essentially or, or consists of at least one (e.g., 1, 2, 3, 4, 5, 6, 7, 8, 9, 10, or more) solvent (e.g., (i) at least one solvent present in an amount of less than or equal to about 50 wt %, less than or equal to about 45 wt %, less than or equal to about 40 wt %, less than or equal to about 35 wt %, less than or equal to about 30 wt %, less than or equal to about 25 wt %, less than or equal to about 20 wt %, less than or equal to about 15 wt %, less than or equal to about 10 wt %, or less than or equal to about 5 wt % of the material, (ii) the at least one solvent includes, consists essentially of, or is water, or (iii) a combination thereof). For example, in any aspect or embodiment described herein, the at least one solvent is present in an amount of about 0.5 wt % to about 50.0 wt %, about 0.5 wt % to about 45.0 wt %, about 0.5 wt % to about 40.0 wt %, about 0.5 wt % to about 35.0 wt %, about 0.5 wt % to about 30.0 wt %, about 0.5 wt % to about 25.0 wt %, about 0.5 wt % to about 20.0 wt %, about 0.5 wt % to about 15.0 wt %, about 0.5 wt % to about 10.0 wt %, about 0.5 wt % to about 5.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 5.0 wt % to about 10.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 10.0 wt % to about 15.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 15.0 wt % to about 20.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 20.0 wt % to about 25.0 wt %, about 25.0 wt % to about 50.0 wt %, about 25.0 wt % to about 45.0 wt %, about 25.0 wt % to about 40.0 wt %, about 25.0 wt % to about 35.0 wt %, about 25.0 wt % to about 30.0 wt %, about 30.0 wt % to about 50.0 wt %, about 30.0 wt % to about 45.0 wt %, about 30.0 wt % to about 40.0 wt %, about 30.0 wt % to about 35.0 wt %, about 35.0 wt % to about 50.0 wt %, about 35.0 wt % to about 45.0 wt %, about 35.0 wt % to about 40.0 wt %, about 40.0 wt % to about 50.0 wt %, about 40.0 wt % to about 45.0 wt %, OR about 45.0 wt % to about 50.0 wt %.

In any aspect or embodiment describe herein, the remediation or purification method further comprises, consists essentially of, or consists of, removing the contaminated material (e.g., from the ground, a body of water, etc., to perform the method on the contaminated material) prior to contacting or treating the contaminated material with the adsorbent material.

In any aspect or embodiment describe herein, the material to be remediated, the material to be purified, or the contaminated materials includes at least one (e.g., 1, 2, 3, 4, 5, 6, 7, 8, 9, 10, or more) heavy metal. For example, in any aspect or embodiment described herein, the at least one heavy metal includes, consists essentially of, or is mercury (Hg), cadmium (Cd), arsenic (As), chromium (Cr), thallium (TI), lead (Pb), or a combination thereof.

Another aspect of the present disclosure relates to an adsorbent material (e.g., a soil remediation adsorbent material or a water remediation adsorbent material) comprising, consisting essentially of, or consisting of, an oxidized lignin (e.g., an adsorbent material for the use of remediation (such as soil remediation, water remediation, or a combination thereof), or purification).

In any aspect or embodiment describe herein, the adsorbent material adsorbs at least one (e.g., 1, 2, 3, 4, 5, 6, 7, 8, 9, 10, or more) heavy metal (e.g., at least one heavy metal that includes, consists essentially of, or is mercury (Hg), cadmium (Cd), arsenic (As), chromium (Cr), thallium (TI), lead (Pb), or a combination thereof).

Another aspect of the present disclosure relates to the use of the absorbent material of the present disclosure for remediation (e.g., soil remediation, water remediation, or a combination thereof) or purification (e.g., water purification).

A further aspect of the present disclosure relates to a composition comprising the adsorbent of the present disclosure and at least one (e.g., 1, 2, 3, 4, 5, 6, 7, 8, 9, 10, or more) heavy metal (e.g., at least one heavy metal that includes, consists essentially of, or is mercury (Hg), cadmium (Cd), arsenic (As), chromium (Cr), thallium (TI), lead (Pb), or a combination thereof).

### Exemplary Oxidized Lignin

In any aspect or embodiment described herein, the at least one oxidized lignin includes, consists essentially of, or is a lignin as described in U.S. Patent Application Publication No. 2019/0002490 A1, which is incorporated by reference herein for all purposes. In any aspect or embodiment described herein, the at least one oxidized lignin includes, consists essentially of, or is a lignin as described in International Patent Application Publication No. WO 2022/221209 A1, which is incorporated by reference herein for all purposes.

In any aspect or embodiment describe herein, the at least one oxidized lignin comprises at least one (e.g., 1, 2, 3, 4, 5, 6, 7, 8, 9, 10, or more) aromatic ring of one or more (e.g., 1, 2, 3, 4, 5, 6, 7, 8, 9, 10, or more, such as each) lignin polymer (e.g., each polymer) that is opened. For example, in any aspect or embodiment described herein, the at least one oxidized lignin comprises at least one (e.g., 1, 2, 3, 4, 5, 6, 7, 8, 9, 10, or more) aromatic ring of each polymer that is opened, optionally each polymer has the opened aromatic ring on a different part of each polymer.

In any aspect or embodiment described herein, the at least one lignin includes, consists essentially of, or is a mixture of lignin polymers comprising more than one (e.g., 2, 3, 4, 5, 6, 7, 8, 9, 10, or more) polymer and each polymer comprises at least one (e.g., 1, 2, 3, 4, 5, 6, 7, 8, 9, 10, or more) aromatic ring opened, optionally each polymer has the opened aromatic ring on a different part of each polymer.

In any aspect or embodiment described herein, the aromatic ring opened forms a polyacid as a result of the aromatic ring being opened. In any aspect or embodiment described herein, the polyacid comprises two carboxylic functional groups. In any aspect or embodiment described herein, the oxidized lignin or the lignin polymer with at least one aromatic ring opened is water-soluble.

In any aspect or embodiment described herein, (i) the at least one lignin includes, consists essentially of, or is a water-insoluble lignin, (ii) the at least one oxidized lignin includes, consists essentially of, or is water-soluble lignin, or (iii) a combination thereof.

### Exemplary Method of Making Oxidized Lignin

In any aspect or embodiment described herein, the at least one oxidized lignin includes, consists essentially of, or is (a) a lignin prepared according to the methods described in U.S. Patent Application Publication No. 2019/0002490 A1, (b) a lignin prepared according to the methods described in U.S. Patent Application Publication No. WO 2022/221209 A1, or (c) a combination thereof. In any aspect or embodiment described herein, the at least one oxidized lignin includes, consists essentially of, or is a lignin prepared according to the methods described in U.S. Patent Application Publication No. 2019/0002490 A1. In any aspect or embodiment described herein, the at least one oxidized lignin includes, consists essentially of, or is a lignin prepared according to the methods described in U.S. Patent Application Publication No. WO 2022/221209 A1.

In any aspect or embodiment describe herein, the at least one oxidized lignin is prepared by performing a modified Fenton reaction (e.g., a Fenton reaction with a chelator) with at least one (e.g., 1, 2, 3, 4, 5, 6, 7, 8, 9, 10, or more) lignin. For example, in any aspect or embodiment described herein, the at least one oxidized lignin is prepared by a method comprising, consisting essentially of, or consisting of, (a) mixing at least one lignin (e.g., water-insoluble lignin) and a chelator/Fe complex (e.g., at least one (e.g., 1, 2, 3, 4, 5, 6, 7, 8, 9, 10, or more) chelator, and at least one (e.g., 1, 2, 3, 4, 5, 6, 7, 8, 9, 10, or more) Fe salt) to produce a first reaction mixture), and optionally incubating the first reaction mixture, (b) mixing at least one (e.g., 1, 2, 3, 4, 5, 6, 7, 8, 9, 10, or more) oxidizing agent to the first reaction mixture to produce a second reaction mixture, and optionally incubating the second reaction mixture, thereby forming the at least one oxidized lignin (e.g., at least one oxidized lignin includes at least one (e.g., 1, 2, 3, 4, 5, 6, 7, 8, 9, 10, or more) comprising at least one (e.g., 1, 2, 3, 4, 5, 6, 7, 8, 9, 10, or more) aromatic ring of one or more (e.g., 1, 2, 3, 4, 5, 6, 7, 8, 9, 10, or more) lignin polymer that is opened). In any aspect or embodiment describe herein, the method of making the oxidized lignin further comprises, consists essentially of, or consists of: (c) after mixing the at least one oxidizing agent to the first reaction mixture to produce a second reaction mixture or optionally incubating the second reaction mixture, adding additional at least one (e.g., 1, 2, 3, 4, 5, 6, 7, 8, 9, 10, or more) lignin (e.g., water-insoluble lignin), additional at least one (e.g., 1, 2, 3, 4, 5, 6, 7, 8, 9, 10, or more) oxidizing agent, and optionally additional chelator/Fe complex (e.g., at least one (e.g., 1, 2, 3, 4, 5, 6, 7, 8, 9, 10, or more) chelator and at least one (e.g., 1, 2, 3, 4, 5, 6, 7, 8, 9, 10, or more) Fe salt), to the second reaction mixture, to produce a third reaction mixture, and optionally incubating the third reaction mixture, and (d) optionally repeating (e.g., repeating 1, 2, 3, 4, or more times) step (c), thereby forming the at least one oxidized lignin (e.g., at least one oxidized lignin includes at least one (e.g., 1, 2, 3, 4, 5, 6, 7, 8, 9, 10, or more) comprising at least one (e.g., 1, 2, 3, 4, 5, 6, 7, 8, 9, 10, or more) aromatic ring of one or more (e.g., 1, 2, 3, 4, 5, 6, 7, 8, 9, 10, or more) lignin polymer that is opened).

In any aspect or embodiment describe herein, at least about 90% (e.g., at least about 91%, at least about 92%, at least about 93%, at least about 94%, at least about 95%, at least about 96%, at least about 97%, at least about 98%, or at least about 99%) of the at least one lignin in the reaction mixture is converted into the at least one oxidized lignin (e.g., at least one oxidized lignin includes at least one (e.g., 1, 2, 3, 4, 5, 6, 7, 8, 9, 10, or more) comprising at least one (e.g., 1, 2, 3, 4, 5, 6, 7, 8, 9, 10, or more) aromatic ring of one or more (e.g., 1, 2, 3, 4, 5, 6, 7, 8, 9, 10, or more) lignin polymer that is opened), such as a water-soluble polyacid by the opening of at least one (e.g., 1, 2, 3, 4, 5, 6, 7, 8, 9, 10, or more) aromatic ring in each water-insoluble lignin.

In any aspect or embodiment described herein, the method of making the oxidized lignin includes concentrating (e.g., via water evaporation) the oxidized lignin and/or separating the oxidized lignin.

In any aspect or embodiment described herein, the method of making the oxidized lignin lacks a concentration step and/or a separating step.

In any aspect or embodiment described herein, the method of making the oxidized lignin includes spray drying the oxidized lignin.

In any aspect or embodiment described herein, step (b) mixing at least one oxidizing agent to the first reaction mixture, step (c) adding additional at least one lignin and additional at least one oxidizing agent to the second reaction mixture, step (d) optionally repeating step (c), or a combination thereof, are continuous or semi-continuous.

In any aspect or embodiment described herein, the method of making the oxidized lignin further comprises, consists essentially of, or consists of, heating the reaction mixture (e.g., the second reaction mixture, third reaction mixture (e.g., the repeat of the third reaction mixture), or a combination thereof). For example, in any aspect or embodiment described herein, the method of making the oxidized lignin further comprises, consists essentially of, or consists of, heating the reaction mixture to a temperature of about 40° C. to about 60° C. (e.g., the second reaction mixture, third reaction mixture (e.g., the repeat of the third reaction mixture), or a combination thereof). For example, in any aspect or embodiment described herein, the method of making the oxidized lignin further comprises, consists essentially of, or consists of: heating the final reaction mixture (e.g., prior to adjusting the pH of the at least one oxidized lignin) a temperature of about 40° C. to about 60° C. For example, in any aspect or embodiment described herein, the temperature is about 40° C. to about 60° C., about 40° C. to about 55° C., about 40° C. to about 50° C., about 45° C. to about 60° C., about 45° C. to about 55° C., or about 50° C. to about 60° C.

In any aspect or embodiment described herein, the method of making the oxidized lignin further comprises, consists essentially of, or consists of: (e) introducing or mixing a base to the reaction mixture to adjust the pH of the reaction mixture to a pH of about 3.0 to about 6.0 (e.g., about 3.0 to about 6.0, about, about 3.0 to about 5.0, about 3.0 to about 4.0, about 4.0 to about 6.0, about, about 4.0 to about 5.0, or about 5.0 to about 6.0), and (f) optionally repeating step (e) one or more (e.g., 1, 2, 3, 4, 5, 6, 7, 8, 9, 10, or more) times.

In any aspect or embodiment described herein, the at least one lignin (e.g., at least one water-insoluble lignin) is part of a solid component that is equal to or more than about 20% by weight of the reaction mixture (e.g., equal to or more than about 21%, equal to or more than about 22%, equal to or more than about 23%, equal to or more than about 24%, equal to or more than about 25%, equal to or more than about 26%, equal to or more than about 27%, equal to or more than about 28%, equal to or more than about 29%, or equal to or more than about 30%, by weight of the reaction mixture). In any aspect or embodiment described herein, the at least one lignin includes, consists essentially of, or is at least one (e.g., 1, 2, 3, 4, 5, 6, 7, 8, 9, 10, or more) organosolv lignin, at least one (e.g., 1, 2, 3, 4, 5, 6, 7, 8, 9, 10, or more) Kraft lignin, or a combination thereof. For example, in any aspect or embodiment described herein, the at least one lignin includes, consisting essentially of, or is derived from, a hardwood lignin composition (e.g. lignin derived from beech, birch, oak, ash, or a combination thereof), a softwood lignin composition (e.g., a lignin composition derived from pine, spruce, fir, larch, cedar, or a combination thereof), a herbaceous plant lignin composition (e.g., a lignin derived from poaceae, cereal grass (such as rice, wheat, rye, oats, barley, millet, maize, or a combination thereof), grass, bamboo, rice, reed grasses, maize, sugarcane, alfalfa, flax, or a combination thereof), or a combination thereof. In any aspect or embodiment described herein, the at least one lignin includes, consists essentially of, or is at least one (e.g., 1, 2, 3, 4, 5, 6, 7, 8, 9, 10, or more) lignosulfonate.

In any aspect or embodiment describe herein, the chelator/Fe complex comprises at least one (e.g., 1, 2, 3, 4, 5, 6, 7, 8, 9, 10, or more) chelator (e.g., dihydroxybenzene) and at least one (e.g., 1, 2, 3, 4, 5, 6, 7, 8, 9, 10, or more) Fe salt (e.g., FeCl₃). Thus, in any aspect or embodiment described herein, the method further comprises, consists essentially of, or consists of, contacting at least one (e.g., 1, 2, 3, 4, 5, 6, 7, 8, 9, 10, or more) Fe salt and at least one (e.g., 1, 2, 3, 4, 5, 6, 7, 8, 9, 10, or more) chelator to form the chelator/Fe complex. For example, contacting the at least one Fe salt and the at least one chelator can be performed prior to step (a) or during step (a) (e.g., mixing at least one lignin, at least one Fe salt, and at least one chelator to produce a first reaction mixture).

In any aspect or embodiment described herein, the at least one chelator includes, consists essentially of, or is any chelator that can chelate Fe to facilitate the reduction of Fe(III) to Fe(II). Thus, in any aspect or embodiment described herein, the at least one Fe salt includes, consists essentially of, or is any Fe(II) salt or Fe(III) salt. Furthermore, in any aspect or embodiment described herein, the chelator includes, consists essentially of, or is 1,2-dihydroxybenzene (DHB), 2,3-dihydroxybenzoic acid (DHBA), pyrogallol, or a mixture thereof. For example, in any aspect or embodiment described herein, the chelator includes, consists essentially of, or is dihydroxybenzene or 1,2-dihydroxybenzene (DHB).

In any aspect or embodiment described herein, the at least one Fe salt includes, consists essentially of, or is FeX₃, wherein X is any halide (e.g., F, Cl, Br, or I). For example, in any aspect or embodiment described herein, the at least one Fe salt includes, consists essentially of, or is Fe₂(SO₄)₃, Fe(NO₃)₃, iron(II) perchlorate (Fe(ClO₄)₂), iron(II) phosphate (FePO₄), iron(III) pyrophosphate (Fe₄(P₂O₇)₃), iron(II) pyrophosphate, iron(II) sulfate (FeSO₄), ammonium iron(II) sulfate, iron(II) bromide, iron(III) bromide, iron(II) chloride, iron(III) chloride, iron(II) fluoride, iron(III) fluoride, iron(III) nitrate, iron(II) oxalate, iron(III) oxalate, or a hydrate thereof, or a mixture thereof. In any aspect or embodiment described herein, the Fe salt comprises, consists essentially of, or is FeCl₃.

In any aspect or embodiment described herein, the Fe concentration added to the reaction mixture has a concentration equal to or more than about 10 mM. For example, in any aspect or embodiment described herein, the Fe concentration added to the reaction mixture has a concentration equal to or more than about 15 mM, equal to or more than about 20 mM, equal to or more than about 25 mM, equal to or more than about 30 mM, equal to or more than about 35 mM, equal to or more than 40 about mM, equal to or more than about 45 mM, or equal to or more than about 50 mM. By way of further example, in any aspect or embodiment described herein, the Fe concentration added to the reaction mixture has a concentration of about 10 mM to about 100 mM, about 10 mM to about 90 mM, about 10 mM to about 80 mM, about 10 mM to about 75 mM, about 10 mM to about 70 mM, about 10 mM to about 65 mM, about 10 mM to about 60 mM, about 10 mM to about 55 mM, about 10 mM to about 50 mM, about 10 mM to about 45 mM, about 10 mM to about 40 mM, about 10 mM to about 35 mM, about 10 mM to about 30 mM, about 10 mM to about 25 mM, about 10 mM to about 20 mM, about 15 mM to about 100 mM, about 15 mM to about 90 mM, about 15 mM to about 80 mM, about 15 mM to about 75 mM, about 15 mM to about 70 mM, about 15 mM to about 65 mM, about 15 mM to about 60 mM, about 15 mM to about 55 mM, about 15 mM to about 50 mM, about 15 mM to about 45 mM, about 15 mM to about 40 mM, about 15 mM to about 35 mM, about 15 mM to about 30 mM, about 15 mM to about 25 mM, about 20 mM to about 100 mM, about 20 mM to about 90 mM, about 20 mM to about 80 mM, about 20 mM to about 75 mM, about 20 mM to about 70 mM, about 20 mM to about 65 mM, about 20 mM to about 60 mM, about 20 mM to about 55 mM, about 20 mM to about 50 mM, about 20 mM to about 45 mM, about 20 mM to about 40 mM, about 20 mM to about 35 mM, about 20 mM to about 30 mM, about 25 mM to about 100 mM, about 25 mM to about 90 mM, about 25 mM to about 80 mM, about 25 mM to about 75 mM, about 25 mM to about 70 mM, about 25 mM to about 65 mM, about 25 mM to about 60 mM, about 25 mM to about 55 mM, about 25 mM to about 50 mM, about 25 mM to about 45 mM, about 25 mM to about 40 mM, about 25 mM to about 35 mM, about 30 mM to about 100 mM, about 30 mM to about 90 mM, about 30 mM to about 80 mM, about 30 mM to about 75 mM, about 30 mM to about 70 mM, about 30 mM to about 65 mM, about 30 mM to about 60 mM, about 30 mM to about 55 mM, about 30 mM to about 50 mM, about 30 mM to about 45 mM, about 30 mM to about 40 mM, about 35 mM to about 100 mM, about 35 mM to about 90 mM, about 35 mM to about 80 mM, about 35 mM to about 75 mM, about 35 mM to about 70 mM, about 35 mM to about 65 mM, about 35 mM to about 60 mM, about 35 mM to about 55 mM, about 35 mM to about 50 mM, about 35 mM to about 45 mM, about 40 mM to about 100 mM, about 40 mM to about 90 mM, about 40 mM to about 80 mM, about 40 mM to about 75 mM, about 40 mM to about 70 mM, about 40 mM to about 65 mM, about 40 mM to about 60 mM, about 40 mM to about 55 mM, about 40 mM to about 50 mM, about 45 mM to about 100 mM, about 45 mM to about 90 mM, about 45 mM to about 80 mM, about 45 mM to about 75 mM, about 45 mM to about 70 mM, about 45 mM to about 65 mM, about 45 mM to about 60 mM, about 45 mM to about 55 mM, about 50 mM to about 100 mM, about 50 mM to about 90 mM, about 50 mM to about 80 mM, about 50 mM to about 75 mM, about 50 mM to about 70 mM, about 50 mM to about 65 mM, about 50 mM to about 60 mM, about 55 mM to about 100 mM, about 55 mM to about 90 mM, about 55 mM to about 80 mM, about 55 mM to about 75 mM, about 55 mM to about 70 mM, about 55 mM to about 65 mM, about 60 mM to about 100 mM, about 60 mM to about 90 mM, about 60 mM to about 80 mM, about 60 mM to about 75 mM, about 60 mM to about 70 mM, about 65 mM to about 100 mM, about 65 mM to about 90 mM, about 65 mM to about 80 mM, about 65 mM to about 75 mM, about 70 mM to about 100 mM, about 70 mM to about 90 mM, about 70 mM to about 80 mM, about 75 mM to about 100 mM, about 75 mM to about 90 mM, or about 90 mM to about 100 mM.

In any aspect or embodiment described herein, the at least one oxidizing agent includes, consists essentially of, or is hydrogen peroxide (H₂O₂), molecular oxygen (O₂), or both. In any aspect or embodiment described herein, (b) mixing at least one oxidizing agent to the first reaction mixture, (c) adding additional at least one lignin (e.g., water-insoluble lignin) and additional at least one oxidizing agent to the second reaction mixture, or both steps (b) and (c), comprises bubbling a gas composition comprising O₂ into the first reaction mixture. In any aspect or embodiment described herein, the gas composition comprises at least about 20% of 02. (e.g., at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, at least about 99%, or essentially 100% of O₂). In any aspect or embodiment described herein, the gas composition is bubbled through the first reaction mixture at a rate of at least about 0.01 standard cubic feet per hour (SCFH) (e.g., at a rate of at least about 0.05 standard cubic feet per hour (SCFH)). In any aspect or embodiment described herein, mixing an oxidizing agent to the first reaction mixture results in at least about 0.1% of oxidizing agent (e.g., at least about 0.5% of oxidizing agent).

In any aspect or embodiment described herein, the method results in a mixture of lignin polymers comprising more than one (e.g., 2, 3, 4, 5, 6, 7, 8, 9, 10, or more) polymer and each polymer comprises at least one (e.g., 1, 2, 3, 4, 5, 6, 7, 8, 9, 10, or more) aromatic ring opened, optionally each polymer has the opened aromatic ring on a different part of each polymer.

In any aspect or embodiment described herein, the method results in at least about 1 mg (e.g., at least about 1.25 mg, at least about 1.5 mg, at least about 1.75 mg, at least about 2.0 mg, at least about 2.25 mg, at least about 2.5 mg, at least about 2.75 mg, or at least about 3.0 mg) of water-soluble lignin from every 100 mg of water-insoluble lignin.

### Exemplary Surfactants

In any aspect or embodiment described herein, the at least one surfactant includes, consists essentially of, or is at least one (e.g., 1, 2, 3, 4, 5, 6, 7, 8, 9, 10, or more) non-ionic surfactant, at least one (e.g., 1, 2, 3, 4, 5, 6, 7, 8, 9, 10, or more) ionic surfactant (e.g., cationic surfactant, anionic surfactant, amphoteric surfactant, or a combination thereof), or a combination thereof. In any aspect or embodiment described herein, the at least one surfactant includes, consists essentially of, or is at least one (e.g., 1, 2, 3, 4, 5, 6, 7, 8, 9, 10, or more) non-ionic surfactant, at least one (e.g., 1, 2, 3, 4, 5, 6, 7, 8, 9, 10, or more) cationic surfactant, at least one (e.g., 1, 2, 3, 4, 5, 6, 7, 8, 9, 10, or more) anionic surfactant, at least one (e.g., 1, 2, 3, 4, 5, 6, 7, 8, 9, 10, or more) amphoteric surfactant, or a combination thereof.

### Exemplary Non-Ionic Surfactants

As used herein, the term “non-ionic surfactant” includes a structural group that has very little attraction for water (a hydrophobic group) together with a neutrally charged group that has strong attraction for water (a hydrophilic group). For example, in any aspect or embodiment described herein, as is common to surfactants of different classes, the hydrophobic group can be a long-chain hydrocarbon. In any aspect or embodiment described herein, the non-ionic surfactant may be any non-ionic surfactant known in the art. In any aspect or embodiment described herein, mixtures of non-ionic surfactants may be used. In any aspect or embodiment described herein, the non-ionic surfactant may be an ethylene oxide-co-propylene oxide, a castor oil ethoxylate, a polysorbate, nonylphenol ethoxylate, ethoxylated distilled tall oil, or a combination thereof.

### Exemplary Ionic Surfactants

In any aspect or embodiment described herein, the at least one surfactant comprises, consists essentially of, or is at least one (e.g., 1, 2, 3, 4, 5, 6, 7, 8, 9, 10, or more) ionic surfactant. As used herein, the term “ionic surfactant” includes a structural group that has very little attraction for water (a hydrophobic group) together with a group that has strong attraction for water (a hydrophilic group), wherein the hydrophilic group distinguishes between the different ionic surfactant classes: cationic surfactants (positive charge), anionic surfactants (negative charge), and amphoteric surfactants (positive and negative charges). In any aspect or embodiment described herein, the at least one ionic surfactant includes, consists essentially of, or is at least one (e.g., 1, 2, 3, 4, 5, 6, 7, 8, 9, 10, or more) amphoteric surfactant, at least one (e.g., 1, 2, 3, 4, 5, 6, 7, 8, 9, 10, or more) cationic surfactants, at least one (e.g., 1, 2, 3, 4, 5, 6, 7, 8, 9, 10, or more) anionic surfactant, or combinations thereof. For example, in any aspect or embodiment described herein, the at least one surfactant comprises, consists essentially of, or is at least one (e.g., 1, 2, 3, 4, 5, 6, 7, 8, 9, 10, or more) anionic surfactant. By way of further example, in any aspect or embodiment described herein, the at least one surfactant comprises, consists essentially of, or is at least one (e.g., 1, 2, 3, 4, 5, 6, 7, 8, 9, 10, or more) cationic surfactant.

In any aspect or embodiment described herein, the hydrophilic groups of anionic surfactants can include a sulfonate group, a sulfate group, a carboxylate group (e.g., linear alkylbenzene sulfonate (LAS)), or a combination thereof. In any aspect or embodiment described herein, the anionic surfactant includes, consists essentially of, or is a linear alkylbenzene sulfonate.

In any aspect or embodiment described herein, the at least one surfactant includes, consists essentially of, or is an amidoamine surfactant, an imidazoline surfactant, a non-ionic surfactant, a quaternary ammonium surfactant, a triamine surfactant, a tetra-amine surfactant, a penta-amine surfactant, an amidated tall oil derivative surfactant (e.g., fatty acids, rosins, or a combination thereof), derivatives thereof, or a combination thereof.

As used herein, the term “amphoteric surfactants” includes mono-amphoteric surfactants and polyamphoteric surfactants. In any aspect or embodiment described herein, the at least one amphoteric surfactant includes, consists essentially of, or is C-12 to C-24 (e.g., C-16 to C-18) fatty acid, rosin acid, and combinations thereof, modified with an enophile and/or dieneophile (e.g., acrylic acid, maleic anhydride, fumaric acid, or a combination thereof), and further reacted with polyethylene polyamines, lithium C-12 to C-24 alkyl amidopropyl halide methyl carboxylate betaines, sodium C-12 to C-24 alkyl amidopropyl halide methyl carboxylate betaines, potassium C-12 to C-24 alkyl amidopropyl halide methyl carboxylate betaines, lithium C-12 to C-24 alkyl amidopropyl halide phosphate betaines, sodium C-12 to C-24 alkyl amidopropyl halide phosphate betaines, potassium C-12 to C-24 alkyl amidopropyl halide phosphate betaines, lithium C-12 to C-24 alkyl amidopropyl halide sulphate betaines, sodium C-12 to C-24 alkyl amidopropyl halide sulphate betaines, potassium C-12 to C-24 alkyl amidopropyl halide sulphate betaines, derivatives thereof, or a combination thereof. Unless the context indicates otherwise, the term “amphoteric surfactants” includes the above-noted compounds and their derivatives.

In any aspect or embodiment described herein, the at least one anionic surfactant includes, consists essentially of, or is a petroleum sulfonate (e.g., alpha-olefin sulfonate, alpha-olefin sulfates, or a combination thereof), a soap-type emulsifying agent (e.g., an alkali metal salt of higher (e.g., C6-C32) fatty acids, such as lauric acid, myristic acid, palmitic acid, oleic acid, ricinoleic acid, linoleic acid, or mixtures of acids, available from animal or vegetable oils), a water-soluble potassium salt of saturated or unsaturated higher (C6-C32) fatty acids, a sodium salt of a sulfuric acid ester of a higher alcohol, a sodium alkyl benzene sulfonate, a sodium salt of a dialkyl succinate sulfonic acid, a sodium salt of an alkyldiphenylether sulfonic acid, or a combination thereof. Other examples of anionic surfactants are described in U.S. Pat. No. 4,282,037, the description of which is incorporated herein by reference. For example, in any aspect or embodiment described herein, the at least one anionic surfactant includes, consists essentially of, or is sodium alkyl benzene sulfonate, sodium lauryl sulfate, a polyoxethylene alkyl (or alkylphenyl) ether sulfonate, a lignate-surfactant blend (Indulin® SA-L, Ingevity, North Charleston, South Carolina), or a combination thereof. Unless the context indicates otherwise, the term “anionic surfactants” includes the above-noted compounds and their derivatives.

In any aspect or embodiment described herein, the at least one cationic surfactant includes, consists essentially of, or is a fatty imidazoline derived from C-12 to C-24 fatty acids, a fatty imidoamine derived from C-12 to C-24 (e.g., C-16 to C-18) fatty acids, rosin acids, or a combination thereof, modified with an enophile and/or dieneophile (e.g., maleic anhydride, fumaric acid, or a combination thereof), and further reacted with polyalkylenepolyamines; a fatty amidoamine derived from C-12 to C-24 (e.g., C-16 to C-18) fatty acids, rosin acids, or a combination thereof, modified with an enophile and/or dieneophile (e.g., acrylic acid, maleic anhydride, fumaric acid, or a combination thereof), and further reacted with a polyalkylenepolyamine; a saturated C-12 to C-24 alkyl monoamine, an unsaturated C-12 to C-24 alkyl monoamine, a saturated C-12 to C-24 alkyl polypropylenepolyamine; an unsaturated C-12 to C-24 alkyl polypropylenepolyamine; a saturated C-12 to C-24 alkyl monoamine modified by reaction with ethylene oxide and/or propylene oxide to give polyoxyethylene derivatives; an unsaturated C-12 to C-24 alkyl monoamines modified by reaction with ethylene oxide and/or propylene oxide to give polyoxyethylene derivatives; a saturated C-12 to C-24 alkyl polypropylenepolyamine modified by reaction with ethylene oxide and/or propylene oxide to give polyoxyethylene derivatives; an unsaturated C-12 to C-24 alkyl polypropylenepolyamine modified by reaction with ethylene oxide and/or propylene oxide to give polyoxyethylene derivatives; a saturated C-12 to C-24 alkyl aryl monoamine; an unsaturated C-12 to C-24 alkyl aryl monoamine; a saturated C-12 to C-24 alkyl aryl polypropylenepolyamine; an unsaturated C-12 to C-24 alkyl aryl polypropylenepolyamines; a C-12 to C-24 quaternary amine; a C-12 to C-24 alkyl ether amine; a C-12 to C-24 alkylether polyamine; a C-12 to C-24 alkyl polypropylene polyamine N-oxide; an amine derivative of tannins; an amine derivatives of phenolic resin; an amine derivative of lignins; an amine-modified polyacrylate; or a combination thereof. In any aspect or embodiment described herein, the at least one cationic surfactant includes, consists essentially of, or is a saturated C-12 to C-24 alkyl monoamine, an unsaturated C-12 to C-24 alkyl monoamine, a saturated C-12 to C-24 alkyl polypropylenepolyamine, an unsaturated C-12 to C-24 alkyl polypropylenepolyamine, or a combination thereof. In any aspect or embodiment described herein, the at least one cationic surfactant includes, consists essentially of, or is a blend of at least one of a saturated C-12 to C-24 alkyl monoamine, an unsaturated C-12 to C-24 alkyl monoamine, a saturated C-12 to C-24 alkyl polypropylenepolyamine, an unsaturated C-12 to C-24 alkyl polypropylenepolyamine, or a combination thereof. Unless the context indicates otherwise, the term “cationic surfactants” includes the above-noted compounds and their derivatives.

### Exemplary Solvents

In any aspect or embodiment described herein, the at least one solvent includes, consists essentially of, or is a polar protic solvent or a polar aprotic solvent. For example, in any aspect or embodiment described herein, the at least one solvent includes, consists essentially of, or is water, propylene glycol, ethylene glycol, glycerin, diethylene glycol monobutyl ether, 1-methoxy-2-propanol, ethanol, isopropanol, propanol, acetone, dimethylformamide, dimethyl sulfoxide, tetrahydrofuran, acetonitrile, dimethylacetamide, or a combination thereof. In any aspect or embodiment described herein, the at least one solvent includes, consists essentially of, or is water.

### Exemplary Defoamers

As used herein, the term “defoamer”, “defoamer agent”, or “anti-foaming agent” is an additive that reduces, hinders, or eliminates the formation of foam, such as foam caused by mixing, agitating, grinding, and/or chemical reactions.

In any aspect or embodiment described herein, the at least one (e.g., 1, 2, 3, 4, 5, 6, 7, 8, 9, 10, or more) defoamer includes, consists essentially of, or is a silicone defoamer (e.g., polydimethylsiloxane (PDMS), silicone oil, silicone emulsion, or a combination thereof), a mineral oil based defoamer (e.g., paraffinic oil, naphthenic oil, vegetable oil, or a combination thereof), a fatty acid-based defoamer (e.g., a stearate, calcium stearate, oleate, tall oil fatty acids, or a combination thereof), a polymeric defoamer (e.g., polyacrylate, polyurethanes, or a combination thereof), a hydrophobic silica-based defoamer (e.g., hydrophobic fumed silica), or a combination thereof.

### Anti-Freezing Agent or Freezing Point Depressant

In any aspect or embodiment described herein, the anti-freezing agent or freezing point depressant includes, consists essentially of, or is water-soluble (e.g., a water-soluble anti-freezing agent or freezing point depressant).

In any aspect or embodiment described herein, the anti-freezing agent or freezing point depressant includes, consists essentially of, or is hydroxy functional compounds comprising C1-6 mono-hydric alcohols. For example, in any aspect or embodiment described herein, the anti-freezing agent or freezing point depressant includes, consists essentially of, or is methanol, ethanol, n-propanol, n-butanol, isopropanol, alkylene glycol monoalkyl ethers (e.g., ethylene glycol monomethyl ether, ethylene glycol monoethyl ether, propylene glycol monomethyl ether, propylene glycol monoethyl ether, or a combination thereof). In any aspect or embodiment described herein, the anti-freezing agent or freezing point depressant includes, consists essentially of, or is at least one (e.g., 1, 2, 3, 4, 5, 6, 7, 8, 9, 10, or more) C24 alkylene glycol (e.g., ethylene glycol, propylene glycol, butylene glycol, glycerin, or a combination thereof). For example, in any aspect or embodiment described herein, the anti-freezing agent or freezing point depressant includes, consists essentially of, or is at least one (e.g., 1, 2, 3, 4, 5, 6, 7, 8, 9, 10, or more) polyalkylene glycol, wherein the alkylene group contains 2 to 4 carbon atoms (e.g., polyethylene glycol, polypropylene glycol, polybutylene glycol, or a combination thereof). In the anti-freezing agent or freezing point depressant includes, consists essentially of, or is at least one (e.g., 1, 2, 3, 4, 5, 6, 7, 8, 9, 10, or more) sugar (e.g., a sugar alcohol, sorbitol, or a combination thereof).

For example, in any aspect or embodiment described herein, the anti-freezing agent or freezing point depressant includes, consists essentially of, or is propylene glycol, polypropylene glycol, urea, ethylene glycol, polyethylene glycol, butylene glycol, or a polybutylene glycol, sorbitol, glycerol, or a combination thereof.

### Examples

Example 1: Active Component Formulation. The active ingredient suspension concentrate was prepared by adding the active ingredient (herbicide) mesotrione (6.75 g), oxidized lignin solution (1.84 g at solid content 32.8%; 1.16 mmol/g carboxylic and molecular weight of 29000), anionic surfactant GEOwet HR (0.15 g; GEO Specialty Chemicals, Ambler, Pennsylvania), propylene glycol (0.75 g), defoamer XIAMETER™ ACP-1500 (0.03 g; DOW Chemical Company, Midland, Michigan), and water (5.48 g). Milling beads were added to the mixture and the formulation was milled to achieve a desired particle size-D50 particle size below 5 micron and D90 particle size below 20 micron.

Storage stability was examined by placing the formulation in an oven at 54° C. for 2 weeks. As shown in Table 1, the formulation performed well after storage, as well as before storage.

TABLE 1
Characterization of the formulation of Example 1.

| | Examples 1 |
|---|---|
| Initial suspensibility (%) | 99.3 |
| Aged suspensibility (%) | 97.4 |
| Initial blooming | Very well |
| Aged blooming | Very well |
| Initial particle size (μm, D50) | 2.60 |
| Aged particle size (μm, D50) | 1 |
| Initial particle size (μm, D90) | 5.40 |
| Aged particle size (μm, D90) | 5.3 |
| Initial viscosity | Workable |
| Aged viscosity | Workable |

Example 2: Micronutrient Formulation. A micronutrient formulation was prepared by adding a combination of water insoluble micronutrients Cu₂O (1.01 g), MnCO₃ (1.88 g), and ZnO (2.27 g) with a surfactant GEOwet HR (0.15 g; GEO Specialty Chemicals, Ambler, Pennsylvania), oxidized lignin (0.375 g; 1.35 mmol/g carboxylic and molecular weight of 30000), defoamer XIAMETER™ ACP-1500 (0.02 g; DOW Chemical Company, Midland, Michigan), xanthan gum (0.02 g), propylene glycol (0.75 g), and water (7.73 g). Milling beads were added to the mixture and the formulation was milled to achieve a desired particle size-D50 particle size below 5 micron and D90 particle size below 20 micron.

Storage stability was examined by placing the formulation in an oven at 54° C. for 2 weeks. As shown in Table 2, the formulation performed well after storage, as well as before storage.

TABLE 2
Characterization of the formulation of Examples 2.

| | Examples 2 |
|---|---|
| Initial suspensibility (%) | 97.9 |
| Aged suspensibility (%) | 97.4 |
| Initial blooming | Very well |
| Aged blooming | Very well |
| Initial particle size (μm, D50) | 0.855 |
| Aged particle size (μm, D50) | 1.00 |
| Initial particle size (μm, D90) | 4.465 |
| Aged particle size (μm, D90) | 5.35 |
| Initial viscosity | Thin |
| Aged viscosity | Soft gel |

Example 3: Formulation with Beauveria bassiana spores. A Beauveria bassiana wettable powder formulation was prepared by a combination of Beauveria bassiana spores (4 g), oxidized lignin (0.8 g, 5.43 mmol/g carboxylic and molecular weight of 14300), GEOwet HR (1.0 g; GEO Specialty Chemicals, Ambler, Pennsylvania), and Hydrite® VS (14.2 g; Imerys USA Inc., Roswell, Georgia, United States of America), and blended in a blender for 30 seconds.

Formulation was evaluated for suspensibility and for D50 particle size below 5 micron and D90 particle size below 100 micron. As shown in Table 3, the formulation performs well for particle size and suspensibility.

TABLE 3
Characterization of formulation example 3.

| | Example 3 |
|---|---|
| Suspensibility (%) | 93.0 |
| Particle size (μm, D50) | 7.22 |
| Particle size (μm, D90) | 50.81 |

Example 4: Micronutrient Formulation. A micronutrient formulation was prepared by adding a combination of water-soluble micronutrient ZnSO₄ (2.1 g) and oxidized lignin (2.1 g; 1.5 mmol/g carboxylic and molecular weight of 13900) in water (16.8 g).

The formulation was evaluated by checking the homogeneity and flowability of the formulation. The formulation was stored at room temperature for 3 days, and homogeneity and flowability checked. Formulation after day 3 showed a syneresis layer, but not significant. There is no gelling.

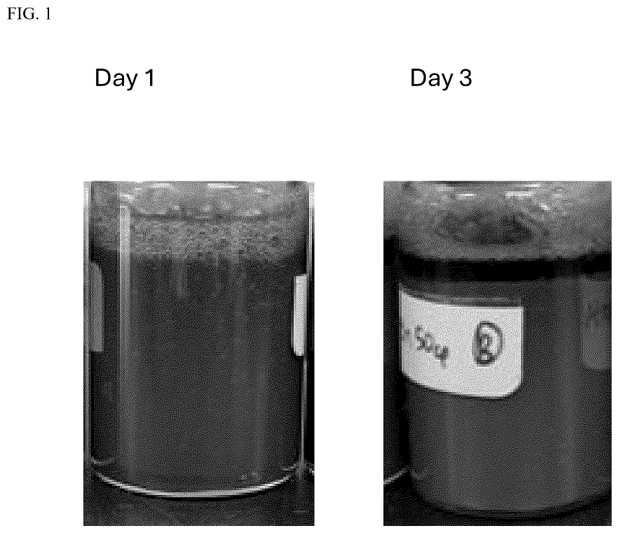

FIG. 1, micronutrient formulation before and after 3 days storage.

Example 5: Examination of Remediation. Fifty milliliters (mL) of heavy metal ion solution with 100 parts per million (ppm) of lead (II) was loaded to a centrifuge tube. Then, the oxidized lignin (250 mg; 1.35 mmol/g carboxylic and molecular weight of 30000) was added to the heavy metal ion solution. The system was kept in a shaker. After agitation for 24 hours, the oxidized lignin-free and purified liquid was recovered thought centrifugation of a membrane separation tube. The metal content in the purified liquid was analyzed and quantified, and the adsorption capacity calculated. The oxidized lignin demonstrated a 19 mg/g lead (II) adsorption capacity.

Example 6: Suspension Concentrate (SC) Formulation with Bacillus thuringiensis. A stock solution was prepared by dissolving polyoxyethylene (20) sorbitan monolaurate (2.60 g, TWEEN® 20; Sigma, Saint Louis, Missouri), polyethylene glycol 400 (2.60 g, Millipore, Burlington, Massachusetts), urea (0.78 g), methyl p-hydroxybenzoate (0.26 g), in water (210.86 g). Bacillus thuringiensis spores (1.95 g, EnviroDEFENSE®; JBMBio, Armada, Michigan), oxidized lignin sample (0.195 g; Sample 1 with 3.08 mmol/g carboxylic and molecular weight of 4800; sample 2 with 5.43 mmol/g carboxylic and molecular weight of 14300), and zirconia milling beads (26 g) were added to an aliquot of the stock solution (10.86 g) in a glass scintillation vial (40 mL) to provide the Suspension Concentrate Formulation of Table 4. The vial was closed and milled on a roller mixer (70 revolutions per minute) at ambient temperature for 4 hours or until particle size D50 below 10 μm was achieved.

TABLE 4
Suspension Concentrate Formulations of Example 6

| | Amount | Amount |
|---|---|---|
| Ingredient | (wt %) | (g) |
| Bacillus thuringiensis spores | 15.0 | 1.95 |
| Oxidized Lignin | 1.5 | 0.195 |
| Polyoxyethylene (20) sorbitan monolaurate | 1.0 | 0.13 |
| Polyethylene glycol 400 | 1.0 | 0.13 |
| Urea | 0.3 | 0.04 |
| Methyl p-hydroxybenzoate | 0.1 | 0.01 |
| Water | 81.1 | 10.54 |

Example 7: Bacillus Thuringiensis SC Suspensibility Study. About 2.5 g of milled SC Bacillus thuringiensis formulation (Example 6) was weighted out to a calibrated cylinder with water (248 mL). The cylinder was stopped and turned upside down 20 times in a fast manner. The mixture was then allowed to settle down. The top 225 mL of the suspension was carefully removed from the cylinder using a pipette and disposed of. The bottom 25 mL of the suspension was transferred from the cylinder into a pre-weighted aluminum pan and dried at 50° C. for 24 hours. The weights collected were used to calculate suspensibility (Table 5).

TABLE 5
Suspensibility of SC Formulations of Example 6

| | Formulation | Dry solids | Sediment | |
|---|---|---|---|---|
| Lignin | added in | added in | layer | Suspensibility |
| dispersant | cylinder | cylinder | recovered | (%) |
| Control | 2.360 g | 0.4460 g | 0.1929 g | 63.1 |
| (lignosulfonate- | | | | |
| based dispersant) | | | | |
| Sample 1 | 2.630 g | 0.4971 g | 0.1737 g | 72.3 |
| Sample 2 | 2.520 g | 0.4763 g | 0.1862 g | 67.7 |

The preceding general areas of utility are given by way of example only and are not intended to be limiting on the scope of the present disclosure and appended claims. Additional objects and advantages associated with the compositions, methods, and processes of the present disclosure will be appreciated by one of ordinary skill in the art in light of the instant claims, description, and examples. For example, the various aspects and embodiments of the disclosure may be utilized in numerous combinations, all of which are expressly contemplated by the present description. These additional aspects and embodiments are expressly included within the scope of the present disclosure. The publications and other materials used herein to illuminate the background of the disclosure, and in particular cases, to provide additional details respecting the practice, are incorporated by reference.

Thus, those skilled in the art will recognize, or be able to ascertain using no more than routine experimentation, many equivalents to the specific embodiments of the disclosure described herein. Such equivalents are intended to be encompassed by the following claims. It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

What is claimed is:

1. A composition or formulation comprising:
at least one active component comprising at least one pesticide, at least one biostimulant, or a combination thereof;
at least one oxidized lignin;
at least one surfactant; and
at least one solvent, at least one filler, or a combination thereof.

2. The composition of claim 1, wherein:
the at least one surfactant includes a non-ionic surfactant, an ionic surfactant, or a combination thereof;
the at least one solvent includes a polar protic solvent or a polar aprotic solvent;
the composition further comprises at least one nutrient; or
a combination thereof.

3. The composition of claim 1, wherein:
the composition comprises at least one solvent, and
the composition further comprises:
a D90 particle size of less than about 30 micron;
a D50 particle size of less than about 15 micron;
at least one anti-freezing agent or freezing point depressant;
at least one defoamer; or
a combination thereof.

4. The composition of claim 2, wherein:
the at least one active component is present in an amount of about 0.5 wt % to about 15.0 wt %;
the at least one oxidized lignin is present in the composition in an amount of about 0.5 to about 15.0 wt %;
the at least one surfactant is present in an amount of about 0.01 wt % to about 5.0 wt %;
the at least one solvent is present in an amount of about 20.0 wt % to about 45.0 wt %;
the at least one anti-freezing agent or freezing point depressant is present in an amount of about 1.0 wt % to about 10.0 wt %;
the at least one defoamer is present in an amount of about 0.05 wt % to about 2.0 wt %;
the at least one nutrient is present in an amount of less than or equal to about 20.0 wt %; or
a combination thereof.

5. The composition of claim 1, wherein the at least one active component includes at least one biopesticide, at least one biostimulant, or a combination thereof, and
(i) the composition comprises at least one filler and optionally further comprises at least one binder, or
(ii) the composition comprises the at least one solvent and optionally further comprises (a) at least one anti-freezing agent or freezing point depressant, (b) at least one preservative, (c) at least one protectant, or (d) a combination thereof.

6. The composition of 5, wherein:
(a) in (i):
the composition has a D90 particle size of less than about 100 micron;
the composition has a D50 particle size of less than about 10 micron;
the at least one active component is present in an amount of about 5.0 wt % to about 90.0 wt %;
the at least one oxidized lignin is present in the composition in an amount of about 0.5 to about 15.0 wt %;
the at least one surfactant is present in an amount of about 0.01 wt % to about 7.5 wt %;
the at least one filler is present in an amount of about 5.0 wt % to about 90.0 wt %;
the at least one binder is present in an amount of less than or equal to about 10.0 wt %;
the at least one nutrient is present in an amount of less than or equal to about 20.0 wt %; or
a combination thereof; or
in (ii):
the composition has a D50 particle size of less than about 15 micron;
the at least one active component is present in an amount of about 5.0 wt % to about 90.0 wt %;
the at least one oxidized lignin is present in an amount of about 0.5 to about 15.0 wt %;
the at least one surfactant is present in an amount of about 0.01 wt % to about 7.5 wt %;
the at least one solvent is present in an amount of about 60.0 wt % to about 90.0 wt %;
the at least one anti-freezing agent or freezing point depressant is present in an amount of about 0.01 wt % to about 1.5 wt %;
the at least one nutrient is present in an amount of less than or equal to about 20.0 wt %;
the at least one preservative is present in an amount of less than or equal to about 0.5 wt %;
the at least one protectant is present in an amount of less than or equal to about 2.0 wt %; or
a combination thereof.

7. A method of making the composition or formulation of claim 1, the method comprising combining, and optionally mixing, the components of the composition.

8. A composition or formulation comprising:
at least one nutrient;
at least one oxidized lignin;
at least one solvent; and
optionally, at least one surfactant.

9. The composition of claim 8, wherein:
the at least one nutrient includes at least one micronutrient, at least one macronutrient, or a combination thereof;
the nutrient includes calcium sulfate, monoammonium phosphate, diammonium phosphate, superphosphate, rock phosphate, ammonium nitrate, potassium nitrate, sodium nitrate, calcium nitrate, magnesium sulfate, potassium-magnesium sulfate, gypsum, ammonium sulfate, elemental sulfur, sodium nitrate, sodium molybdate, potassium iodate, potassium nitrate, potassium sulfate, muriate of potash (MOP), potassium chloride, iron oxide, ferrous sulfate sulfa, zinc oxysulfate, zinc oxide, zinc chloride, zinc nitrate, boric acid, ammonium molybdate, copper sulfate, copper chloride, chromium oxides, sodium selenate, manganese sulfate, manganese oxide, copper sulfates, cobalt sulfate, sodium fluoride, calcium fluoride, or a combination thereof;
the composition has a D90 particle size of less than about 30 micron;
the composition has a D50 particle size of less than about 10 micron;
the solvent includes a polar protic solvent or a polar aprotic solvent; or
a combination thereof.

10. The composition of claim 9, wherein:
the at least one macronutrient includes nitrogen (N), phosphorus (P), potassium (K), or a combination thereof;
the at least one micronutrient includes sulphur(S), magnesium (Mg), calcium (Ca), zinc (Zn), iron (Fe), boron (B), manganese (Mn), copper (Cu), molybdenum (Mo), chlorine (Cl), nickel (Ni), iodine (I), sodium (Na), cobalt (Co), selenium (Se), fluorine (F), or a combination thereof; or
a combination thereof.

11. The composition of claim 8, wherein the composition comprises at least one surfactant, the at least one nutrient comprises at least one water-insoluble nutrient, and the composition further comprises:
at least one defoamer;
at least one stabilizer or thickener;
at least one anti-freezing agent or freezing point depressant, or
a combination thereof.

12. The composition of claim 11, wherein:
the oxidized lignin is present in an amount of about 0.5 to about 10.0 wt %;
the at least one nutrient is present in an amount of about 25.0 wt % to about 50.0 wt %;
the at least one solvent is present in an amount of about 40.0 wt % to about 70.0 wt %;
the at least one surfactant is present in an amount of about 0.01 wt % to about 5.0 wt %;
the at least one anti-freezing agent or freezing point depressant is present in an amount of about 1.0 wt % to about 15.0 wt %;
the at least one defoamer is present in an amount of about 0.01 wt % to about 2.0 wt %;
the at least one stabilizer or thickener is present in an amount of about 0.01 wt % to about 2.0 wt %; or
a combination thereof.

13. The composition of claim 8, wherein:
the at least one nutrient comprises at least one water-soluble nutrient;
the composition does not include a surfactant; or
a combination thereof.

14. The composition of claim 13, wherein:
the at least one nutrient is present in an amount of about 5.0 wt % to about 20.0 wt %;
the at least one oxidized lignin is present in an amount of about 5.0 wt % to about 20.0 wt %;
the at least one solvent is present in an amount of about 60.0 wt % to about 90.0 wt %; or
a combination thereof.

15. A method of making the composition or formulation of claim 8, the method comprising combining, and optionally mixing, the components of the composition.

16. The composition of claim 1, wherein:
the at least one oxidized lignin comprises at least aromatic ring of one or more lignin polymer that is opened;
the at least one oxidized lignin is prepared by performing a modified Fenton reaction with at least one lignin;
the at least one oxidized lignin is prepared by a method comprising (a) mixing at least one lignin and a chelator/Fe complex to produce a first reaction mixture, and optionally incubating the first reaction mixture, (b) mixing at least one) oxidizing agent to the first reaction mixture to produce a second reaction mixture, and optionally incubating the second reaction mixture, thereby forming the at least one oxidized lignin;
the at least one surfactant is derived from Kraft lignin;
optionally, the method further comprises (c) after mixing the at least one oxidizing agent to the first reaction mixture to produce the second reaction mixture or optionally incubating the second reaction mixture, adding additional at least one lignin, additional at least one oxidizing agent, and optionally additional chelator/Fe complex, to the second reaction mixture, to produce a third reaction mixture, and optionally incubating the third reaction mixture, and (d) optionally repeating step (c), thereby forming the at least one oxidized;
the chelator/Fe complex comprises at least one chelator and at least one Fe salt;
at least about 90% of the at least one lignin in the reaction mixture is converted into the at least one oxidized lignin by the opening of at least one aromatic ring in each water-insoluble lignin; or
a combination thereof.

17. A method of applying or treating a plant, soil, and/or seed with the composition of claim 1, the method comprising contacting a plant, a seed, soil near, containing or adjacent to a plant, or a combination thereof, with the composition.

18. An adsorbent material comprising an oxidized lignin.

19. The adsorbent material of claim 18, wherein:
the at least one oxidized lignin comprises at least one aromatic ring of one or more lignin polymer that is opened;
the at least one oxidized lignin is prepared by performing a modified Fenton reaction with at least one lignin;
the at least one oxidized lignin is prepared by a method comprising (a) mixing at least one lignin and a chelator/Fe complex to produce a first reaction mixture, and optionally incubating the first reaction mixture, (b) mixing at least one oxidizing agent to the first reaction mixture to produce a second reaction mixture, and optionally incubating the second reaction mixture, thereby forming the at least one oxidized lignin;
the chelator/Fe complex comprises at least one chelator and at least one Fe salt;
the at least one oxidized lignin is derived from Kraft lignin;
the material adsorbs at least one heavy metal;
optionally, the method further comprises (c) after mixing the at least one oxidizing agent to the first reaction mixture to produce the second reaction mixture or optionally incubating the second reaction mixture, adding additional at least one lignin, additional at least one oxidizing agent;
at least about 90% of the at least one lignin in the reaction mixture is converted into the at least one oxidized lignin by the opening of at least one aromatic ring in each water-insoluble lignin; or
a combination thereof.

20. A composition comprising the adsorbent material of claim 18 and at least one heavy metal.

21. A method of performing remediation or purification, the method comprising contacting or treating a contaminated material or a material to be remediated or purified with the adsorbent material of claim 18, wherein:
optionally, the method further comprises removing the contaminated material prior to contacting or treating the contaminated material with the adsorbent material;
optionally, the contaminated material or the material to be remediated or purified includes at least one heavy metal; or
a combination thereof.
